(19) United States
(12) Patent Application Publication
(10) Pub. No.: US 2026/0312700 A1
(43) Pub. Date: Oct. 8, 2026

(54) PERFORMING FREQUENCY ALLOCATION IN PARALLEL

(71) Applicant: NVIDIA Corporation, Santa Clara, CA (US)

(72) Inventors: Steven Carl Rennich, Belmont, CA (US); Yan Huang, San Jose, CA (US)

(21) Appl. No.: 19/194,373

(22) Filed: Apr. 30, 2025

Related U.S. Application Data
(60) Provisional application No. 63/780,041, filed on Mar. 28, 2025.

(51) Int. Cl. H04B 17/309; G06F 9/30; G06F 9/38; G06T 1/20

(52) U.S. Cl. CPC H04B 17/309; G06F 9/30185; G06F 9/3888; G06T 1/20

(57) ABSTRACT

In various examples, apparatuses, systems, software, and methods are described for executing a Riding Peaks algorithm in parallel using multiple threads (e.g., GPU threads) to allocate sub-bands to user equipment device (UE)s. Examples of UEs include mobile phones, in-machine infotainment devices, smart devices, security systems, and/or other wireless-capable devices. For example, a processor executing an algorithm that allocates sub-bands to UEs by using threads (e.g., GPU threads) operating concurrently to identify peaks and assign sub-bands.

### CROSS-REFERENCE TO RELATED APPLICATION

This application claims the benefit of U.S. Provisional Application No. 63/780,041, filed Mar. 28, 2025, entitled “PERFORMING FREQUENCY ALLOCATION IN PARALLEL,” the disclosure of which is herein incorporated by reference in its entirety.

### TECHNICAL FIELD

Apparatuses, systems, software, and methods to execute a parallelization of the Riding Peaks algorithm using multiple threads (e.g., GPU threads) executed concurrently to allocate sub-bands to user equipment devices (UEs). For example, a processor executes an algorithm that allocates sub-bands to UEs by using threads (e.g., GPU threads) operating concurrently to identify peaks and assign sub-bands.

### BACKGROUND

In wireless networks (e.g., Fifth Generation (5G)), sub-bands (e.g., frequency ranges to use for wireless communication) are allocated to user equipment devices (UEs) using a Riding Peaks algorithm, which a central processing unit (CPU) performs in serial (e.g., sequence). Specifically, the algorithm assigns sub-bands based on a metric derived from signal attributes for each frequency-UE pair, and whether the sub-band is contiguous with a previously assigned sub-band for the corresponding UE. For example, the Riding Peaks algorithm performed by a CPU iterates from the highest to lowest metrics, assigning sub-bands to UEs without any sub-bands already assigned.

When evaluating a metric for an unassigned sub-band, the algorithm first checks whether the corresponding UE has already been assigned a sub-band. If not, the sub-band is assigned as the UE's peak, e.g., highest value. Otherwise, the algorithm determines whether the new sub-band is adjacent to any previously assigned sub-band for that UE before assigning it. This dependency can cause sequential processing, as each assignment influences subsequent decisions. This processing can be slow (e.g., because of many iterations over a long period of time) and use a significant amount of computing resources. Additionally, this processing time can reduce a quality of service for a UE using a wireless network (e.g., more latency in a 5G network). Accordingly, there exists a need to address this problem, as well as other related problems, and provide additional technical benefits.

### BRIEF DESCRIPTION OF THE DRAWINGS

FIG. 1 is a block diagram of a system to generate sub-band assignments using a Riding Peaks algorithm with threads operating in parallel, in accordance with at least one embodiment.

FIG. 2 illustrates a process flow diagram for a process to generate sub-band assignments by performing a Riding Peaks algorithm that uses threads in parallel, in accordance with at least one embodiment.

FIG. 3 illustrates a process flow diagram including a process to generate sub-band assignments by identifying a first peak type (e.g., easy peaks) and a second peak type (e.g., difficult peaks), in accordance with at least one embodiment.

FIG. 4 illustrates a graph of performance metrics for user equipment devices for different sub-bands, in accordance with at least one embodiment.

FIG. 5 illustrates a graph of metrics for user equipment devices with indications of peaks and gaps to be filled to assign sub-bands to the user equipment devices, in accordance with at least one embodiment.

FIG. 6 illustrates an overview of prefix sums that are used by one or more processors when identifying peaks (e.g., difficult peaks), in accordance with at least one embodiment.

FIG. 7 illustrates a graph of metrics of user equipment across sub-bands used to determine a peak type (e.g., difficult peak), in accordance with at least one embodiment.

FIG. 8 illustrates a graph including metrics of user equipment across sub-bands used to determine a sub-band assignments, in accordance with at least one embodiment.

FIG. 9 illustrates a graph of sub-band assignments for different user equipment devices, in accordance with at least one embodiment.

FIG. 10 illustrates a system for performing training, inferencing, and other operations within a 5G network, in accordance with at least one embodiment.

FIG. 11 illustrates a system for performing simulations and using simulations results to modify a wireless network, in accordance with at least one embodiment.

FIG. 12 illustrates an example data center system, in accordance with at least one embodiment.

FIG. 13 illustrates a system-on-a-chip (SoC), in accordance with at least one embodiment.

FIG. 14A illustrates a parallel processor, in accordance with at least one embodiment.

FIG. 14B illustrates a processing cluster, in accordance with at least one embodiment.

FIG. 14C illustrates a graphics multiprocessor, in accordance with at least one embodiment.

FIG. 15 illustrates an accelerator processor, in accordance with at least one embodiment.

FIG. 16A illustrates a central processing unit, in accordance with at least one embodiment.

FIG. 16B illustrates a core of central processing unit in FIG. 16A, in accordance with at least one embodiment.

FIG. 17 illustrates another accelerator processor, in accordance with at least one embodiment.

FIG. 18 illustrates a supercomputer, in accordance with at least one embodiment.

FIG. 19 illustrates another accelerator processor, in accordance with at least one embodiment.

FIG. 20 illustrates another processor, in accordance with at least one embodiment.

FIG. 21 illustrates another accelerator processor, in accordance with at least one embodiment.

FIG. 22 illustrates a tensor processing unit, in accordance with at least one embodiment.

FIG. 23 illustrates a software stack of a programming platform, in accordance with at least one embodiment.

FIG. 24 illustrates software that is supported by a programming platform, in accordance with at least one embodiment.

FIG. 25 illustrates compiling code to execute on programming platforms of FIG. 24, in accordance with at least one embodiment.

### DETAILED DESCRIPTION

Fifth-generation (5G) cellular networks, standardized by the Third Generation Partnership Project (3GPP), can use Multiple Input Multiple Output (MIMO) technology to increase the number of users who can receive wireless service simultaneously. Using MIMO effectively includes several steps, one of which is the assignment of sub-bands to individual users, referred to as user equipment devices or user equipment (e.g., mobile phones, in-machine infotainment devices—such as vehicles, robots, watercraft, aircraft, etc., talking kiosks, smart devices, security systems, and other wireless-capable devices).

Within a given radio spectrum, multiple user equipment devices (UEs) are serviced by a base station assigning portions of that spectrum, called sub-bands, to each UE. This is one of several techniques used in MIMO systems. Due to multipath interference, environmental conditions, and other factors affecting the wireless connection between the UE and a cell tower (e.g., antennas, radio unit), each UE experiences a different level of signal quality for each sub-band. Signal quality, often measured by signal strength or signal-to-noise ratio, can be improved by assigning multiple sub-bands to a UE. In at least one embodiment, there can be a constraint, requirement, or other limitation that physical resource block allocation is contiguous to comply with a wireless communication standard such as Fifth Generation (5G), Sixth Generation (6G), or other wireless standard according to 3^{rd} Generation Partnership Project (3GPP); for example, the disclosed technology can be applied to Type-0 and Type-1 resource allocation schemes as defined in 3GPP for 5G. UEs, user equipment, UE device, and user equipment device are interchangeable terms that refer to a UE, e.g., as defined in 3GPP.

One technical challenge is to allocate (e.g., distribute, assign) sub-bands among multiple UEs in a way that increases or maximizes signal strength while ensuring that each sub-band is assigned to only one UE and that all sub-bands assigned to a given UE are contiguous. Sub-bands can be contiguous for a UE when all the frequency bands assigned to that UE are next to each other without gaps, e.g., the UE can use a continuous section of the wireless spectrum, rather than scattered or spaced apart frequencies, which can be required due to single-carrier transmission method.

This problem can be referred to as a non-deterministic polynomial-time hard problem. Specifically, a technical challenge of assigning sub-bands (e.g., optimally) to UEs while ensuring that sub-bands remain contiguous and increasing (e.g., maximizing) overall signal quality is computationally complex. Because solving this problem exactly would take too long in real-time cellular communication, heuristic methods are used to approximate a possible solution efficiently. One effective heuristic is the Riding Peaks algorithm, disclosed in Proportional Fair Frequency-Domain Packet Scheduling for 3GPP LTE Uplink, Lee et al., UCLA CSD TECHNICAL REPORT: TR-090001, IEEE INFOCOM 2009.

Each frequency-UE pair can have an associated metric (e.g., signal-to-noise ratio, signal-to-interference ratio signal strength, a Transmission Quality Indicator (TQI)), which determines the utility of assigning a given sub-band to a UE. For example, each user equipment device in a 5G network can periodically transmit a channel quality indicator (CQI) or other report to a base station, where that report includes metrics that indicate the performance of different frequencies for that user equipment device. To improve (e.g., maximize) overall assignment efficiency, sub-bands are allocated based on metrics while ensuring that (1) each sub-band is assigned to only one UE and (2) a UE's sub-bands remain contiguous.

In the Riding Peaks algorithm performed serially, a processor may first sort all UE metrics and execute the algorithm to assign the first unallocated sub-band to a UE as its peak if the UE has no prior assignments. For UEs with existing assignments, additional sub-bands are allocated only if they are adjacent to a previously assigned one-effectively “riding” the peak. However, this algorithm is inherently sequential, as each assignment depends on prior assignments. In at least one embodiment, the algorithm iterates through metrics in sequential order, which can be slow or cause parallel processing units (e.g., GPUs) to be underutilized as they can perform operations more efficiently in parallel.

To address this problem and provide additional benefits, software performed by a processor executes a parallelized version of a Riding Peaks algorithm that can generate the same outputs as the serial approach while improving efficiency by performing many operations in parallel (e.g., concurrently, simultaneously) instead of sequentially. The algorithm can be performed by one or more processors such as parallel processing units (PPUs), GPUs, a CPU that uses one or more GPUs for acceleration, and/or other processing units configured to perform threads (e.g., thread groups) in parallel (e.g., independently, simultaneously, concurrently).

In at least one embodiment, a software algorithm can include three operations, steps, or other portions: (1) identifying a first peak type (e.g., “easy peaks”), (2) identifying a second peak type (e.g., “difficult peaks”), and (3) performing operations to fill gaps (e.g., assigning sub-bands in a range to one or two UEs between identified peaks).

As an example, a peak may alternatively be referred to as an allocation. A first type of peak, such as an ‘easy peak’, can be found by identifying metrics which are both the maximum metric for a UE, and the maximum metric at a particular sub-band. These ‘easy peaks’ can be identified using parallel reductions and embarrassingly-parallel operations. Another type of peak, such as ‘difficult peaks’, can be determined efficiently using parallel-prefix-minimums applied to found peaks and additional parallel reductions to validate candidate peaks. Once all peaks are found, the remaining sub-bands, which fill the ‘gaps’ between the peaks, can be efficiently allocated by processing the gaps in parallel. As an example, unassigned sub-bands must belong to one of the two UEs corresponding to the peaks on either side. For example, one or more GPUs uses threads to assign sub-bands to UEs efficiently by processing each gap independently in parallel (e.g., at the same time, simultaneously, or concurrently).

By reducing (e.g., eliminating) sequential traversals, the disclosed algorithm performed by one or more processors enables sub-band assignment to be performed in less time compared to in serial (e.g., as disclosed in Proportional Fair Frequency-Domain Packet Scheduling for 3GPP LTE Uplink, Lee et al., UCLA CSD TECHNICAL REPORT: TR-090001, IEEE INFOCOM 2009).

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) are small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. For example, a processor can receive one or more inputs from neural networks or machine learning models and use those to modify its outputs in a parallelization of the Riding Peaks algorithm.

In one or more embodiments, the system and methods described herein may be deployed in a gaming application, e.g., a base station communicating with a server that is providing a gaming application to one or more UEs. For example, a gaming console, PC, tablet, mobile device, and/or other gaming device may include cellular wireless capability and one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a robotics application, e.g., a robot can be a UE device. For example, a robot or robotic system may have cellular wireless capability and include one or more onboard processors (e.g., CPUs, GPUS, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system or IX application (e.g., for occupant and driver monitoring) within a machine (e.g., cars, trucks, drones, construction equipment, robots, semi-autonomous vehicles, or autonomous vehicles) may include cellular wireless capability and one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In the following description, numerous specific details are set forth to provide a more thorough understanding of at least one embodiment. However, it will be apparent to one skilled in the art that the inventive concepts may be practiced without one or more of these specific details.

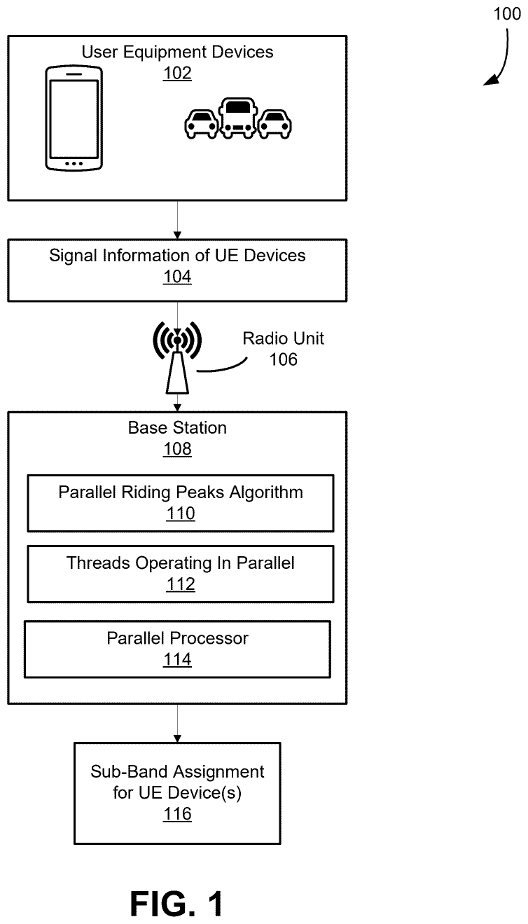

FIG. 1 illustrates a system 100 to generate sub-band assignments using a parallel Riding Peaks algorithm with threads operating in parallel (e.g., concurrently, simultaneously, independently). System 100 or a component of system 100 (e.g., base station 108) can perform a software algorithm to identify a first peak type (e.g., “easy peaks”), identify a second peak type (e.g., “difficult peaks”), perform operations to fill gaps (e.g., assigning sub-bands in a range to one or two UEs between identified peaks), and transmit sub-band assignments to UEs 102.

System 100 can include one or more user equipment devices (UE) 102 (e.g., cellular device, autonomous vehicle, in-machine infotainment devices, smart devices, security systems, and/or other UEs that are capable of wireless transmission and reception), signal information of UEs 104 of one or more UEs 102, one or more radio units 106, one or more base stations 108, one or more Riding Peaks algorithms 110 (e.g., Riding Peaks algorithm with one or more threads operating in parallel 112), and one or more parallel processors 114, where a base station can transmit sub-band assignments of one or more UEs using a radio unit. A parallel processor 114 can be a graphics processing unit (GPU), general-purpose GPU (GPGPU), parallel processing unit (PPU), central processing unit (CPU) that uses a GPU or has a capability to perform threads in parallel, a data processing unit (DPU), or a combination thereof. Specifically, parallel processor 114 can be a PPU that includes circuits configured to perform threads in parallel to identify peaks and allocate sub-bands to UEs 102.

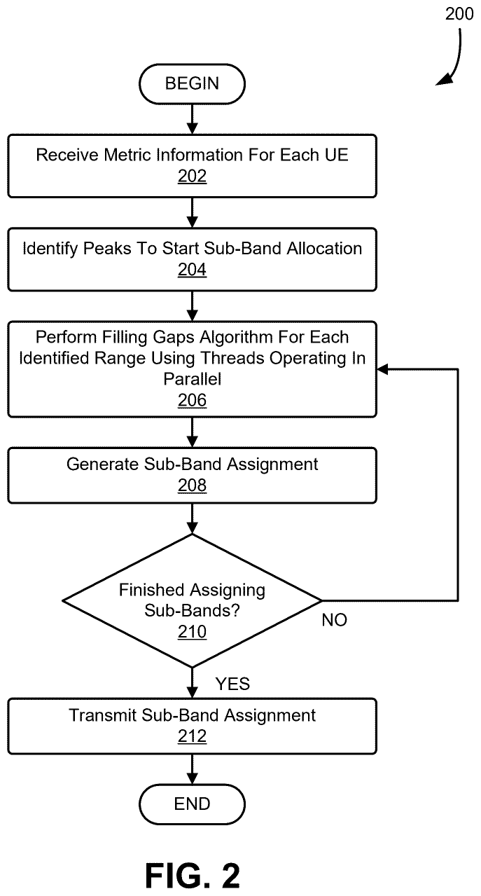

System 100 can use signal information of UEs 104 of one or more UEs 102. Signal information of UEs 104 can include data related to a signal received by one or more UEs 102. This information can include one or more metrics (e.g., performance metrics that indicate how a signal performed when received or used by a UE device), such as signal-to-noise ratio, bit error rate, reference signal received power (RSRP), reference signal received quality (RSRQ), received signal strength indicator (RSSI), channel state information (CSI), timing advance (TA), delay spread, Doppler shift, hybrid automatic repeat request (HARQ) feedback, proportional fairness scheduling metrics, block error rate (BLER), and modulation and coding scheme (MCS) feedback. An example of signal information of UEs 104 can include the channel quality indicator (CQI) reported by a smartphone to a base station 108. For example, signal information of UEs 104 can include a performance metric for a UE for a particular sub-band. As another example, signal information of UEs 104 can include the channel quality indicator (CQI) reported by a smartphone to base station 108. For example, a UE device, such as a mobile phone, can report CQI values for different sub-bands to indicate channel conditions. Base station 108 can then use this information to adjust resource allocation by using parallel Riding Peaks algorithm 110, threads operating in parallel 112, and parallel processor 114 as described in FIGS. 2-10.

Base station 108 may be a network component that facilitates communication between one or more UEs 102 and a core network. As an example, base station 108 could manage multiple connections and handle data transmission. An example of a base station 108 might include or be connected to a cell tower, radio unit, or group of antennas that provides coverage to one or more geographic areas (e.g., or to one or more cells).

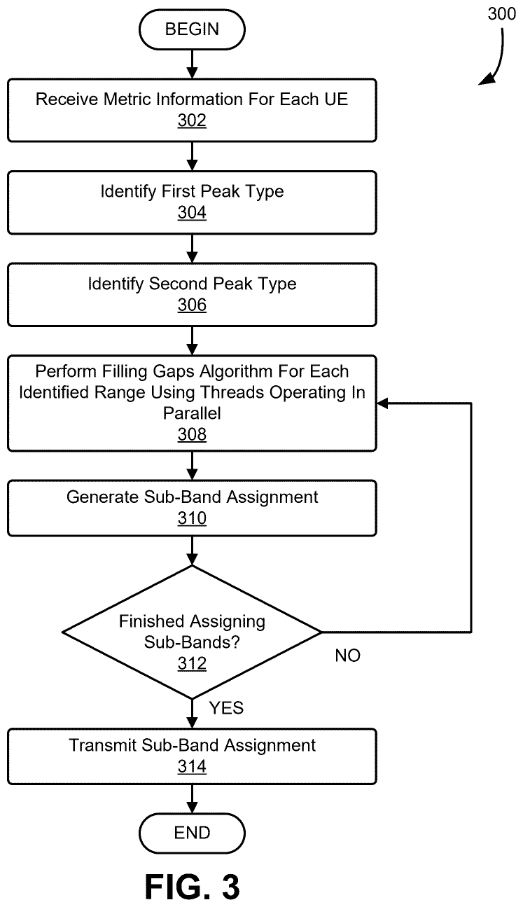

System 100 includes the parallelization of a parallel Riding Peaks algorithm 110, such as by using one or more threads operating in parallel 112. Parallel riding peaks algorithm 110 may include an algorithm used to assign one or more sub-bands to one or more UEs 102 based, at least in part, on peak performance metrics. An example of a parallel Riding Peaks algorithm 110 may generate one or more adjacent sub-band assignments to one or more UEs 102. An output of this algorithm may include a list and/or range of one or more sub-band allocations for each UE 102. In at least one embodiment, a system using a parallelization of Riding Peaks algorithm may perform process 200 (see FIG. 2) and/or process 300 (see FIG. 3). One or more examples of a system performing a parallelization of a Riding Peaks algorithm may be illustrated in FIGS. 2-9. An example of threads operating in parallel 112 may include one or more separate threads identifying peaks concurrently or performing different sub-band assignments concurrently.

One or more sub-band assignments 116 may include an allocation of frequency ranges to one or more UEs 102 for data transmission. This sub-band assignment 116 may be based, at least in part, on one or more metrics like signal quality and/or proportional fairness.

In some embodiments, one or more elements of system 100 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device.

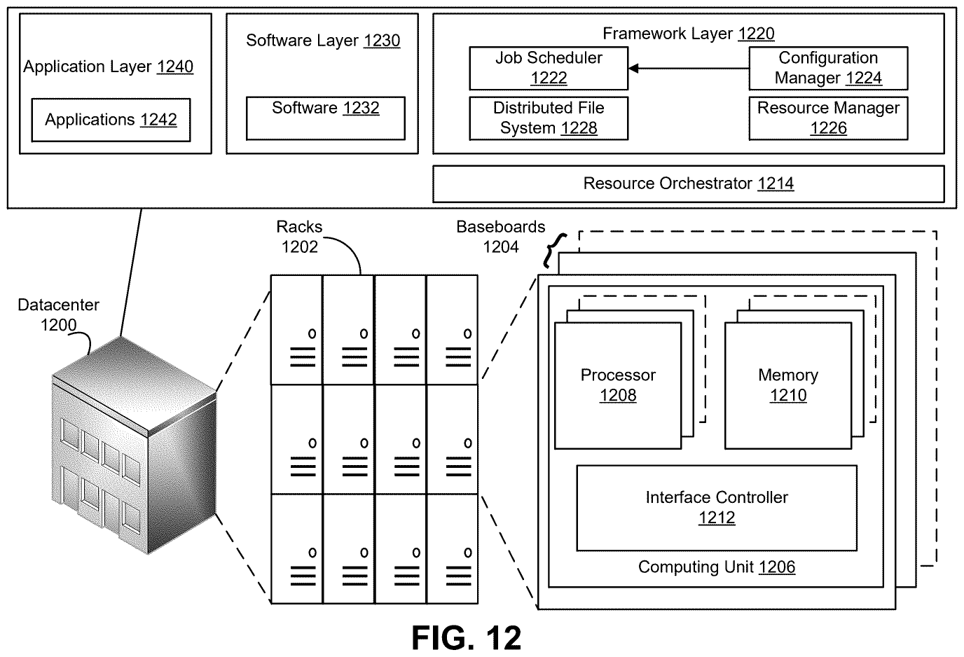

In some embodiments, one or more elements of system 100 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system 100 may perform processes illustrated in FIGS. 1-11, such as to receive performance metric values for each user UE of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system 100 may perform one or more processes as illustrated in FIGS. 12-23A/B to receive performance metric values for each UE of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

In at least one embodiment, system 100 can be an Open Radio Access Network (O-RAN). An O-RAN (Open Radio Access Network) can comprise a distributed architecture with functional components including the Radio Unit (RU), Distributed Unit (DU), and Centralized Unit (CU), interconnected via standardized open interfaces such as the fronthaul (e.g., Open Fronthaul Interface) and midhaul. An O-RAN network can use a Service Management and Orchestration (SMO) framework for centralized control and integrates RAN Intelligent Controllers (RICs) to enable real-time and non-real-time optimization of radio resources. In an O-RAN network, sub-band assignment can be executed by a Centralized Unit (CU), specifically the CU-CP (Control Plane) in coordination with the CU-UP (User Plane). In at least one embodiment, base station 108 can include, use, otherwise perform the functions of a CU, where a CU is responsible for higher-layer RAN functions, including Radio Resource Management (RRM), which involves scheduling, spectrum allocation, and sub-band assignment. As another example, a Near-Real-Time RAN Intelligent Controller (Near-RT RIC) can be involved in sub-band assignment decisions by optimizing resource allocation based on policies, machine learning models, or real-time network conditions.

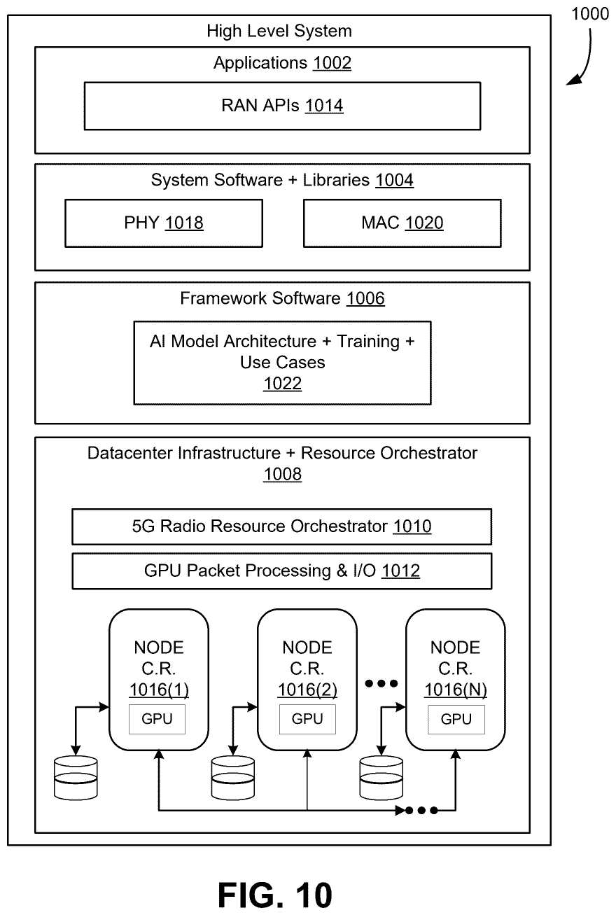

In at least one embodiment, system 100 is comprised of modules (e.g., as illustrated in FIG. 10) such that said system 100 performs a Riding Peaks algorithm using one or more threads operating in parallel. In at least one embodiment, a module includes any combination of any type of logic (e.g., software, hardware, firmware) and/or circuitry configured to perform a function as described. A module may include one or more circuits that form part of a larger system (e.g., an integrated circuit (IC), system-on-chip (SoC), central processing unit (CPU), graphics processing unit (GPU), data processing unit (DPU), etc.). In at least one embodiment, a controller includes any combination of any type of logic (e.g., software, hardware, firmware) and/or circuitry configured to perform a function as described. Software may include software packages, code, programming language, drivers, instructions, instruction sets, or some combination thereof. In at least one embodiment, hardware includes hardwired circuits, programmable circuits, state machine circuits, fixed function circuits, execution unit circuits, firmware with stored instructions executed by programmable circuits, or some combination thereof.

System 100 may include one or more logic units. In at least one embodiment, a logic unit includes firmware logic, hardware logic, or some combination thereof configured to provide any function as described further herein. A logic unit may include circuitry that forms part of a larger system (e.g., IC, SoC, CPU, GPU, DPU). In at least one embodiment, a logic unit includes logic circuitry for implementation of firmware and/or hardware to generate one or more sub-band assignments using a Riding Peaks algorithm with threads operating in parallel.

In at least one embodiment, system 100 includes one or more engines. An engine may include a module and/or logic unit as described further herein. A component may include a module and/or logic unit as described further herein. An engine may include software logic, firmware logic, hardware logic, or some combination thereof configured to provide any function as described further herein. A component may include software logic, firmware logic, hardware logic, or some combination thereof configured to provide any function as described further herein. One or more operations performed by hardware and/or firmware may alternatively be implemented via a software module, which may be embodied as a software package, code and/or instruction set. In at least one embodiment, a logic unit may also utilize a portion of software to implement its function.

System 100 may use a machine learning training framework such as PYTORCH, TENSORFLOW, BOOST, CAFFE, MICROSOFT COGNITIVE TOOLKIT/CNTK, MXNET, CHAINER, KERAS, DEEPLEARNING4J, and/or other training framework to implement and perform operations described herein to generate one or more sub-band assignments using a Riding Peaks algorithm with threads operating in parallel and/or otherwise perform operations described herein. As an example, training a neural network model includes use of a server (e.g., NVIDIA DGX servers) which further includes at least a GPU (e.g., AMD MI200, VEGAL10, VEGO20, AND ARCTURUS), an optimizer (e.g., ADAM OPTIMIZER), or discriminator architecture.

FIG. 2 is a flow diagram illustrating process 200 to generate sub-band assignments performing an algorithm using threads in parallel. A base station, such as base station 108 from FIG. 1, or central unit (CU) can perform part or all of process 200. In at least one embodiment, a simulated base station or simulated radio unit can perform process 200. Each operation of process 200, described herein, comprises a computing process that may be performed using any combination of hardware, firmware, and/or software. For instance, various functions may be carried out using one or more processors executing instructions stored in one or more memories (e.g., a non-transitory computer readable medium storing instructions that can be executed by one or more processors). The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. System 100 of FIG. 1 can perform process 200. Process 200 can additionally or alternatively be executed by any one system, or any combination of systems, including, but not limited to, those described herein.

At operation 202, a base station can receive metric information for each user equipment device (UE). For example, a base station can receive a metric derived from signal attributes for each frequency-UE pair. Metric information can include signal strength, signal-to-noise ratio (SNR), signal-to-interference-plus-noise ratio (SINR), transmission quality indicators (TQI), or other performance metrics measured by the UE when receiving a signal in 5G or 6G networks. Operation 202 can involve a base station receiving performance data from multiple sources (e.g., radio units, other base stations, network cards, data centers) to facilitate subsequent processing. The output at operation 202 can include organized data sets ready for further processing, enabling efficient execution of a parallelized Riding Peaks algorithm.

At operation 204, a base station can identify peaks within received metric information by analyzing performance data obtained from operation 202. For example, identifying peaks is accomplished using a first set of parallel threads that execute a parallel reduction operation to locate peak values for each UE across all sub-bands. The output of this step is a list of sub-bands where each UE has the highest measured performance metric. In some embodiments, such as those described in FIG. 3, operation 202 of identifying peaks includes identifying two peak types: easy peaks and difficult peaks as described in FIG. 3. If at operation 204, a processor performing operation 204 identifies a peak that is a highest value for a UE within a sub-band and the highest value for all sub-bands, a processor can assign this sub-band to a UE device. Note that additional assignments of sub-bands should be contiguous after a peak is assigned to a UE as a sub-band. Once peaks are identified, a subsequent operation fills gaps between them by assigning remaining unallocated sub-bands to the most appropriate UE device. At operation 204, a base station uses one or more PPUs and a multi-threaded approach to perform parallel processing of metric determination, peak identification, and sub-band allocation. For example, a first parallel reduction operation can identify the highest performance metric per UE across sub-bands. As another example, a second parallel reduction can determine the highest performing UE for each sub-band. As another example, a parallel prefix minimum operation can validate peak selections, using threads to compute prefix minimum values across sub-bands. In at least one embodiment, operation 204 is performed using one or more threads operating in parallel.

At operation 206, a base station can execute a fill gaps algorithm, which is part of a parallel version of the Riding Peaks algorithm, for each identified range using independent threads. For example, if a GPU identifies two peaks in operation 204, where one peak corresponds to a first UE with a maximum metric and another peak corresponds to a second UE with its maximum metric, a gap exists between these peaks. Since sub-band assignments should be contiguous, a PPU can detect this gap and determine whether the first or second UE should receive adjacent frequencies by comparing metrics for each UE within this gap. Operation 204 can also reveal multiple gaps where two UEs are candidates for a sub-band assignment. A CPU can cause a PPU to launch separate, independent threads to assign frequencies within each gap, allowing one group of threads to operate independently of another for each separate gap. A second set of parallel threads refines assignments by identifying the nearest allocated sub-bands and extending allocations to optimize spectral efficiency. In general, operation 206 considers bounding peaks and determines which UE should receive each unallocated sub-band by comparing performance metrics for sub-band in the gap (e.g., within a frequency range founded by identified peaks). In at least one embodiment, filling gaps can also include using peaks identified in different ways such as those disclosed in FIG. 3. In at least one embodiment, operation 206 is performed using one or more threads operating in parallel (e.g., a processor performing different threads concurrently, simultaneously, or otherwise at the same time).

At operation 208, a base station can generate a sub-band assignment for each UE device. This assignment can be determined based on the peak identification and gap-filling operations performed in previous steps. The output of this step can be a structured allocation of sub-bands to individual UEs. An example sub-band assignment is shown below in Table 1:

| UE Device | Assigned Sub-Band(s) |
|---|---|
| UE1 | 5, 6 |
| UE2 | 10, 11 |
| UE3 | 15 |
| UE4 | 20, 21, 22 |

At decision operation 210, a base station can determine whether the sub-band assignment process is complete. This step can include determining whether all sub-bands have been allocated in accordance with peak identification and gap-filling as discussed in operation 206. If additional assignments are needed, a base station can determine that the process should return to operation 206 to continue filling gaps. If a base station determines that all required sub-band assignments have been made in accordance with the Riding Peaks algorithm, the process can proceed to operation 212. The process can be repeated as necessary to adapt to changing network conditions or dynamic user requirements, e.g., it can be repeated by a base station each time sub-band assignments occur.

At operation 212, a base station can transmit the finalized sub-band assignments. This step can include providing the generated assignments to UEs, ensuring they receive their designated sub-bands for data transmission. A base station can end process 200 after all sub-bands have been assigned, or process 200 can be repeated for subsequent slots or as part of regular 5G and 6G communication between a base station and a UE device. Additionally, process 200 can be applied in MIMO (Multiple-Input Multiple-Output) systems to optimize spectral efficiency and increase or maximize data throughput across multiple antennas. The process can be executed iteratively to accommodate new UEs or fluctuating network conditions.

Some or all of process 200 (or any other methods described herein, or variations and/or combinations thereof) may be performed under the control of one or more computer systems configured with computer executable instructions and may be implemented as code (e.g., computer executable instructions, one or more computer programs, or one or more applications) executing collectively on one or more processors, by hardware, software, or combinations thereof. Code may be stored on a computer-readable storage medium in the form of a computer program comprising a plurality of computer-readable instructions executable by one or more processors. A computer-readable storage medium may be a non-transitory computer-readable medium. At least some computer-readable instructions are usable to perform process 200, which may not be stored solely using transitory signals (e.g., a propagating transient electric or electromagnetic transmission). A non-transitory computer-readable medium may not necessarily include non-transitory data storage circuitry (e.g., buffers, caches, and queues) within transceivers of transitory signals. Process 200 may be performed at least in part on a computer system such as those described elsewhere in this disclosure. Logic (e.g., hardware, software, or a combination of hardware and software) may perform process 200.

In some embodiments, processors may use process 200 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, as an example, a machine-readable medium having stored thereon a set of instructions, which if performed by one or more processors, can cause said processors to receive performance metric values for each UE of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, process 200 includes, is included in, and/or otherwise includes systems illustrated in FIGS. 1-11. In some embodiments, process 200 is performed by one or more systems illustrated in FIGS. 1-11. In some embodiments, process 200 is performed by one or more systems illustrated in FIGS. 12-23A/B.

FIG. 3 illustrates process 300, which a base station can execute to perform sub-band assignment (e.g., in a 3G, 4G, 5G, 6G, LTE, or other wireless standard). In at least one embodiment, a base station executes process 300 in three phases: (1) identifying easy peaks, (2) identifying difficult peaks, and (3) filling gaps. Process 300 can be performed using system 100. Part or all of process 300 can be combined with part or all of process 200.

At operation 302, a base station begins execution by receiving performance metric values for each UE across multiple sub-bands. For example, a base station can receive a metric derived from signal attributes for each frequency-UE pair. A base station processes this data to establish a basis for subsequent peak identification and assignment operations. A base station can receive and store this data to facilitate efficient processing through parallelized operations.

At operation 304, a base station identifies one or more first peak types (e.g., easy peaks) by determining that one or more performance metric values are a maximum in a sub-band compared to all sub-bands for a UE and a maximum compared to the same performance metric for any other UE in the same sub-band. The base station executes this determination in parallel by performing a first reduction operation using first threads and a second reduction operation using second threads, such as by finding one or more easy peaks and using parallel processing using one or more parallel reductions. A base station can determine easy peaks using parallel reductions, which allow e.g., a simultaneous computation of highest PF values for each sub-band. For example, if a UE reports highest proportional fairness score at sub-band 4 and no other UE has a higher value at that sub-band, a base station designates sub-band 4 as an easy peak for that UE. In at least one embodiment, operation 304 is performed using one or more threads operating in parallel.

To assign a first peak type, a base station including one or more processors can use the following equations, which use proportional fairness as a performance metric, but other performance metrics could be used too:

| | |
|---|---|
| λ | Proportional Fairness (‘metric’) function of (UE, sub-band) (i, c) |
| ${λ}_{i}^{c}$ | Proportional Fairness, for UE = i and sub-band = c |
| ${c}_{i} = {max}_{c} \{ {λ}_{i}^{c} \}$ | Sub-band corresponding to the maximum λ for a given UE = i |
| Pᵢ | Designated sub-band ‘Peak’ for UE = i |
| ${P}_{i}^{-} , {P}_{i}^{+}$ | Sub-bands of ‘lower’ and ‘upper’ neighboring peaks, to the (proposed) peak |
| | of UE(i) |
| ${U}_{i}^{-} , {U}_{i}^{+}$ | ‘lower’ and ‘upper’ neighboring UEs with ‘peaks’ defined |
| ${R}_{i}^{-} \to {R}_{i}^{+}$ | ‘Sub-band range’ of a particular UE, i |

For each UE, i;
Find the sub-band, cᵢ, where

$${λ}_{i}^{c}$$

is maximized, e.g., by performing parallel reduction operations with parallel, concurrent, or otherwise simultaneous threads:

$${c}_{i} = {max}_{c} ( {λ}_{i}^{c} )$$

IF: this UE is also the UE which has the max λ at cᵢ:

$$If {λ}_{i}^{{c}_{i}} > {λ}_{j}^{{c}_{i}} ∀ j \neq i$$

THEN: cᵢ is a ‘peak’ for UE(i):

Pᵢ=cᵢ

Zero the metrics for all other UEs at sub-bands where peaks have been found:

$${λ}_{j}^{{P}_{i}} = 0 ∀ j \neq i$$

At operation 306, a base station identifies one or more second peak type (e.g., difficult peak) by performing a parallel prefix minimum operation. The base station performs the parallel prefix minimum operation using third threads and fourth threads in parallel to compute prefix minimum values across sub-bands. Difficult peaks exist where a UE's metric is locally high but does not meet easy peak criteria. One or more difficult peaks may be found from one or more candidate peaks, such as one or more peaks that are the maximum metrics over all UEs which do not have peaks defined. These candidate peaks may be selected as peaks if the metric is larger than the minimum metric of the neighbor peaks in the interval between the candidate and the neighbors. A base station may apply one or more parallel-prefix-min operations to the defined peaks to efficiently determine whether candidate peaks meet this criteria. The candidate peak, and the metrics in the associated interval, may then be zeroed if the interval when they are not larger than the minimum of the neighbor UEs metrics in the interval. For example, when a candidate peak fails, and its' metrics are zeroed over an interval, the sub-band for the max of its remaining metrics can be found again, which can again use a parallel reduction If a candidate peak metric exceeds prefix-minimum of adjacent UEs, a base station validates and assigns peak. For instance, if sub-band 10 qualifies as a candidate for assignment to a UE, but sub-band 8, assigned to a different UE, has a minimum metric that is greater than candidate UE's metric at sub-band 10, a base station refrains from assigning sub-band 10 to that UE. However, if candidate metric at sub-band 10 exceeds prefix-minimum for its neighboring sub-bands, a base station assigns sub-band 10 accordingly. In at least one embodiment, operation 306 is performed using one or more threads operating in parallel.

To perform operation 306 to identify a second peak type, a base station using one or more processors can use the following equations, which can be part of an algorithm:
WHILE there are UEs with unassigned peaks, and these UEs have some λ>0;
Find the UE, without a peak, with the max λ:

$${c}_{i} = {max}_{j} ( {λ}_{j}^{c} ) ∀ \{ c , j with unassigned peaks \}$$

IF the cᵢ is greater than the min of the neighbor peaks in the intervening sub-bands

$$( {λ}_{i}^{{c}_{i}} ) > min ( {λ}_{{U}_{i}^{-}}^{k} , k = \{ {P}_{i}^{-} , … , {c}_{i} \} ) AND$$

$$( {λ}_{i}^{{c}_{i}} ) > min ( {λ}_{{U}_{i}^{+}}^{k} , k = \{ {c}_{i} , … , {P}_{i}^{+} \} )$$

THEN this is a peak

$${P}_{i} = {c}_{i}$$

ELSE zero the span

$${λ}_{i}^{k} = 0 , k = \{ {P}_{i}^{-} , … , {c}_{i} \} \{ {c}_{i} , … , {P}_{i}^{+} \}$$

(whichever range was not true above)

At operation 308, a base station executes a filling gaps algorithm to allocate sub-bands between identified peaks from operations 304 and 306. The base station executes parallel threads for each gap, with each thread processing an unallocated sub-band by determining the nearest assigned sub-band and assigning the unallocated sub-band to a UE. For example, a single thread can fill each gap, where there are multiple single threads filling each gap. A base station executes this operation in parallel, assigning each unassigned sub-band to one of two bounding peaks (e.g., as identified in operations 304 and 306). Because each gap involves only two candidate UEs, a base station performs independent parallel operations to determine UE with highest PF metric for each gap. For example, if UE X has received an assignment for sub-band 3 because it had the highest signal strength at sub-band 3 and UE Y has received an assignment for sub-band 7, and sub-bands 4, 5, and 6 remain unassigned, a base station executes filling gaps operation by assigning those sub-bands to either UE X or UE Y comparing metric performance for UE X and UE Y in that range. In at least one embodiment, operation 308 is performed using one or more threads operating in parallel.

As an example, a fill gaps algorithm may include one or more operations or variations thereof. Left and right may be used to refer to lower and higher sub-bands. As an example, within a gap the metric in the leftmost unassigned sub-band associated with the UE of the left peak is compared to the metric in the rightmost unassigned sub-band associated with the UE of the right peak. Whichever metric is greater may have its associated sub-band assigned to its associated UE. This process may continue until all sub-bands in the gap have been filled. As another example, a processor may re-use one or more results of the already performed parallel prefix-minimums, determining where these prefix minimums cross. Sub-bands to the left of where these cross may be assigned to the UE of the left peak. Sub-bands to the right may be assigned to the UE of the right peak. As an example, this ‘crossing’ occurs between two sub-bands.

At operation 310, a base station finalizes sub-band assignments based on results of filling gaps operation from operation 308. A base station ensures that all UEs receive contiguous sub-band allocations that maximize proportional fairness while maintaining continuity of assigned sub-band ranges. For example, after executing filling gaps, a base station may assign sub-bands 3 through 6 to UE X and sub-bands 7 through 9 to UE Y. At decision operation 312, a base station determines whether all sub-bands have been assigned. If unassigned sub-bands remain, a base station returns to operation 308 to refine assignment. If all sub-bands have been assigned, a base station proceeds to operation 314 and transmits final sub-band allocation to a radio unit and/or UEs via another network component. In at least one embodiment, performing operations in parallel includes using an embarrassingly-parallel algorithm that is parallelized over all sub-bands. For example, ∥ sub-bands can indicate performing parallel operations (e.g., embarrassingly-parallel) algorithms overall sub-bands (e.g., 68), which indicate at least some (e.g., all) threads performing this algorithm can be performed in parallel, concurrently, or simultaneously as disclosed in this application.

Process 300 can include the following steps:

| | |
|---|---|
| Find max UE at each sub-band | \|\| sub-bands |
| Easy Peaks | |
| Find max sub-band for each UE | \|\| reduction |
| Find ‘easy’ peaks | \|\| UEs |
| Zero other UEs where peaks found | \|\| UEs |
| Prefix-min of UEs with found peaks | \|\| prefix-min |
| Find max sub-band for remaining UEs | \|\| reduction |
| Difficult Peaks | |
| WHILE unfound peaks not all zero | |
| Find UE with max metric | \|\| reduction |
| Find neighbors | \|\| UEs |
| IF metric > neighbor prefix mins at | |
| Define peak for this UE | |
| Perform prefix-min on UE with new peak | \|\| prefix-min |
| ELSE | |
| Zero intervals | \|\| interval |
| Find max sub-band, c_i, for updated UE | \|\| reduction |
| Fill gaps using neighbor prefix mins | \|\| UEs |

As an example, n is a total number of metrics over all UEs, such as sub-bands multiplied by a number of UEs.

By executing process 300, a base station significantly improves performance over serial Riding Peaks algorithms, which can require quadratic complexity (O(n²)) to assign sub-bands sequentially. Specifically, n can be the total number of metrics over all UEs or the number of sub-bands times number of UEs′. Parallel Riding Peaks algorithm identifies peaks in parallel and assigns gaps efficiently using prefix-min operations, reducing execution time. A base station identifies easy peaks using parallel reductions, validates difficult peaks via prefix-minimums, and allocates unassigned sub-bands through independent parallel gap-filling operations.

Some or all of process 300 (or any other methods described herein, or variations and/or combinations thereof) may be performed under the control of one or more computer systems configured with computer executable instructions and may be implemented as code (e.g., computer executable instructions, one or more computer programs, or one or more applications) executing collectively on one or more processors, by hardware, software, or combinations thereof. Code may be stored on a computer-readable storage medium in the form of a computer program comprising a plurality of computer-readable instructions executable by one or more processors. A computer-readable storage medium may be a non-transitory computer-readable medium. At least some computer-readable instructions usable to perform process 300 may not be stored solely using transitory signals (e.g., a propagating transient electric or electromagnetic transmission). A non-transitory computer-readable medium may not necessarily include non-transitory data storage circuitry (e.g., buffers, caches, and queues) within transceivers of transitory signals. Process 300 may be performed at least in part on a computer system such as those described elsewhere in this disclosure. Logic (e.g., hardware, software, or a combination of hardware and software) may perform process 300.

In some embodiments, processors may use process 300 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, as an example, a machine-readable medium having stored thereon a set of instructions, which if performed by one or more processors, can cause said processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, process 300 includes, is included in, and/or otherwise includes systems illustrated in FIGS. 1-11. In some embodiments, process 300 is performed by one or more systems illustrated in FIGS. 1-11. In some embodiments, process 300 is performed by one or more systems illustrated in FIGS. 12-23A/B.

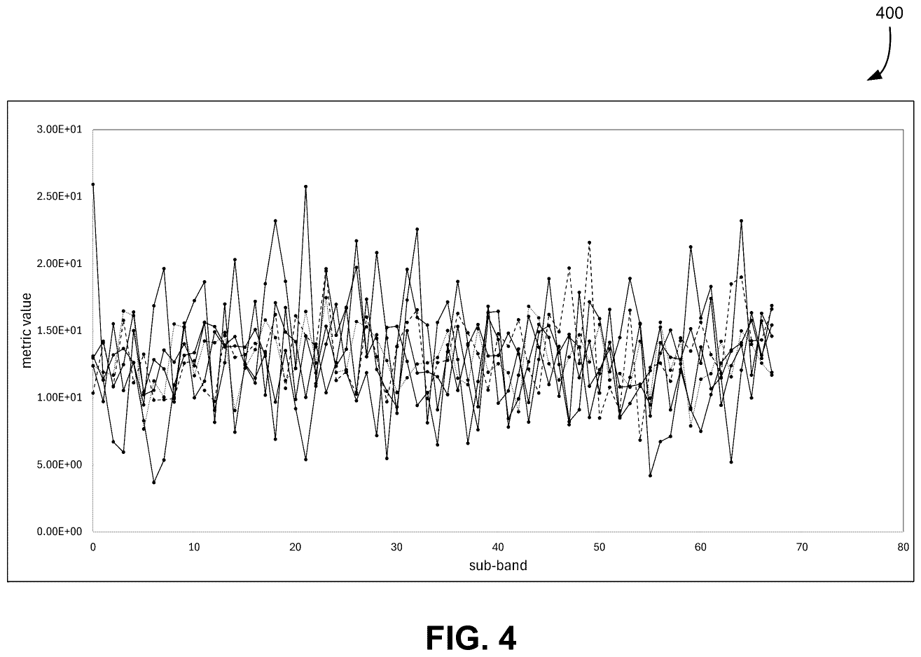

FIG. 4 illustrates graph 400 of performance metrics for user equipment devices (UEs) across different sub-bands, in accordance with at least one embodiment. The horizontal axis of FIG. 4 represents sub-bands (e.g., 68 sub-bands), while the vertical axis represents the performance metric values. As an example, graph 400 may include 6 UEs and 68 sub-bands to be allocated. Each data series corresponds to a different UE. For example, a dashed line corresponds to how one UE behaves across sub-bands for one metric and a solid line corresponds to how another UEs behaves across sub-bands for that same metric. The performance metric values can correspond to signal strength, signal-to-noise ratio (SNR), signal-to-interference ratio (SIR), or proportional fairness, among other relevant wireless communication metrics. Proportional fairness can be measured as an instantaneous value based on the most recent transmission data, as a time-averaged metric that smooths variations over multiple transmission intervals, or by other statistical techniques that assess long-term fairness in resource distribution.

A base station, centralized unit, or other computing unit for assigning sub-bands receives these values from UEs to determine optimal sub-band assignments based on specific conditions. For example, if the performance metric represents signal strength, a higher value at a given sub-band indicates that a UE experiences better channel conditions in that frequency range. Similarly, if the performance metric corresponds to SNR, the base station may prioritize assigning sub-bands where a UE has a high SNR to maximize data throughput and reduce transmission errors.

In some embodiments, one or more elements of graph 400 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 400 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 400 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein.

In some embodiments, elements of graph 400 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

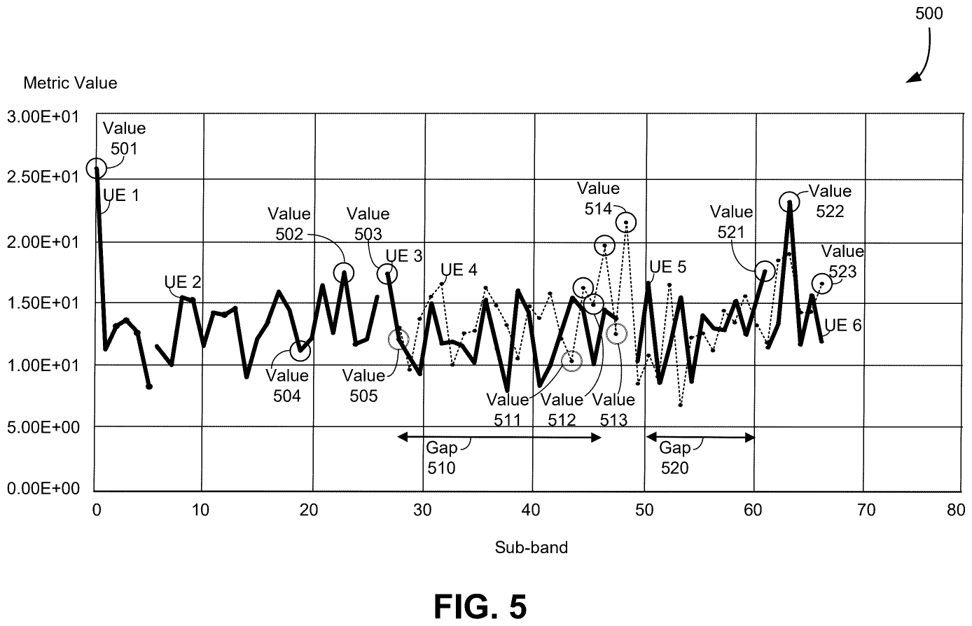

FIG. 5 illustrates a graph of metrics for user equipment devices with indications of peaks and gaps to be filled to assign sub-bands to the user equipment devices, in accordance with at least one embodiment. FIG. 5 illustrates graph 500, which includes values 501, 502, 503, 504, 505, 511, 512, 513, 514, 521, 522, and 523. Values represent performance metric values for a particular UE at a particular sub-band. Using data from FIG. 4 and process 200 or process 300 from FIGS. 2 and 3, a base station identified easy peaks, e.g., value 501, value 514, and value 522. These identified easy peaks can be used to assign respective sub-bands to specific UEs such as sub-band 0 to UE 1, sub-band 49 to UE 2, and sub-band 64 to UE 6. Using identified peaks (e.g., easy peaks or difficult peaks), a base station can identify gaps. For example, gaps 510 and 520 can represent ranges were a base station executes process 200 or process 300 (e.g., using system 100) to identify gaps that need to be filled (e.g., a range of sub-bands where two UE candidates can be assigned); specifically filling gap 510 and gap 520 such that each sub-band in that gap is assigned to a UE device.

Specifically, when a base station identifies gaps 510 and 520, a processor (e.g., GPU) can use separate independent threads to assign unallocated sub-bands by determining the nearest assigned sub-band to an unassigned sub-band and comparing performance metrics such as proportional fairness or signal strength for each UE in that gap. As an example, a processor may determine which unassigned sub-bands are adjacent to one or more assigned sub-bands and comparing metrics.

One or more elements of graph 500 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 500 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 500 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 500 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

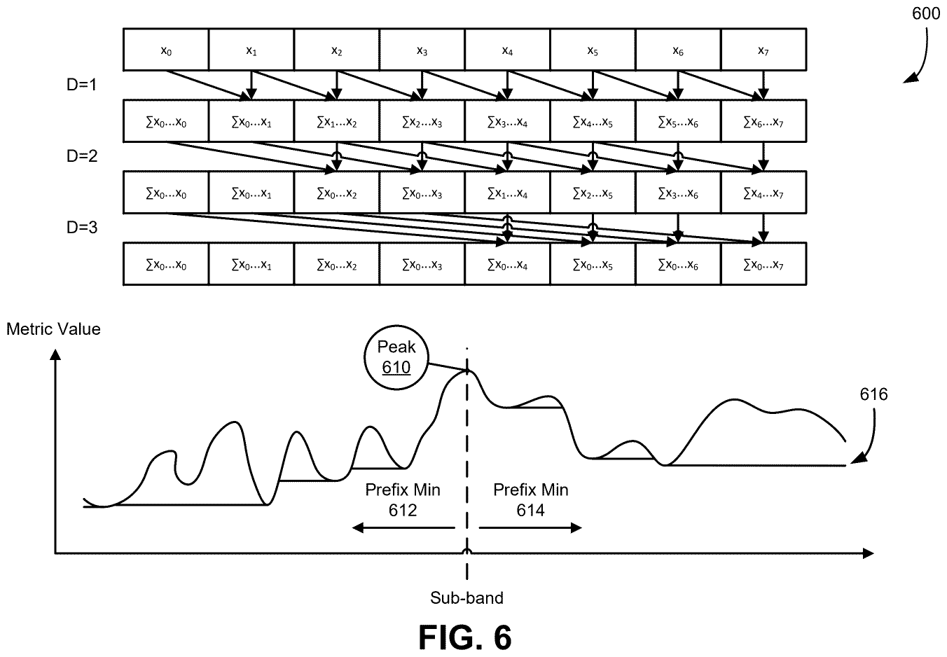

FIG. 6 illustrates an overview of prefix min sums that are used by one or more processors when identifying peaks. For example, a base station uses prefix min sums as disclosed in FIGS. 2 and 3 when performing process 200 or process 300. Specifically, a base station can use prefix min to identify difficult peaks. As another example, system 100 can also perform, execute, or otherwise use prefix sums to identify, confirm, or otherwise validate peaks that can be used in allocation of sub-bands. As an example, graph 600 may include a parallel algorithm for finding the prefix-sum of one or more values (e.g., 8) using one or more (e.g., 3) steps in parallel (e.g., log 2(n) steps).

The prefix-minimums may be applied, first to one or more found ‘easy peaks’. These prefix minimums may then be used to efficiently find the ‘difficult peaks’. As each difficult peak is found, its prefix-minimum may be computed which then, together with the previously computed prefix-mins, is used to find subsequent ‘difficult peaks’. Once all the peaks have been found, then the existing prefix-minimums may be used to efficiently fill the gaps between peaks.

A base station or system 100 can identify a peak type (e.g., difficult peak) by executing a parallel prefix minimum operation, where prefix minimum computations extend outward from peak 610 to establish boundaries for fill gaps operations by performing a parallel prefix minimum operation. For example, a base station executes this operation using different thread groups in parallel to determine minimums on each side of a peak such as peak 610. As shown in FIG. 6, peak 610 represents a detected difficult peak, with prefix minimum values 612 and 614 used to validate peak 610 by ensuring that its metric exceeds adjacent minimum values. Prefix minimum computations extend outward from peak 610 to establish boundaries for fill gaps operations.

The diagram in the upper portion of FIG. 6 illustrates a hierarchical summation process used in peak detection and validation, which correspond to iterations in hierarchical prefix sum computations used for efficient peak detection, where each depth represents an iteration of summation and reduction operations applied to performance metric values.

In some embodiments, one or more elements of graph 600 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 600 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 600 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 600 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and

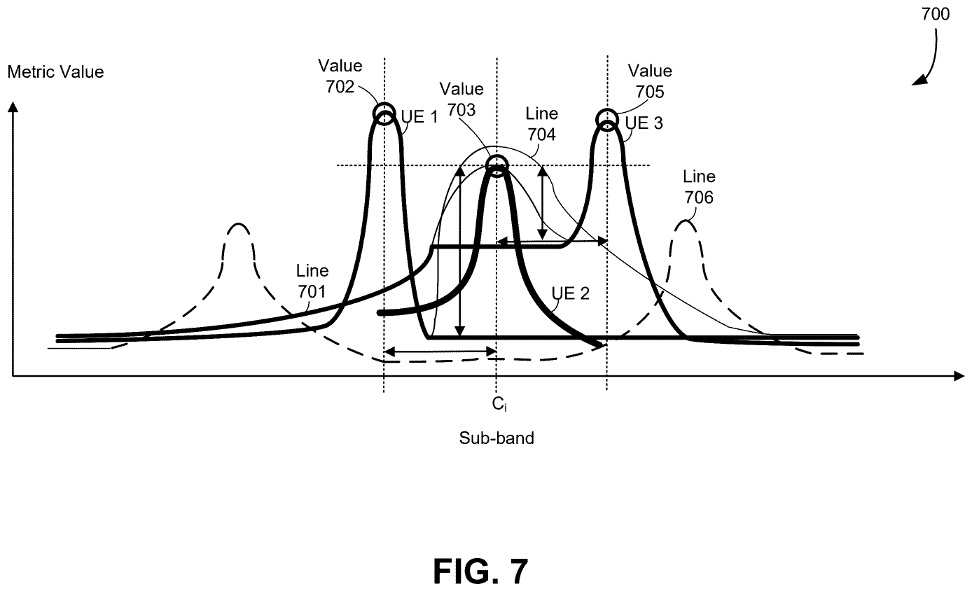

FIG. 7 illustrates graph 700, which is an example for how to identify and validate a difficult peak as discussed in FIGS. 1-6. The horizontal axis represents sub-bands, while the vertical axis represents performance metric values such as proportional fairness, signal strength, or signal-to-noise ratio (SNR). Graph 700 includes values 702, 703, and 705, which indicate identified peaks for UE 1, UE 2, and UE 3, respectively. Lines 701, 704, and 706 represent boundary conditions and transitions between assigned sub-bands. As an example, values 702 and 705 may be established peaks, either easy or difficult Value 703 may illustrate a candidate ‘difficult peak’ that is a maximum of UE2, but below metrics for UE1 and UE3. As an example, since 703 is higher than the minimum metric for UE1 in the interval between 702 and 703, and 703 is also higher than the minimum metric for UE3 in the interval between 703 and 705, then 703 is a peak. Since the prefix-mins for 702 and 705 may have already been computed, 703 can be efficiently validated as a peak simply by comparing value 703 to the prefix mins of 702 and 705 at the sub-band of value 703.

These peaks correspond to sub-bands where each UE has the highest performance metric relative to its neighboring sub-bands. To identify difficult peaks, a base station can use parallel prefix min operations as described in FIG. 5 started at each peak. An algorithm, used by one or more processors, in FIG. 7 includes the following equations:
WHILE there are UEs with unassigned peaks, and these UEs have some λ>0;
Find the UE, without a peak, with the max A:

$$i = {max}_{j} ( {λ}_{j}^{c} ) ∀ \{ c , j with unassigned peaks \}$$

(Need to assign in order, so this must be done each time)
IF the cᵢ is greater than the min of the neighbor peaks in the intervening sub-bands

$$( {λ}_{i}^{{c}_{i}} ) > min ( {λ}_{{U}_{i}^{-}}^{k} , k = \{ {P}_{i}^{-} , … , {c}_{i} \} ) AND$$

$$( {λ}_{i}^{{c}_{i}} ) > min ( {λ}_{{U}_{i}^{+}}^{k} , k = \{ {c}_{i} , … , {P}_{i}^{+} \} )$$

THEN this is a peak

$${P}_{i} = {c}_{i}$$

ELSE zero the span

$${λ}_{i}^{k} = 0 , k = \{ {P}_{i}^{-} , … , {c}_{i} \} \{ {c}_{i} , … , {P}_{i}^{+} \}$$

(whichever range was not true above)

The base station executes a fill gaps algorithm to allocate unassigned sub-bands between identified peaks. The base station may process one or more gaps by comparing metric values of unassigned sub-bands adjacent to assigned sub-bands of the same UE and assigning the sub-band with the highest metric to its associated UE. The algorithm ensures that no sub-band assignment extends beyond a neighboring peak, preventing interference and maintaining contiguous allocations.

As an example, proportional fairness may otherwise be substituted and/or used in combination with one or more metrics indicating a quality of a signal. As an example, one or more unassigned sub-bands between UE 1 and UE 2 may be assigned to either UE 1 or UE2. Each sub-band may be assigned to the UE whose prefix minimum is the maximum for that sub-band. For example, if sub-band Ci represents an unassigned sub-band between UE 1 and UE 2, the base station evaluates the proportional fairness values of these UEs within that interval. If UE 1 has a higher proportional fairness metric at Ci than the prefix minimum of UE 2, the base station assigns sub-band Ci to UE 1. Otherwise, UE 2 receives the sub-band assignment. This process continues iteratively until all sub-bands are assigned, ensuring efficient and contiguous allocation of resources.

In some embodiments, one or more elements of graph 700 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 700 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 700 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 700 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and

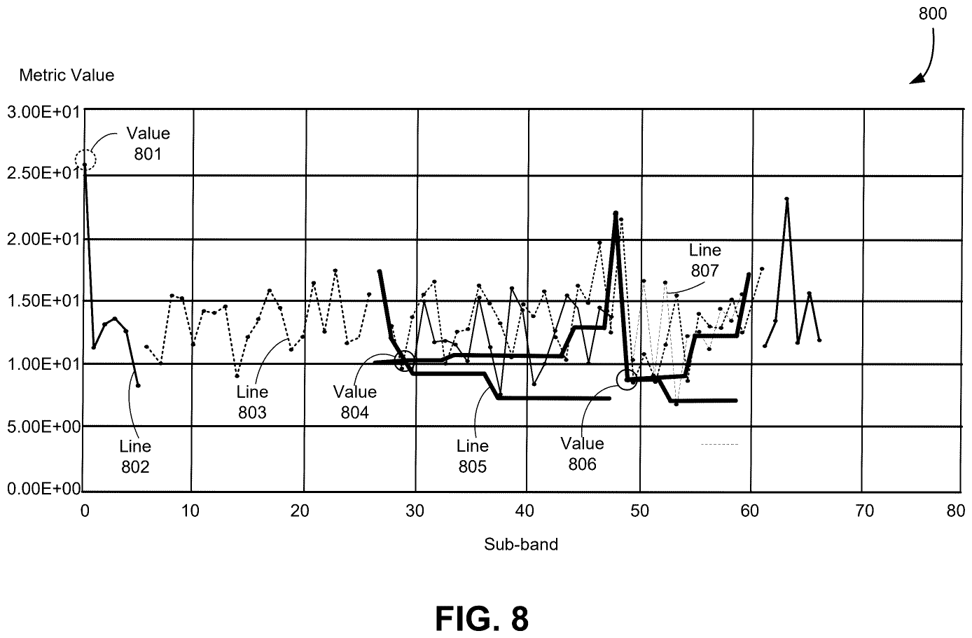

FIG. 8 illustrates graph 800, which represents the identification of peaks and the application of prefix sum minimums for a sub-band assignment in a wireless communication system. The horizontal axis represents sub-bands, while the vertical axis represents performance metric values, such as signal strength, proportional fairness, or signal-to-noise ratio (SNR).

Graph 800 includes values 801, 804, and 806, which indicate detected peaks or significant points in the metric data. As an example, values 804 and 806 may correspond to where one or more prefix minimum values intersect. The intersection of prefix minimums within a ‘gap’ may indicate which sub-bands in the gap belong to which UE. The one or more sub-bands to the left of the intersection may be assigned to the UE of the peak on the left. The one or more sub-bands to the right of the intersection may be assigned to the UE of the peak on the right. The one or more intersections may not be used to identify difficult peaks.

Value 801 represents a peak where a user equipment device (UE) has a maximum metric value for a specific sub-band. Values 804 and 806 correspond to where prefix minimum values intersect, which can be used to verify a candidate peak as a difficult peak. Line 802 indicates sub-bands that have been assigned to UE 1, Line 803 indicates lines that have been assigned to UE 2, and Line 807 indicates performance metric values corresponding to another UE device. Line 805 indicates a prefix minimum value for a UE that is used to identify a difficult peak. In at least one embodiment, a base station can use an intersection of prefix min sums for different UEs corresponding to different peaks to assign sub-bands.

In some embodiments, one or more elements of graph 800 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 800 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 800 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 800 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

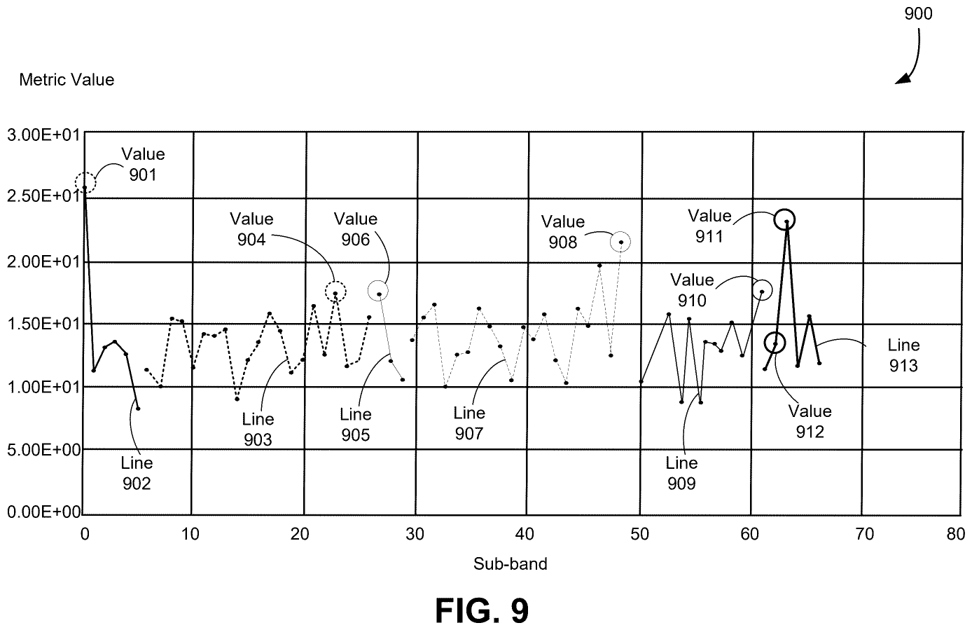

FIG. 9 illustrates graph 900, which represents final sub-band assignments after executing the peak identification and fill gaps algorithm. The horizontal axis represents sub-bands, while the vertical axis represents metric values such as proportional fairness, signal strength, or signal-to-noise ratio (SNR). The base station applies the parallel Riding Peaks algorithm to optimize sub-band allocation, ensuring contiguous assignments while maximizing spectral efficiency. Graph 900 includes values 901, 904, 906, 908, 910, 911, and 912. Graph 900 includes Lines 902 corresponding to a first UE and its assigned sub-bands, 903 corresponding to a second UE and its assigned sub-bands, 905 corresponding to a third UE and its assigned sub-bands, Line 907 corresponding to a fourth UE and its assigned sub-bands, Line 909 corresponding to a fifth UE and its assigned sub-bands, and Line 913 corresponding to a sixth UE and its assigned sub-bands.

In some embodiments, one or more elements of graph 900 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of graph 900 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 900 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of graph 900 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

FIG. 10 illustrates an system 1000 that can be used to perform operations or in combination with components disclosed in FIGS. 1-9. In at least one embodiment, system 1000 includes applications 1002, system software+libraries 1004, framework software 1006 and a datacenter infrastructure+resource orchestrator 1008. In at least one embodiment, system 1000 may be implemented as a cloud service, physical service, virtual service, network service, and/or variations thereof.

As shown in FIG. 10, datacenter infrastructure+resource orchestrator 1008 may include 5G radio resource orchestrator 1010, GPU packet processing & I/O 1012, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors (“GPUs”), etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, 5G radio resource orchestrator 1010 may configure or otherwise control one or more node C.R.s 1016(1)-1016(N) and/or other various components and resources a 5G network architecture may comprise. In at least one embodiment, 5G radio resource orchestrator 1010 may include a software design infrastructure (“SDI”) management entity for system 1000. In at least one embodiment, 5G radio resource orchestrator 1010 may include hardware, software, or some combination thereof. In at least one embodiment, 5G radio resource orchestrator 1010 may be utilized to configure or otherwise control various medium access control sublayers, radio access networks, physical layers or sublayers, and/or variations thereof, which may be part of a 5G network architecture. In at least one embodiment, 5G radio resource orchestrator 1010 may configure or allocate grouped compute, network, memory or storage resources to support one or more workloads which may be executed as part of a 5G network architecture.

In at least one embodiment, GPU packet processing & I/O 1012 may configure or otherwise process various inputs and outputs, as well as packets such as data packets, which may be transmitted/received as part of a 5G network architecture, which may be implemented by system 1000. In at least one embodiment, a packet may be data formatted to be provided by a network and may be typically divided into control information and payload (e.g., user data). In at least one embodiment, types of packets may include Internet Protocol version 4 (IPv4) packets, Internet Protocol version 6 (IPv6) packets, and Ethernet II frame packets. In at least one embodiment, control data of a data packet may be classified into data integrity fields and semantic fields. In at least one embodiment, network connections that a data packet may be received upon include a local area network, a wide-area network, a virtual private network, Internet, an intranet, an extranet, a public switched telephone network, an infrared network, a wireless network, a satellite network, and any combination thereof.

In at least one embodiment, framework software 1006 includes an AI Model Architecture+Training+Use Cases 1022. In at least one embodiment, AI Model Architecture+Training+Use Cases 1022 may include tools, services, software, or other resources to train one or more machine learning models or predict or infer information using one or more machine learning models according to one or more embodiments. For example, in at least one embodiment, a machine learning model may be trained by calculating weight parameters according to a neural network architecture using software and computing resources described above with respect to system 1000. In at least one embodiment, trained machine learning models corresponding to one or more neural networks may be used to infer or predict information using resources described above with respect to system 1000 by using weight parameters calculated through one or more training techniques. In at least one embodiment, framework software 1006 may include a framework to support system software+libraries 1004 and applications 1002.

In at least one embodiment, system software+libraries 1004 or applications 1002 may respectively include web-based service software or applications, such as those provided by Amazon Web Services, Google Cloud and Microsoft Azure. In at least one embodiment, framework software 1006 may include, but is not limited to, a type of free and open-source software web application framework such as Apache Spark™ (hereinafter “Spark”). In at least one embodiment, system software+libraries 1004 may include software used by at least portions of node C.R.s 1016(1)-1016(N). In at least one embodiment, one or more types of software may include, but are not limited to, Internet web page search software, e-mail virus scan software, database software, and streaming video content software.

In at least one embodiment, PHY 1018 is a set of system software and libraries configured to provide an interface with a physical layer of a wireless technology, which may be a physical layer such as a 5G New Radio (NR) physical layer. In at least one embodiment, an NR physical layer utilizes a flexible and scalable design and may comprise various components and technologies, such as modulation schemes, waveform structures, frame structures, reference signals, multi-antenna transmission and channel coding.

In at least one embodiment, a NR physical layer supports quadrature phase shift keying (QPSK), 16 quadrature amplitude modulation (QAM), 64 QAM and 256 QAM modulation formats. In at least one embodiment, different modulation schemes for different user entity (UE) categories may also be included in a NR physical layer. In at least one embodiment, a NR physical layer may utilize cyclic prefix orthogonal frequency division multiplexing (CP-OFDM) with a scalable numerology (subcarrier spacing, cyclic prefix) in both uplink (UL) and downlink (DL) up to at least 52.6 GHz. In at least one embodiment, a NR physical layer may support discrete Fourier transform spread orthogonal frequency division multiplexing (DFT-SOFDM) in UL for coverage-limited scenarios, with single stream transmissions (that is, without spatial multiplexing).

In at least one embodiment, a NR frame supports time division duplex (TDD) and frequency division duplex (FDD) transmissions and operation in both licensed and unlicensed spectrum, which enables very low latency, fast hybrid automatic repeat request (HARQ) acknowledgements, dynamic TDD, coexistence with LTE and transmissions of variable length (for example, short duration for ultra-reliable low-latency communications (URLLC) and long duration for enhanced mobile broadband (eMBB)). In at least one embodiment, NR frame structure follows three key design principles to enhance forward compatibility and reduce interactions between different features.

In at least one embodiment, a first principle is that transmissions are self-contained, which can refer to a scheme in which data in a slot and in a beam are decodable on its own without dependency on other slots and beams. In at least one embodiment, this implies that reference signals required for demodulation of data are included in a given slot and a given beam. In at least one embodiment, a second principle is that transmissions are well confined in time and frequency, which results in a scheme in which new types of transmissions in parallel with legacy transmissions may be introduced. In at least one embodiment, a third principle is avoiding static and/or strict timing relations across slots and across different transmission directions. In at least one embodiment, usage of a third principle can entail utilizing asynchronous hybrid automatic repeat request (HARQ) instead of predefined retransmission time.

In at least one embodiment, NR frame structure also allows for rapid HARQ acknowledgement, in which decoding is performed during reception of DL data and HARQ acknowledgement is prepared by a UE during a guard period, when switching from DL reception to UL transmission. In at least one embodiment, to obtain low latency, a slot (or a set of slots in case of slot aggregation) is front-loaded with control signals and reference signals at a beginning of a slot (or set of slots).

In at least one embodiment, NR has an ultra-lean design that minimizes always-on transmissions to enhance network energy efficiency and ensure forward compatibility. In at least one embodiment, reference signals in NR are transmitted only when necessary. In at least one embodiment, four main reference signals are demodulation reference signal (DMRS), phase-tracking reference signal (PTRS), sounding reference signal (SRS) and channel-state information reference signal (CSI-RS).

In at least one embodiment, DMRS is used to estimate a radio channel for demodulation. In at least one embodiment, DMRS is UE-specific, can be beamformed, confined in a scheduled resource, and transmitted only when necessary, both in DL and UL. In at least one embodiment, to support multiple-layer multiple-input, multiple-output (MIMO) transmission, multiple orthogonal DMRS ports can be scheduled, one for each layer. In at least one embodiment, a basic DMRS pattern is front loaded, as a DMRS design takes into account an early decoding requirement to support low-latency applications. In at least one embodiment, for low-speed scenarios, DMRS uses low density in a time domain. In at least one embodiment, however, for high-speed scenarios, a time density of DMRS is increased to track fast changes in a radio channel.

In at least one embodiment, PTRS is introduced in NR to enable compensation of oscillator phase noise. In at least one embodiment, typically, phase noise increases as a function of oscillator carrier frequency. In at least one embodiment, PTRS can therefore be utilized at high carrier frequencies (such as mm Wave) to mitigate phase noise. In at least one embodiment, PTRS is UE-specific, confined in a scheduled resource and can be beamformed. In at least one embodiment, PTRS is configurable depending on a quality of oscillators, carrier frequency, OFDM sub-carrier spacing, and modulation and coding schemes used for transmission.

In at least one embodiment, SRS is transmitted in UL to perform channel state information (CSI) measurements mainly for scheduling and link adaptation. In at least one embodiment, for NR, SRS is also utilized for reciprocity-based precoder design for massive MIMO and UL beam management. In at least one embodiment, SRS has a modular and flexible design to support different procedures and UE capabilities. In at least one embodiment, an approach for channel state information reference signal (CSI-RS) is similar.

In at least one embodiment, NR employs different antenna solutions and techniques depending on which part of a spectrum is used for its operation. In at least one embodiment, for lower frequencies, a low to moderate number of active antennas (up to around 32 transmitter chains) is assumed and FDD operation is common. In at least one embodiment, acquisition of CSI requires transmission of CSI-RS in a DL and CSI reporting in an UL. In at least one embodiment, limited bandwidths available in this frequency region require high spectral efficiency enabled by multi-user MIMO (MU-MIMO) and higher order spatial multiplexing, which is achieved via higher resolution CSI reporting compared with LTE.

In at least one embodiment, for higher frequencies, a larger number of antennas can be employed in a given aperture, which increases a capability for beamforming and multiuser (MU)-MIMO. In at least one embodiment, here, spectrum allocations are of TDD type and reciprocity-based operation is assumed. In at least one embodiment, high-resolution CSI in a form of explicit channel estimations is acquired by UL channel sounding. In at least one embodiment, such high-resolution CSI enables sophisticated precoding algorithms to be employed at a base station (BS). In at least one embodiment, for even higher frequencies (in mmWave range) an analog beamforming implementation is typically required currently, which limits transmission to a single beam direction per time unit and radio chain. In at least one embodiment, since an isotropic antenna element is very small in this frequency region owing to a short carrier wavelength, a great number of antenna elements is required to maintain coverage. In at least one embodiment, beamforming needs to be applied at both transmitter and receiver ends to combat increased path loss, even for control channel transmission.

In at least one embodiment, to support these diverse use cases, NR features a highly flexible but unified CSI framework, in which there is reduced coupling between CSI measurement, CSI reporting and an actual DL transmission in NR compared with LTE. In at least one embodiment, NR also supports more advanced schemes such as multi-point transmission and coordination. In at least one embodiment, control and data transmissions follow a self-contained principle, where all information required to decode a transmission (such as accompanying DMRS) is contained within a transmission itself. In at least one embodiment, as a result, a network can seamlessly change a transmission point or beam as a UE moves in a network.

In at least one embodiment, MAC 1020 is a set of system software and libraries configured to provide an interface with a medium access control (MAC) layer, which may be part of a 5G network architecture. In at least one embodiment, a MAC layer controls hardware responsible for interaction with a wired, optical, or wireless transmission medium. In at least one embodiment, MAC provides flow control and multiplexing for a transmission medium.

In at least one embodiment, a MAC sublayer provides an abstraction of a physical layer such that complexities of a physical link control are invisible to a logical link control (LLC) and upper layers of a network stack. In at least one embodiment, any LLC sublayer (and higher layers) may be used with any MAC. In at least one embodiment, any MAC can be used with any physical layer, independent of transmission medium. In at least one embodiment, a MAC sublayer, when sending data to another device on a network, encapsulates higher-level frames into frames appropriate for a transmission medium, adds a frame check sequence to identify transmission errors, and then forwards data to a physical layer as soon as appropriate channel access method permits it. In at least one embodiment, MAC is also responsible for compensating for collisions if a jam signal is detected, in which a MAC may initiate retransmission.

In at least one embodiment, applications 1002 may include one or more types of applications used by at least portions of node C.R.s 1016(1)-1016(N) and/or framework software 1006. In at least one embodiment, one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, RAN APIs 1014 may be a set of subroutine definitions, communication protocols, and/or software tools that provide a method of communication with components of a radio access network (RAN) which may be part of a 5G network architecture. In at least one embodiment, a radio access network is part of a network communications system and may implement a radio access technology. In at least one embodiment, radio access network functionality is typically provided by a silicon chip residing in both a core network as well as user equipment. Further information regarding a radio access network can be found in the description of FIG. 53.

In at least one embodiment, system 1000 may use CPUs, application-specific integrated circuits (ASICs), GPUs, FPGAs, or other hardware to perform training, inferencing, and/or other various processes using above-described resources. In at least one embodiment, moreover, one or more software and/or hardware resources described above may be configured as a service to allow users to train or performing inferencing of information, such as image recognition, speech recognition, or other artificial intelligence services, as well as other services such as services that allow users to configure and implement various aspects of a 5G network architecture.

In some embodiments, one or more elements of system 1000 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of system 1000 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system 1000 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system 1000 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

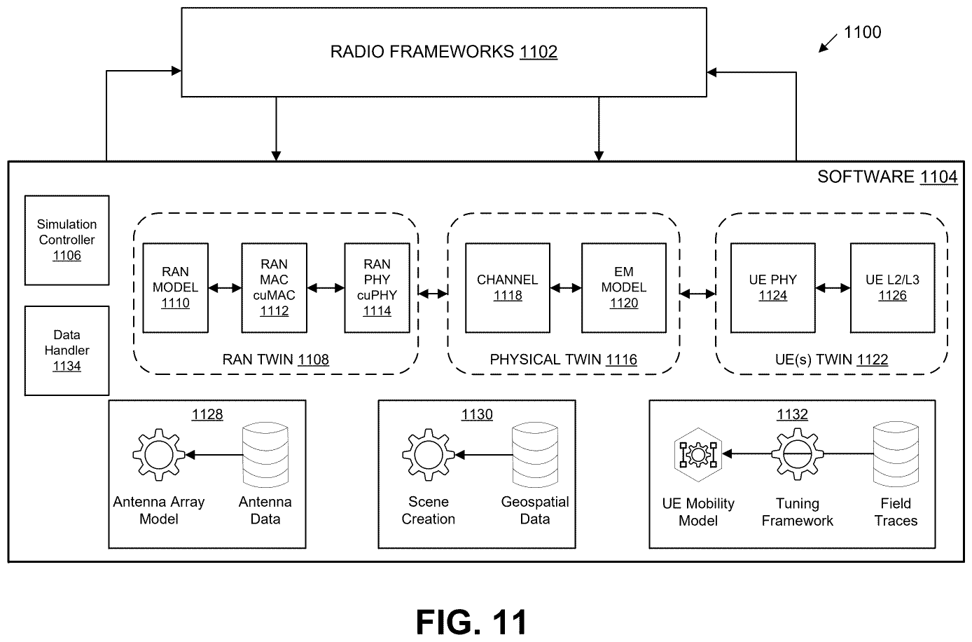

FIG. 11 illustrates simulation software 1100 for a wireless network, such as a 5G New Radio (NR) or radio access network (RAN). Simulation software 1100 performed by processing circuitry can receive wireless signal data processed by radio framework 1102 from real-world wireless networks. Simulation software 1100 can use this data to simulate network performance under modified configurations of network components, including changes to base stations, antennas, and user equipment device (UE) s.

In the system depicted in FIG. 11, the software architecture enables simulation of 5G radio access networks (RANs) using digital twin models (e.g., NVIDIA Digital Twins). For example, a processor executes software module RAN Model 1110 to emulate high-level network behavior in the RAN Twin 1108. This model can handle scheduling, handovers, mobility management, and coordination between the RAN and core network. As another example, a processor also executes RAN MAC cuMAC 1112, which can emulate the centralized MAC layer of the 5G RAN, managing resource allocation, HARQ, and scheduling decisions. A processor can execute RAN PHY cuPHY 1114, which models the centralized physical layer operations, such as modulation, coding, MIMO processing, and beamforming, completing the RAN Twin 1108.

To simulate the physical environment, the processor can perform Channel 1118, which models wireless propagation characteristics, including path loss, fading, Doppler effects, and interference. This module can exchange data with EM Model 1120, which simulates the electromagnetic environment, such as antenna radiation patterns, signal reflections, and obstructions. Together, these modules form the Physical Twin 1116, enabling realistic modeling of RF conditions.

On the user equipment (UE) side, a processor can execute UE PHY 1124, which simulates the physical layer of one or more UEs, processing signal reception and transmission in accordance with the simulated channel conditions. It can connect to UE L2/L3 1126, which models the Layer 2 (MAC/RLC) and Layer 3 (RRC/NAS) protocol stacks of the UE, enabling authentication, session management, and mobility procedures. These components comprise the UE(s) Twin 1122, which can emulate real-world UE behavior under varying network and physical conditions.

In at least one embodiment, supporting models provide data to these modules for a simulation. For example, a processor can use Antenna Array Model and Antenna Data 1128 to provide configuration and performance data for base station antennas. As another example, scene creation and geospatial data 1130 inform the EM and Channel models with terrain and environmental context. UE Mobility Model and Field Traces 1132 offer dynamic movement patterns and real-world trace data for the UEs, while the Tuning Framework allows calibration and refinement of the overall simulation.

Radio framework 1102 (e.g., software performed by a processor to receive, collect, or otherwise get information) obtains wireless signal data from base station cell sites, antennas, and UEs operating under protocols and standards that define wireless communication establishment, management, and optimization such as those from 3rd Generation Partnership Project. Radio framework 1102 can include databases for storing signal data, software libraries and modules for signal processing, and machine learning models for radio signal analysis. These components can enable simulation software to generate predictions about network performance based on modifications to network infrastructure and configurations.

Software 1104 performed by one or more processors can generate a virtual model of a network, including a RAN model, physical infrastructure models, and UE models. Software 1104 performed by one or more processors can use multiple models in a single simulation environment to optimize, monitor, manage, and simulate network performance.

Software 1104 performed by one or more processors can replicate a physical network infrastructure, including base stations, antennas, and other network components, to mirror real-world behavior, performance, and interactions. For example, software 1104 can be NVIDIA's Digital Twin software that receives network data from radio framework 1102 and updates virtual models to reflect real-time changes in the network environment. Input data can include network traffic, signal strength, device connectivity, configuration settings, historical network data, environmental conditions, and outputs from other simulations or neural network models.

Simulation controller 1106 performed by one or more processors can allocate computing resources to execute network simulations at varying levels of resolution. Simulation controller 1106 performed by one or more processors can adjust simulation settings based on user-defined configurations, dynamically modifying capacity limitations and computing resource allocation. Simulation controller 1106 can scale simulations from single cell sites to city-wide networks with thousands of base stations. To optimize computing resource utilization, simulation controller 1106 performed by processing circuitry can assign different spatial, frequency-based, or temporal resolutions to individual network cells. For example, simulation controller 1106 performed by processing circuitry can configure spatial resolution by setting wireless signal ray spacing to 10 cm or 1 cm, or adjust temporal resolution by modifying the frequency of simulation updates for network interactions.

Software 1104 performed by processing circuitry can include, access, or otherwise use data handler 1134, antenna model 1128, scene creation model 1130, and UE mobility model 1132. These models support network simulations executed by simulation controller 1106. Software 1104 can integrate models that simulate, generate, or otherwise use simulations such as RAN twin 1108, physical twin 1116, and UE twin 1122 to generate a comprehensive simulation environment.

Antenna model 1128 performed by processing circuitry can generate a representation of network antennas using input from antenna data sources such as base stations, RAN twin 1108, and physical twin 1116. The antenna model can include configuration data, beamforming parameters, radiation patterns, frequency, bandwidth, gain, efficiency, and environmental interference levels. The simulation software can include this model to evaluate antenna system performance and optimize beamforming configurations.

Scene creation model 1130 performed by a processor can construct a digital representation of the network environment using geospatial data, e.g., it can process geographic coordinates, terrain data, infrastructure layouts, and other environmental factors to create 3D network models. These models can enable simulation software to analyze how the physical environment impacts wireless signal propagation and network performance.

UE mobility model 1132 can generate, represent, or otherwise simulate movement patterns, historical behavior, and usage trends of UEs such as smartphones and tablets. The UE mobility model can process field trace data, including GPS coordinates, signal strength, and cell site handovers, to simulate real-world UE interactions within the network. The simulation software can use this model to optimize network parameters such as transmission power and handover management.

Field trace data can include UE movement information, signal strength variations, and network handover records. The tuning framework processes field trace data to refine mobility models, which characterize UE movement speeds, directional changes, and connectivity patterns. The simulation software incorporates these models to evaluate network quality, coverage, and congestion levels.

The simulation software performed by processing circuitry can use, communicate, or otherwise correspond with RAN twin 1108, physical twin 1116, and UE twin 1122 to generate a comprehensive virtual network environment. RAN twin 1108 can digitally replicate base stations, antennas, and signal propagation behaviors. Physical twin 1116 can model real-world environmental factors affecting signal transmissions, such as terrain, buildings, and weather conditions. UE twin 1122 simulates UE behaviors, including data usage, mobility patterns, and connectivity changes.

Simulation software 1100 performed by processing circuitry can enable interaction between RAN twin 1108, physical twin 1116, and UE twin 1122. For example, RAN twin 1108 receives environmental data from physical twin 1116 and simulates network performance under various physical conditions. As another example, UE twin 1122 provides mobility and behavior data to RAN twin 1108, which then adjusts network configurations accordingly.

Simulation controller 1106 performed by processing circuitry can execute network simulations using inputs from RAN twin 1108, physical twin 1116, and UE twin 1122. Simulation controller 1106 can dynamically adjust network parameters, simulation settings, and computing resource allocations based on performance requirements and available computing power.

In some embodiments, one or more elements of system for simulation software 1100 may be used by one or more processors to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device. In some embodiments, one or more elements of system for simulation software 1100 may be, may be included in, and/or otherwise may include other systems illustrated in FIGS. 1-11 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system for simulation software 1100 may perform processes illustrated in FIGS. 1-11, such as to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or otherwise perform operations described herein. In some embodiments, elements of system for simulation software 1100 may perform one or more processes as illustrated in FIGS. 12-23A/B to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device, and/or otherwise perform operations described herein.

### Data Center

FIG. 12 illustrates an example data center 1200, in accordance with at least one embodiment. Data center 1200 may include one or more rooms having racks 1202 and auxiliary equipment used to house one or more racks 1202 and one or more baseboards 1204. Rack 1202 can include one or more baseboards 1204. Rack 1202 can include a housing that receives and supports individual baseboards 1204. Operational aspects of rack 1202 may be regulated at a rack level, corresponding to a group of baseboards 1204, or at a baseboard level, corresponding to individual baseboards 1204, among other options. Rack 1202 or baseboards 1204 can have particularly selected maximum operating parameters, such as, but not limited to, power consumption, operating frequencies, and others. Data center 1200 can be supported by various cooling systems, such as, but not limited to, cooling towers, cooling loops, pumps, and other support systems. Cooling systems may include sensors and controllers to monitor and managing cooling properties for racks 1202. Baseboards 1204 within racks 1202 can get operational power from one or more power distribution units (PDUs; not shown). PDUs may be arranged within racks 1202, for example between racks 1202 including baseboards 1204, or within racks 1202 that also house baseboards 1204.

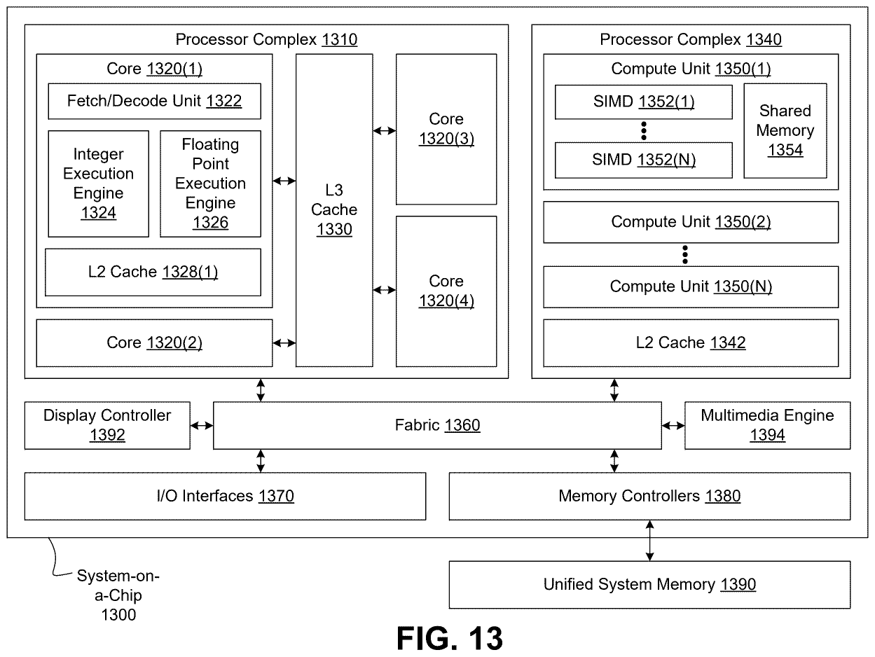

Racks 1202 and baseboards 1204 can include sub-systems, modules, add-in cards, and other semiconductor components. Baseboards 1204 can include one or more computing units 1206 that can include one or more processors 1208, one or more memory 1210, and an interface controller 1212. Computing units 1206 may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, processors in FIGS. 13-25. Computing units 1206 can include one or more memory storage devices 1210 (e.g., dynamic read-only memory, solid state storage or disk drives), as well as network input/output (“NW I/O”) devices, network switches, virtual machines (“VMs”), power modules, and cooling modules, etc. One or more computing units 1206 may be a server having one or more of above-mentioned computing resources.

Computing units 1206 can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 1214 may configure or otherwise control one or more computing units 1206 or groups of computing units. Resource orchestrator 1214 may include a software design infrastructure (“SDI”) management entity for data center 1200. Resource orchestrator 1214 may include hardware, software or some combination thereof.

Data center 1200 can include any one of or any combination of a framework layer 1220, a software layer 1230 and an application layer 1240. As shown in FIG. 12, framework layer 1220 includes a job scheduler 1222, a configuration manager 1224, a resource manager 1226 and a distributed file system 1228. Framework layer 1220 may include a framework to support software 1232 of software layer 1230 and/or one or more application(s) 1242 of application layer 1240. Software 1232 or application(s) 1242 may respectively include web-based service software or applications, such as, but not limited to, those provided by Amazon Web Services, Google Cloud and Microsoft Azure. Framework layer 1220 may be a type of free and open-source software web application framework such as, but not limited to, Apache Spark™ (hereinafter “Spark”) that may utilize distributed file system 1228 for large-scale data processing (e.g., “big data”). Job scheduler 1222 may include a Spark driver to facilitate scheduling of workloads supported by various layers of data center 1200. Configuration manager 1224 may be capable of configuring different layers such as, but not limited to, software layer 1230 and framework layer 1220 including Spark and distributed file system 1228 for supporting large-scale data processing. Resource manager 1226 may be capable of managing clustered or grouped computing units 1206 mapped to or allocated for support of distributed file system 1228 and job scheduler 1222. Resource manager 1226 may coordinate with resource orchestrator 1214 to manage these mapped or allocated computing resources.

Software 1232 can be included in software layer 1230 and may include software used by at least portions of a computing unit 1206, one or more computing units 1206, groups of computing units 1206, and/or distributed file system 1228 of framework layer 1220. One or more types of software may include, but are not limited to, Internet web page search software, e-mail virus scan software, database software, and streaming video content software.

Application(s) 1242 can be included in application layer 1240 and may include one or more types of applications used by at least portions of a computing unit 1206, one or more computing units 1206, groups of computing units 1206, and/or distributed file system 1228 of framework layer 1220. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 1224, resource manager 1226, and resource orchestrator 1214 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

Data center 1200 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to data center 1200. Trained machine learning models corresponding to one or more neural networks may be used to infer or predict information using resources described above with respect to data center 1200 by using weight parameters calculated through one or more training techniques described herein.

Data center 1200 may use CPUs, application-specific integrated circuits (ASICs), GPUs, FPGAs, or other hardware (e.g., embodiments in FIGS. 13-25) to perform some or all of processes and techniques described elsewhere herein, such as, but not limited to, training and/or inferencing using above-described resources. Moreover, one or more software and/or hardware resources described above may be configured as a service to allow users to train or performing inferencing of information, such as, but not limited to, image recognition, speech recognition, or other artificial intelligence services.

In at least one embodiment, processor 1208 can include one of the processors below and/or comprises one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. In at least one embodiment, processor 1208 is configured by software 1232 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. Data center 1200 may use logic, CPUs, application-specific integrated circuits (ASICs), GPUs, FPGAs, or other hardware (e.g., embodiments in FIGS. 13-25) to perform any of the operations described above or elsewhere herein.

### Processors

The following figures set forth, without limitation, example processors and processing systems that can be used to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform some or all of processes, operations and/or and techniques described elsewhere herein. Example processors and processing systems can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. Processors and processing systems can include logic, central processing units (CPUs), application-specific integrated circuits (ASICs), graphics processing units (GPUs), field programmable arrays (FPGAs), XPUs (i.e., any compute architecture that best fits the need of an application) or other hardware (e.g., embodiments in FIGS. 13-25) to perform any of the operations described above, below, or elsewhere herein. Processors and/or processing systems described herein can include one or more circuits that can be used to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. As used herein, one or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. FIGS. 30A and 30B illustrate logic 3015 which, as described elsewhere herein, can be used in one or more devices to perform operations such as, but not limited to, those discussed herein in accordance with at least one embodiment. Logic can refer, for example, to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU).

FIG. 13 illustrates a processor which is a system-on-a-chip (SOC) 1300 (which may be referred to as system-on-chip, a superchip, or another name), in accordance with at least one embodiment. SOC 1300 can include processor complex 1310 and processor complex 1340. SOC 1300 can include any number of processor complexes 1310 and/or processor complexes 1340 that may include any number of processors that are described herein, such as, but not limited to, those in FIGS. 13-25, in any combination. For example, processor 1310 may include a central processing unit (CPU), and processor 1340 may include a graphics processor. Alternatively, processor 1310 may include a graphics processor, and processor 1340 may include a graphics processor. SOC 1300 may include any number of display controllers 1392, any number of multimedia engines 1394, any number of I/O Interfaces 1370, any number of memory controllers 1380, and any number of fabrics 1360 in any combination. For explanatory purposes, multiple instances of like objects are denoted herein with reference numbers identifying the object and parenthetical numbers identifying the instance where needed. SOC 1300 can include a processor from Broadcom in Palo Alto, CA.

Processor complex 1310 can include a CPU, processor complex 1340 can include a GPU, and SOC 1300 can include a processing unit that integrates one or more processor complexes 1310 and 1340 onto a single chip. Some tasks may be assigned to processor complex 1310 and other tasks may be assigned to processor complex 1340. Processor complex 1310 can be configured to execute main control software associated with SOC 1300, such as, but not limited to, an operating system. Processor complex 1310 can be the master processor of SOC 1300, controlling and coordinating operations of other processors. Processor complex 1310 can issue commands that control the operation of processor complex 1340 to perform some or all of the operations described herein. Processor complex 1310 can be configured to execute host executable code derived from CUDA or other source code (e.g., HIP source code), and processor complex 1340 can be configured to execute device executable code derived from CUDA or other source code in order to perform any of the operations described herein.

Processor complex 1310 can include cores 1320(1)-1320(4) and a cache (e.g., L3 cache) 1330 to store information to perform operations described herein. Processor complex 1310 may include any number of cores 1320 and any number and type of caches in any combination. Cores 1320 can be configured to execute instructions of a particular instruction set architecture (“ISA”) to perform some or all of the operations described herein. Each core 1320 can include a CPU core. Core 1320(1)-1320(4) can be referred to as a computing units or compute units. SOC 1300 can includes any number of processor complexes 1310, fabric 1360, I/O interfaces 1370, and memory controllers 1380.

Each core 1320 can include a fetch/decode unit 1322, an integer execution engine 1324, a floating point execution engine 1326, and an L2 cache 1328. Fetch/decode unit 1322 can fetch instructions to perform some or all of the operations described herein (such as, but not limited to, an API that is compiled into instructions) and decode such instructions, generate micro-operations, and dispatch separate micro-instructions to integer execution engine 1324 and/or floating point execution engine 1326. Fetch/decode unit 1322 can concurrently dispatch one micro-instruction to integer execution engine 1324 and another micro-instruction to floating point execution engine 1326. Integer execution engine 1324 can execute integer and memory operations. Floating point engine 1326 can execute floating point and vector operations. Fetch-decode unit 1322 can dispatch micro-instructions to one or more execution engines that replaces both integer execution engine 1324 and floating point execution engine 1326.

Each core 1320(i), where i is an integer representing a particular instance of core 1320, may access L2 cache 1328(i) included in core 1320(i). Each core 1320 included in core complex 1310(j), where j is an integer representing a particular instance of core complex 1310, can be connected to other cores 1320 included in core complex 1310(j) via L3 cache 1330(j) included in core complex 1310(j). Cores 1320 included in core complex 1310(j), where j is an integer representing a particular instance of core complex 1310, can access all of L3 cache 1330(j) included in core complex 1310(j). L3 cache 1330 may include any number of slices.

Processor complex 1340 can be a graphics complex that can be configured to perform compute operations (e.g., compute operations involved in operations described herein) in a highly-parallel fashion. Processor complex 1340 can be configured to execute graphics pipeline operations such as, but not limited to, draw commands, pixel operations, geometric computations, and other operations associated with rendering an image to a display. Processor complex 1340 can be configured to execute operations unrelated to graphics, such as, but not limited to, neural network training and/or simulations. Processor complex 1340 can be configured to execute both operations related to graphics and operations unrelated to graphics.

Processor complex 1340 can include any number of compute units 1350(1)-1350(N), where N is any integer greater than 1, and an L2 cache 1342. Compute units 1350 can share L2 cache 1342, which may store information to be used to perform some or all of the operations described herein. L2 cache 1342 can be partitioned. Processor complex 1340 can include any number of compute units 1350 and any number (including zero) and type of caches. Processor complex 1340 can include any amount of dedicated graphics hardware.

Each compute unit 1350 can include any number of SIMD units 1352(1)-1352(N), where N is any integer greater than 1, and a shared memory 1354. Each SIMD unit 1352 can implement a SIMD architecture and can be configured to some or all of the operations described herein, in parallel. Each compute unit 1350 may execute any number of thread blocks, but each thread block can execute on a single compute unit 1350, although in some embodiments a thread block can execute on multiple compute units. A thread block can include any number of threads of execution. A workgroup can be a thread block. Each SIMD unit 1352 can execute a group of threads. A group of threads (e.g., 16 threads), which can also be referred to as a warp, or subgroup, or wavefront (e.g., as used by AMD and Intel), where each thread in the warp, wave, subgroup, or wavefront can belong to a single thread block and is configured to process a different set of data based on a single set of instructions. Predication can be used to disable one or more threads in a warp, subgroup, or wavefront. A lane can be a thread. A work item can be a thread, such as, but not limited to, e.g., with OpenCL. Different warps, subgroups, or wavefronts in a thread block may synchronize together and communicate via shared memory 1354. Each compute unit 1350 can include one or more thread block clusters, where a thread block cluster can enable programmatic control of locality at a granularity larger than a single thread block of a single streaming multiprocessor (SM). Thread block clusters (also referred to as “clusters”) can enable multiple thread blocks running concurrently across streaming multiprocessors to synchronize and collaboratively fetch, exchange, or otherwise use data. In at least one embodiment, streaming multiprocessors (“SMs”) can be referred to streaming microprocessors, stream processors (“SPs”), stream processing units (“SPUs”), compute units (“CUs”), execution units (“EUs”), and/or slices, where a slice in this context can refer to a portion of processing resources in a processing unit (e.g., 16 cores, a ray tracing unit, a thread director or scheduler).

Fabric 1360 can be a system interconnect that facilitates data and control transmissions across processor complex 1310, processor complex 1340, I/O interfaces 1370, memory controllers 1380, display controller 1392, and multimedia engine 1394, e.g., to perform some or all of the operations described herein. SOC 1300 may include any amount and type of system interconnect in addition to or instead of fabric 1360 that facilitates data and control transmissions across any number and type of directly or indirectly linked components that may be internal or external to SOC 1300. I/O interfaces 1370 can be representative of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 1370. Peripheral devices that can be coupled to I/O interfaces 1370 may include keyboards, mice, printers, scanners, joysticks or other types of game controllers, media recording devices, external storage devices, network interface cards, and so forth.

Display controller 1392 may display images on one or more display device(s), such as, but not limited to, a liquid crystal display (“LCD”) device. Multimedia engine 1394 can include any amount and type of circuitry that is related to multimedia, such as, but not limited to, a video decoder, a video encoder, an image signal processor, etc. Memory controllers 1380 may facilitate data transfers between SOC 1300 and a unified system memory 1390. Processor complex 1310 and processor complex 1340 may share unified system memory 1390. Unified system memory 1390 can include various types of memory devices, including dynamic random access memory (DRAM) or graphics random access memory, such as, but not limited to, synchronous graphics random access memory (SGRAM), including graphics double data rate (GDDR) memory. Unified system memory 1390 may include 3D stacked memory, including but not limited to high bandwidth memory (HBM), HBM2e, or HDM3.

SOC 1300 may implement a memory subsystem that includes any amount and type of memory controllers 1380 and memory devices (e.g., shared memory 1354) that may be dedicated to one component or shared among multiple components in order to perform any of the operations described herein. SOC 1300 can implement a cache subsystem that includes one or more cache memories (e.g., L2 caches 1328, L3 cache 1330, and L2 cache 1342) that may each be private to or shared between any number of components (e.g., cores 1320, core complex 1310, SIMD units 1352, compute units 1350, and processor complex 1340).

In at least one embodiment, SOC 1300 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

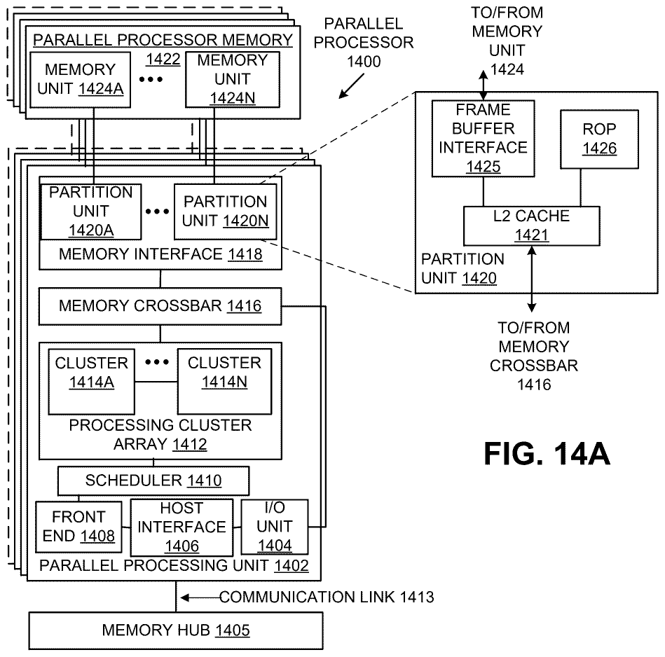

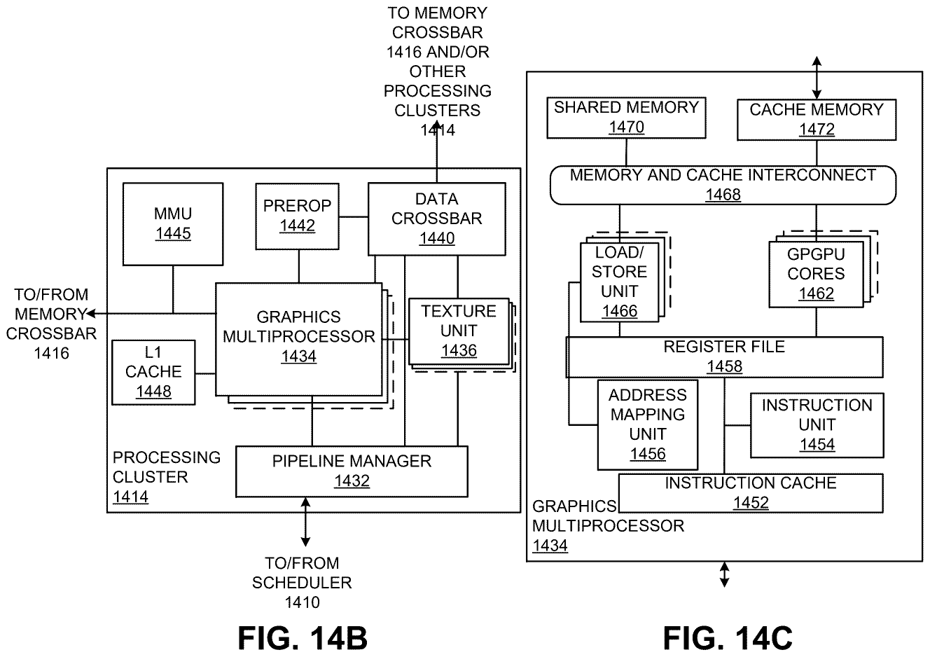

FIG. 14A illustrates a parallel processor 1400, in accordance with at least one embodiment. Parallel processor 1400 may be implemented using one or more circuits and may be referred to as a programmable processor (e.g., a CPU and/or GPU), logic, an application specific integrated circuit (ASIC), a field programmable gate array (FPGA) or other hardware (e.g., embodiments in FIGS. 13-25) to perform any of the operations described above or elsewhere herein.

Parallel processor 1400 can include a parallel processing unit 1402 to perform any of the operations described above or elsewhere herein. Parallel processing unit 1402 can include an I/O unit 1404 that enables communication with other devices, including other instances of parallel processing unit 1402. I/O unit 1404 may be directly connected to other devices. I/O unit 1404 may connect with other devices via use of a hub or switch interface, such as, but not limited to, a memory hub 1405. Connections between memory hub 1405 and I/O unit 1404 can form a communication link 1413. I/O unit 1404 may connect with a host interface 1406 and a memory crossbar 1416, where host interface 1406 receives commands directed to performing processing operations and memory crossbar 1416 receives commands directed to performing memory operations.

When host interface 1406 receives a command buffer via I/O unit 1404, host interface 1406 can direct work operations to perform those commands to a front end 1408. Front end 1408 can couple with a scheduler 1410 (which may be referred to as a sequencer), which is configured to distribute commands or other work items to a processing cluster array 1412. Scheduler 1410 can ensure that processing cluster array 1412 is properly configured and in a valid state before tasks may be distributed to a cluster of processing cluster array 1412. Scheduler 1410 may be implemented via firmware logic executing on a microcontroller. Microcontroller-implemented scheduler 1410 can be configurable to perform complex scheduling and work distribution operations at coarse and fine granularity, enabling rapid preemption and context switching of threads executing on processing array 1412. Host software can prove workloads for scheduling on processing cluster array 1412 via one of multiple graphics processing paths. Workloads can then be automatically distributed across processing array cluster 1412 by scheduler 1410 logic within a microcontroller including scheduler 1410.

Processing cluster array 1412 can perform any of the operations described above or elsewhere herein and can include up to “N” processing clusters (e.g., cluster 1414A, cluster 1414B, through cluster 1414N), where “N” represents a positive integer (which may be a different integer “N” than used in other figures). Each cluster 1414A-1414N of processing cluster array 1412 can execute a large number of concurrent threads. Scheduler 1410 can allocate work to clusters 1414A-1414N of processing cluster array 1412 using various scheduling and/or work distribution algorithms, which may vary depending on workload arising for each type of program or computation. Scheduling can be handled dynamically by scheduler 1410, or can be assisted in part by compiler logic during compilation of program logic configured for execution by processing cluster array 1412. Different clusters 1414A-1414N of processing cluster array 1412 can be allocated for processing different types of programs or for performing different types of computations.

Processing cluster array 1412 can be configured to perform various types of parallel processing operations, such as, but not limited to, any of the operations described above or elsewhere herein. Processing cluster array 1412 can be configured to perform general-purpose parallel compute operations. For example, processing cluster array 1412 can include logic to execute processing tasks including filtering of video and/or audio data, performing modeling operations, including physics operations, and performing data transformations.

Processing cluster array 1412 can be configured to perform parallel graphics processing operations. Processing cluster array 1412 can include additional logic to support execution of such graphics processing operations, including but not limited to, texture sampling logic to perform texture operations, as well as tessellation logic and other vertex processing logic. Processing cluster array 1412 can be configured to execute graphics processing related shader programs such as, but not limited to, vertex shaders, tessellation shaders, geometry shaders, and pixel shaders. Parallel processing unit 1402 can transfer data from system memory via I/O unit 1404 for processing. During processing, transferred data can be stored to on-chip memory (e.g., parallel processor memory 1422) during processing, then written back to system memory.

When parallel processing unit 1402 is used to perform graphics processing, scheduler 1410 can be configured to divide a processing workload into approximately equal sized tasks, to better enable distribution of graphics processing operations to multiple clusters 1414A-1414N of processing cluster array 1412. Portions of processing cluster array 1412 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of clusters 1414A-1414N may be stored in buffers to allow intermediate data to be transmitted between clusters 1414A-1414N for further processing.

Processing cluster array 1412 can receive processing tasks to be executed via scheduler 1410, which receives commands defining processing tasks from front end 1408. Processing tasks can include indices of data to be processed, e.g., surface (patch) data, primitive data, vertex data, and/or pixel data, as well as state parameters and commands defining how data is to be processed (e.g., what program is to be executed). Scheduler 1410 may be configured to fetch indices corresponding to tasks or may receive indices from front end 1408. Front end 1408 can be configured to ensure processing cluster array 1412 is configured to a valid state before a workload specified by incoming command buffers (e.g., batch-buffers, push buffers, etc.) is initiated.

Each of one or more instances of parallel processing unit 1402 can couple with a parallel processor memory 1422 to perform any of the operations described above or elsewhere herein. Parallel processor memory 1422 can be accessed via memory crossbar 1416, which can receive memory requests from processing cluster array 1412 as well as I/O unit 1404. Memory crossbar 1416 can access parallel processor memory 1422 via a memory interface 1418. Memory interface 1418 can include multiple partition units (e.g., partition unit 1420A, partition unit 1420B, through partition unit 1420N) that can each couple to a portion (e.g., memory unit) of parallel processor memory 1422. A number of partition units 1420A-1420N can be configured to be equal to a number of memory units, such that a first partition unit 1420A has a corresponding first memory unit 1424A, a second partition unit 1420B has a corresponding memory unit 1424B, and an N-th partition unit 1420N has a corresponding N-th memory unit 1424N. A number of partition units 1420A-1420N may not be equal to a number of memory units.

Memory units 1424A-1424N can include various types of memory devices, including dynamic random access memory (DRAM) or graphics random access memory, such as, but not limited to, synchronous graphics random access memory (SGRAM), including graphics double data rate (GDDR) memory. Memory units 1424A-1424N may also include 3D stacked memory, including but not limited to high bandwidth memory (HBM), HBM2e, or HDM3. Render targets, such as, but not limited to, frame buffers or texture maps may be stored across memory units 1424A-1424N, allowing partition units 1420A-1420N to write portions of each render target in parallel to efficiently use available bandwidth of parallel processor memory 1422. A local instance of parallel processor memory 1422 may be excluded in favor of a unified memory design that utilizes system memory in conjunction with local cache memory.

Any one of clusters 1414A-1414N of processing cluster array 1412 can process data that will be written to any of memory units 1424A-1424N within parallel processor memory 1422. Memory crossbar 1416 can be configured to transfer an output of each cluster 1414A-1414N to any partition unit 1420A-1420N or to another cluster 1414A-1414N, which can perform additional processing operations on an output. Each cluster 1414A-1414N can communicate with memory interface 1418 through memory crossbar 1416 to read from or write to various external memory devices. Memory crossbar 1416 can have a connection to memory interface 1418 to communicate with I/O unit 1404, as well as a connection to a local instance of parallel processor memory 1422, enabling processing units within different processing clusters 1414A-1414N to communicate with system memory or other memory that is not local to parallel processing unit 1402. Memory crossbar 1416 can use virtual channels to separate traffic streams between clusters 1414A-1414N and partition units 1420A-1420N.

Multiple instances of parallel processing unit 1402 can be provided on a single add-in card, or multiple add-in cards can be interconnected. Different instances of parallel processing unit 1402 can be configured to interoperate even if different instances have different numbers of processing cores, different amounts of local parallel processor memory, and/or other configuration differences. For example, some instances of parallel processing unit 1402 can include higher precision floating point units relative to other instances. Systems incorporating one or more instances of parallel processing unit 1402 or parallel processor 1400 can be implemented in a variety of configurations and form factors, including but not limited to desktop, laptop, or handheld personal computers, servers, workstations, game consoles, and/or embedded systems.

FIG. 14A further includes a block diagram of a partition unit 1420, in accordance with at least one embodiment. Partition unit 1420 is an instance of one of partition units 1420A-1420N of FIG. 14A. Partition unit 1420 can include an L2 cache 1421, a frame buffer interface 1425, and a ROP 1426 (raster operations unit). L2 cache 1421 can be a read/write cache that is configured to perform load and store operations received from memory crossbar 1416 and ROP 1426. Read misses and urgent write-back requests can be output by L2 cache 1421 to frame buffer interface 1425 for processing. Updates can also be sent to a frame buffer via frame buffer interface 1425 for processing. Frame buffer interface 1425 may interface with one of memory units in parallel processor memory, such as, but not limited to, memory units 1424A-1424N (shown as 1424) of FIG. 14A (e.g., within parallel processor memory 1422).

ROP 1426 can be a processing unit that performs raster operations such as, but not limited to, stencil, z test, blending, etc. ROP 1426 can then output processed graphics data that is stored in graphics memory. ROP 1426 can include compression logic to compress depth or color data that is written to memory and decompress depth or color data that is read from memory. Compression logic can be lossless compression logic that makes use of one or more of multiple compression algorithms. A type of compression that is performed by ROP 1426 can vary based on statistical characteristics of data to be compressed. For example, delta color compression is performed on depth and color data on a per-tile basis.

ROP 1426 can be included within each processing cluster (e.g., cluster 1414A-1414N of FIG. 14A) instead of within partition unit 1420. Read and write requests for pixel data may be transmitted over memory crossbar 1416 instead of pixel fragment data. Processed graphics data may be displayed on a display routed for further processing by processor(s), or routed for further processing by one of processing entities within parallel processor 1400 of FIG. 14A.

In at least one embodiment, parallel processor 1400 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

FIG. 14B includes a block diagram of a processing cluster 1414 within a parallel processing unit, in accordance with at least one embodiment. A processing cluster can be an instance of one of processing clusters 1414A-1414N of FIG. 14A that can be used to perform any of the operations described above or elsewhere herein. Processing cluster 1414 can be configured to execute many threads in parallel, where “thread” refers to an instance of a particular program executing on a particular set of input data. Single-instruction, multiple-data (SIMD) instruction issue techniques can be used to support parallel execution of a large number of threads without providing multiple independent instruction units. Single-instruction, multiple-thread (SIMT) techniques may be used to support parallel execution of a large number of generally synchronized threads, using a common instruction unit configured to issue instructions to a set of processing engines within each one of processing clusters.

Operation of processing cluster 1414 can be controlled via a pipeline manager 1432 that distributes processing tasks to SIMT parallel processors. Pipeline manager 1432 can receive instructions from scheduler 1410 of FIG. 14A and manages execution of those instructions via a graphics multiprocessor 1434 and/or a texture unit 1436. Graphics multiprocessor 1434 may be an example instance of a SIMT parallel processor. However, various types of SIMT parallel processors of differing architectures may be included within processing cluster 1414. One or more instances of graphics multiprocessor 1434 can be included within a processing cluster 1414. Graphics multiprocessor 1434 can process data and a data crossbar 1440 can be used to distribute processed data to one of multiple possible destinations, including other shader units. Pipeline manager 1432 can facilitate distribution of processed data by specifying destinations for processed data to be distributed via data crossbar 1440.

Each graphics multiprocessor 1434 within processing cluster 1414 can include an identical set of functional execution logic (e.g., arithmetic logic units, load-store units, etc.) to perform computations for any of the operations described above or elsewhere herein. Functional execution logic can be configured in a pipelined manner in which new instructions can be issued before previous instructions may be complete. Functional execution logic can support a variety of operations including integer and floating point arithmetic, comparison operations, Boolean operations, bit-shifting, and computation of various algebraic functions. Same functional-unit hardware can be leveraged to perform different operations and any combination of functional units may be present.

Instructions transmitted to processing cluster 1414 may constitute a thread, which can also be referred to as a warp, subgroup, wave, or a wavefront. A set of threads executing across a set of parallel processing engines can be referred to as a thread group. A thread group can execute a common program on different input data. Each thread within a thread group can be assigned to a different processing engine within a graphics multiprocessor 1434. A thread group may include fewer threads than a number of processing engines within graphics multiprocessor 1434. When a thread group includes fewer threads than a number of processing engines, one or more of processing engines may be idle during cycles in which that thread group is being processed. A thread group may also include more threads than a number of processing engines within graphics multiprocessor 1434. When a thread group includes more threads than number of processing engines within graphics multiprocessor 1434, processing can be performed over consecutive clock cycles. Multiple thread groups can be executed concurrently on a graphics multiprocessor 1434.

Graphics multiprocessor 1434 includes an internal cache memory to perform load and store operations, such as, but not limited to, any of the operations described above or elsewhere herein. Graphics multiprocessor 1434 can forego an internal cache and use a cache memory (e.g., L1 cache 1448) within processing cluster 1414. Each graphics multiprocessor 1434 may also have access to L2 caches within partition units (e.g., partition units 1420A-1420N of FIG. 14A) that can be shared among all processing clusters 1414 and may be used to transfer data between threads. Graphics multiprocessor 1434 may also access off-chip global memory, which can include one or more of local parallel processor memory and/or system memory. Any memory external to parallel processing unit 1402 may be used as global memory. Processing cluster 1414 can include multiple instances of graphics multiprocessor 1434 and can share common instructions and data, which may be stored in L1 cache 1448.

Each processing cluster 1414 may include an MMU 1445 (memory management unit) that can be configured to map virtual addresses into physical addresses. One or more instances of MMU 1445 may reside within memory interface 1418 of FIG. 14A. MMU 1445 can include a set of page table entries (PTEs) used to map a virtual address to a physical address of a tile and optionally a cache line index. MMU 1445 may include address translation lookaside buffers (TLB) or caches that may reside within graphics multiprocessor or L1 1448 cache or processing cluster 1414. A physical address can be processed to distribute surface data access locally to allow for efficient request interleaving among partition units. A cache line index may be used to determine whether a request for a cache line is a hit or miss.

A processing cluster 1414 may be configured such that each graphics multiprocessor 1434 is coupled to a texture unit 1436 for performing texture mapping operations, e.g., determining texture sample positions, reading texture data, and filtering texture data. Texture data can be read from an internal texture L1 cache (not shown) or from an L1 cache within graphics multiprocessor 1434 and can be fetched from an L2 cache, local parallel processor memory, or system memory, as needed. Each graphics multiprocessor 1434 can output processed tasks to data crossbar 1440 to provide processed task to another processing cluster 1414 for further processing or to store processed task in an L2 cache, local parallel processor memory, or system memory via memory crossbar 1416. A preROP 1442 (pre-raster operations unit) can be configured to receive data from graphics multiprocessor 1434, and direct data to ROP units, which may be located with partition units as described herein (e.g., partition units 1420A-1420N of FIG. 14A). PreROP 1442 unit can perform optimizations for color blending, organizing pixel color data, and performing address translations.

In at least one embodiment, processing cluster 1414 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

FIG. 14C shows a graphics multiprocessor 1434, in accordance with at least one embodiment, e.g., to perform any of the operations described above or elsewhere herein. Graphics multiprocessor 1434 can couple with pipeline manager 1432 of processing cluster 1414. Graphics multiprocessor 1434 can include an execution pipeline including but not limited to an instruction cache 1452 (that, e.g., can store instructions, such as, not limited to compiled API instructions), an instruction unit 1454, an address mapping unit 1456, a register file 1458, one or more general purpose graphics processing unit (GPGPU) cores 1462, and one or more load/store units 1466, where one or more load/store units 1466 can perform load/store operations to load/store instructions corresponding to performing an operation. GPGPU cores 1462 and load/store units 1466 can be coupled with cache memory 1472 and shared memory 1470 via a memory and cache interconnect 1468. GPGPU cores 1462 can be part of an SoC such as, but not limited to, part of integrated circuit 1300 in FIG. 13.

Instruction cache 1452 can receive a stream of instructions (e.g., to perform any of the operations described above or elsewhere herein) to execute from pipeline manager 1432. Instructions can be cached in instruction cache 1452 and dispatched for execution by an instruction unit 1454. Instruction unit 1454 can dispatch instructions as thread groups (e.g., warps, subgroups, wavefronts, or waves), with each thread of thread group assigned to a different execution unit within GPGPU cores 1462. An instruction can access any of a local, shared, or global address space by specifying an address within a unified address space. Address mapping unit 1456 can be used to translate addresses in a unified address space into a distinct memory address that can be accessed by load/store units 1466.

Register file 1458 can provide a set of registers for functional units of graphics multiprocessor 1434. Register file 1458 may provide temporary storage for operands connected to data paths of functional units (e.g., GPGPU cores 1462, load/store units 1466) of graphics multiprocessor 1434. Register file 1458 may be divided between each of functional units such that each functional unit is allocated a dedicated portion of register file 1458. Register file 1458 can be divided between different warps (which may be referred to as wavefronts, subgroups, and/or waves or threads) being executed by graphics multiprocessor 1434.

GPGPU cores 1462 can each include floating point units (FPUs) and/or integer arithmetic logic units (ALUs) that can be used to execute instructions of graphics multiprocessor 1434. GPGPU cores 1462 can be similar in architecture or can differ in architecture. A first portion of GPGPU cores 1462 can include a single precision FPU and an integer ALU while a second portion of GPGPU cores include a double precision FPU. FPUs can implement IEEE 754-2008 standard floating point arithmetic or enable variable precision floating point arithmetic. Graphics multiprocessor 1434 can additionally include one or more fixed function or special function units to perform specific functions such as, but not limited to, copy rectangle or pixel blending operations. One or more of GPGPU cores 1462 can also include fixed or special function logic.

GPGPU cores 1462 can include SIMD logic capable of performing a single instruction on multiple sets of data. GPGPU cores 1462 can physically execute SIMD4, SIMD8, and SIMD16 instructions and logically execute SIMD1, SIMD2, and SIMD32 instructions. SIMD instructions for GPGPU cores can be generated at compile time by a shader compiler or automatically generated when executing programs written and compiled for single program multiple data (SPMD) or SIMT architectures. Multiple threads of a program can be configured for an SIMT execution model that can be executed via a single SIMD instruction. For example, eight SIMT threads that perform same or similar operations can be executed in parallel via a single SIMD8 logic unit.

Memory and cache interconnect 1468 can include an interconnect network that connects each functional unit of graphics multiprocessor 1434 to register file 1458 and to shared memory 1470. Memory and cache interconnect 1468 may be a crossbar interconnect that allows load/store unit 1466 to implement load and store operations between shared memory 1470 and register file 1458. register file 1458 can operate at a same frequency as GPGPU cores 1462, thus data transfer between GPGPU cores 1462 and register file 1458 can have very low latency. Shared memory 1470 can be used to enable communication between threads that execute on functional units within graphics multiprocessor 1434. Cache memory 1472 can be used as a data cache for example, to cache texture data communicated between functional units and texture unit 1436. Shared memory 1470 can also be used as a program managed cache. Threads executing on GPGPU cores 1462 can programmatically store data within shared memory in addition to automatically cached data that is stored within cache memory 1472.

A parallel processor or GPGPU as described herein may be communicatively coupled to host/processor cores to accelerate graphics operations, machine-learning operations, pattern analysis operations, and various general purpose GPU (GPGPU) functions. A GPU may be communicatively coupled to host processor/cores over a bus or other interconnect (e.g., a high-speed interconnect such as, but not limited to, PCIe or NVLink). An SoC may include a parallel processor or GPGPU as described herein, where said parallel processor or said GPGPU is performed on said SoC. A GPU may be integrated on a package or chip as cores and communicatively coupled to cores over an internal processor bus/interconnect internal to a package or chip. Regardless a manner in which a GPU is connected, processor cores may allocate work to such GPU in a form of sequences of commands/instructions contained in a work descriptor. GPU then may use dedicated circuitry/logic for efficiently processing these commands/instructions to perform any of the operations described above or elsewhere herein.

In at least one embodiment, graphics multiprocessor 1434 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

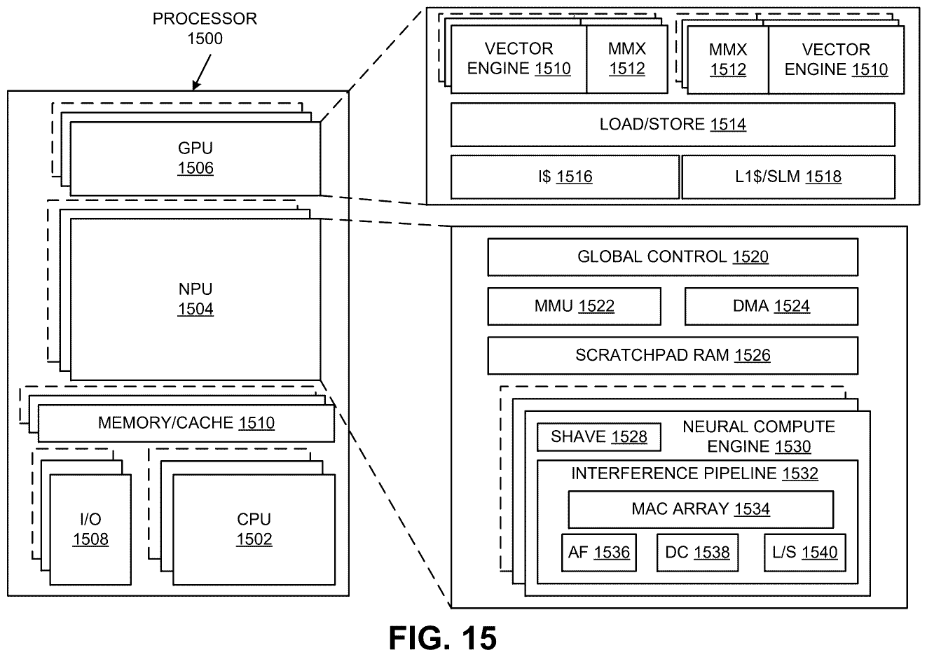

FIG. 15 shows a processor 1500, in accordance with at least one embodiment. Processor 1500 can include a processor with hybrid architecture (e.g., Lunar Lake or Meteor Lake) from Intel Corporation in Santa Clara, CA or another processor that shares at least some of the components described herein. Processor 1500 can include one or more Central Processing Unit(s) (CPU 1502), one or more Graphics Processing Unit(s) (GPU 1506), and/or one or more Neural Processing Unit(s) (NPU 1508) that can be, e.g., a dedicated AI accelerator that offloads artificial intelligence (AI) workloads from CPU 1502 and GPU 1506. Processor 1500 can use instructions that, if executed cause processor 1500 and/or any of its components to perform some or all of processes and techniques described elsewhere herein. Processor 1500 may include any number of memory and cache units to facilitate processing amongst different components of processor 1500. Memory and cache on processor 1500 may include one or more levels of cache (e.g., L1, L2, L3, and/or last-level cache) and high-bandwidth memory (e.g., HBM2e or HBM3) in any combination. With respect to processor 1500 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 1500 (e.g., in cache and/or memory). A result of API(s) can then be stored in storage within or outside of processor 1500, including registers, DRAM, flash, SRAM, cache, or other memory. One or more of APIs described herein can include a call.

Processor 1500 can include compute engines as CPUs 1502 and can include any number of cores, such as, but not limited to, up to 16 cores/22 threads. Cores in CPU 1502 can include P-cores (Performance), E-cores (Efficient) & LP-E cores (Low-power Efficient). Performance-cores can be used for low latency single-threaded, compute-intensive workloads, while Efficient-cores can be used for multi-threaded, less compute-intensive workloads. Low-power Efficient cores can be used for scalable multithreaded performance and offloading background tasks. P-cores can be used for single & limited threading performance, whereas E- and LP-E cores can be used for multi-threaded throughput and power efficiency.

GPU 1506 can include any number of graphics engines, such as, but not limited to, Intel® Arc™ graphics engines (Xe LPG) with 8 Xe cores (up to 128 Execution Units or EUs). As shown in FIG. 15, GPU 1506 can include vector engines and matrix engines 1512, that, for example, can run FP, INT, and matrix operation tasks all at the same time or separately or in batches. GPU 1506 can include a load/store unit 1514, as well as other memory, such as, but not limited to, an instruction cache (I$) 1516 and L1 cache/subsystem local memory (SLM) 1518 that can, e.g., store instructions to perform any of the operations described above or elsewhere herein.

NPU 1504 can include one or more Intel® AI Boost built-in neural processing unit(s) (NPUs). NPU 1504 can be enumerated to a host processor as an integrated PCIe device. NPU 1504 can include one or more (e.g., two) Neural Compute Engine (NCE) tiles 1530. Each tile can be configured with any combination of, but not limited to, (e.g., 2000) Multiply Accumulate (MAC) Engines 1534, a Post Processing Engine (not shown), a AI DSP Processor (not shown), and memory (2 MB of dedicated SRAM) per tile as shown in FIG. 15. For general compute needs, Neural Compute Engines 1530 can include interference pipeline 1532, activation function (AF) 1536, data conversion 1538, load/store 1540, and Streaming Hybrid Architecture Vector Engines (SHAVE) 1528 for high performance parallel computing, which can include DMA (Direct Memory Access) engines 1524 to shuttle data between system memory DRAM (Dynamic Random Access Memory) 1526 and a software managed cache. Built-in device MMU (Memory Management Unit) 1522 plus IOMMU (Input-Output Memory Management Unit) (not shown) can support multiple simultaneous hardware contexts and provide security isolation between execution contexts as per MCDM (Microsoft Compute Driver Model) architecture. Processor 1500 can also include a media unit (not shown) that is included on or separately from XCDs or other components of processor 1500 to enable video playback and video processing of compressed or non-compressed data, such using HEVC, AV1, VP9 and AVC HW accelerated decode support and HEVC, VP9 and AVC HW accelerated encode support.

A Intel® Thread Director, which includes firmware that is built into processor 1500, can prioritize and manage distribution of workloads, sending tasks to optimized cores. For example, Thread Director can tie P-cores, E-cores and/or LP-E cores (described above) together with task-scheduling capabilities and ability to send less-demanding tasks to E-cores or LP-E cores. Intel® Deep Learning Boost (Intel® DL Boost) (not shown) can provide built in AI acceleration for training and inference workloads, and may include VNNI (for CPU) and DP4a (for GPU) instruction set support. This instruction set may be optimized with OpenVINO™ Toolkit and oneAPI to accelerate INT8 inferencing. A software stack, e.g., as described elsewhere herein, can be used to enable AI inference using Open VINO™ toolkit. Processor 1500 can be configured to execute an application program, such as, but not limited to, a CUDA program.

In at least one embodiment, processor 1500 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

Processor 1500 can alternatively include a processor based on AI Engine Direct architecture from Qualcomm Corporation in Santa Clara, CA or another processor that shares at least some of the components described herein. that may include any number of NPUs, GPUs, CPUs and other related components, such as, but not limited to, NPU 1504 as a Hexagon NPU, GPU 1506 as a Adreno GPU, CPU 1502 as a Kryo or Qualcomm Oryon CPU, as well as a Qualcomm Sensing Hub (not shown) and a memory subsystem 1510, in any combination. Hexagon NPU 1504 can include a power rail a micro-tile inferencing unit, a hardware acceleration unit, a tensor unit, a scalar unit, and a vector unit (all not shown), which can have dedicated memory or share memory (e.g., cache or memory, such HBM3) for, e.g., storing instructions to perform any of the operations described above or elsewhere herein. Adreno GPU 1506 can provide graphics and parallel processing for AI in formats, such as, but not limited to, 32-bit floating point (FP32), 16-bit floating point (FP16), and 8-bit integer (INT8). Kryo or Qualcomm Oryon CPUs 1502 can perform AI workloads, and can handle contextualization for pervasive generative AI applications. CPU 1502 can also include an instruction fetch unit, a rename and retire unit, a memory management unit, a vector execution unit, an integer execution unit, and a load and store unit for processing and instruction management. With respect to processor 1500 and any of its components described above or elsewhere herein, one or more of APIs described herein can, for example, get compiled into instructions, which may be fetched by instruction fetch unit, decoded by a processor decoder or equivalents, scheduled (e.g., in order or out of order) for execution by a scheduler or equivalents, executed by execution logic or equivalents, reordered, and then retired by rename and retire unit. API(s) (and/or compiled instructions including API(s)) can be stored in any storage outside or inside of processor 1500 (e.g., in cache and/or memory). Any number of CPU cores 1502 may be included in any number of CPU cluster(s) that can be coupled to memory and/or cache, such as, but not limited to a shared L2 cache. Memory can be separate or shared, e.g., CPU clusters of CPU cores 1502 can couple to memory subsystem 1510 that can include fabric, system level cache and any number of memory management units that can, for example, read and write memory (e.g., DRAM). Qualcomm Sensing Hub (not shown) includes micro NPUs, a power rail, and traditional sensors (a gyrometer, accelerometer, even a barometer) with voice and data streams. Memory subsystem 1510 can include memory and cache on processor 1500, which may include one or more levels of cache (e.g., L1, L2, L3, and/or last-level cache) and high-bandwidth memory (e.g., HBM2e or HBM3) in any combination, e.g., for storing information and/or instructions to perform any of the operations described above or elsewhere herein. All or some of memory and/or cache in memory subsystem 1510 can be shared or used individually by any one or combinations of components (e.g., GPU 1506, NPU 1504, and CPU 1502) on processor 1500.

A Qualcomm AI Engine may be programmed and controlled with an a software stack to perform some or all of the operations described herein, and include, e.g., a Qualcomm® Neural Processing SDK for inferencing with versions for Android, Linux, and Windows. Developer libraries and services support programming languages, virtual platforms, and compilers. At a lower level of software stack, system software includes basic real-time operating system (RTOS), system interfaces, and drivers. Software stack supports different operating systems, including Android, Windows, Linux, and QNX, and deployment and monitoring infrastructure like Prometheus, Kubernetes, and Docker. For direct cross-platform access to GPU 1506, OpenCL and DirectML may be supported. For CPU 1502, a LLVM compiler infrastructure optimizations enable accelerated and efficient AI inference. With respect to Qualcomm AI Engine and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of a Qualcomm AI Engine (e.g., in cache and/or memory). A result of API(s) can then be stored in storage within or outside of Qualcomm AI Engine, including registers, DRAM, flash, SRAM, cache, or other memory.

In at least one embodiment, processor 1500 (e.g., or Qualcomm AI Engine) can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

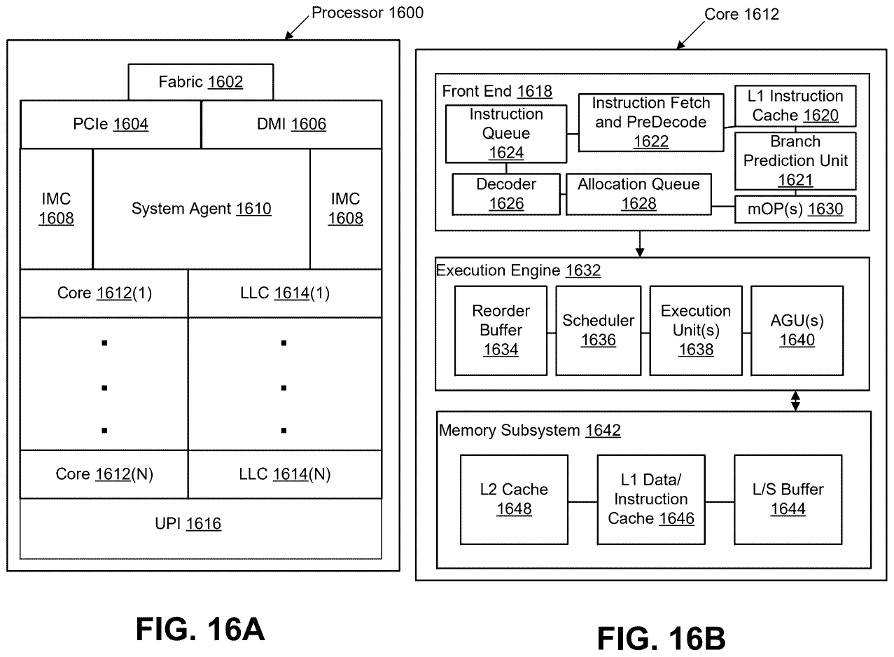

FIG. 16A illustrates a processor 1600, in accordance with at least one embodiment. Processor 1600 can include an processor with scalable family from Intel Corporation in Santa Clara, CA or another processor that shares at least some of the components described herein. Processor 1600 can include one or more cores 1612(1)-1612(N), where N is any integer greater than 1 that can perform the operations described elsewhere herein. Cores 1612(1)-1612(N) can be interlinked together using ring and/or mesh interconnects. With a mesh interconnects architecture, an array of vertical and horizontal communication paths may allow traversal from one core to another 1612(1)-1612(N) through a shortest path (hop on vertical path to correct row, and hop across horizontal path to correct column). For mesh interconnects, a die can house cores 1612(1)-1612(N) and can include a grid of converged mesh stops (CMS) that may be associated (e.g., 1:1) with cores 1612(1)-1612(N). Each core can be associated with one lower level cache (LLC) slice 1614(1)-1614(N), or cores 1612(1)-1612(N) can share cache, e.g., lower level cache. LLCs 1614(1)-1614(N) can be inclusive by incorporating blocks in higher level cache (e.g., L2 cache) or non-inclusive (having blocks that may be not present in higher level cache). Each core and LLC slice can include a Caching and Home Agent (CHA) (not shown) that can maintain cache coherency by providing scalability of resources across mesh interconnects for Intel® Ultra Path Interconnect (Intel® UPI 1616) cache coherency functionality. UPI 1616 can provide a coherent interconnect for scalable systems and can allow for multiple processors to share a single shared address space through links, such as, but not limited to, two or three UPI links per processor.

Processor 1600 can also include System Agent 1610 that can house and/or perform various functionalities, such as, but not limited to, memory management, display functions, and/or input/output (I/O) functions. For example, processor 1600 can include one or more integrated memory controller(s) (IMC) 1608. IMC 1608 can control and manage memory, such as, but not limited to, different memory types e.g., DDR ram, like DDR4 or others described elsewhere herein. System Agent 1610 can include a display controller (not shown) to support display(s). System Agent 1610 can also incorporate PCIe 1604 (e.g., up to 20 lanes of PCIe), e.g., that can connect with an external dedicated graphics hookup over DMI bus (e.g., Intel's DMI 3.0 bus) 1606. System Agent 1610 can include an Image Processing Unit (IPU) (not shown) which incorporates an image signal processor (ISP) on-die. Fabric 1602 can provide scalability for connecting to other nodes (e.g., processors, such as processor 1600), and can, for example, be used with Cornelis Networks, an element of Intel® Scalable System Framework, that delivers the performance for high performance computing (HPC) workloads and the ability to scale to tens of thousands of nodes.

FIG. 16B illustrates components within core 1612, in accordance with at least one embodiment. Core 1612 can include front-end 1618, back-end or execution engine 1632, and memory subsystem 1642. Front-end 1618 can provide execution engine 1632 with operations (e.g., operations described elsewhere herein) by decoding instructions stored in memory. For example, front-end 1618 can include a micro-operations (μOps) cache path and/or a legacy path, along with branch prediction unit 1621 that can determine paths instructions. A legacy path for instructions may include fetching variable-length (e.g., x86) instructions from L1 instruction cache 1620 with instruction fetch and predecode 1622, queuing the instructions in instruction queue 1624, and decoding instructions using decoder 1626 into μOps that can be provided to allocation queue 1628. Alternatively, a μOPs cache path may include a cache containing already decoded μOps (μOps 1630) that can be sent to allocation queue 1628. Allocation queue 1628 can perform as an interface between front-end 1618 and execution engine 1632, and can provide instructions to execution engine 1632. One or more of API(s) described herein can, for example, get compiled into instructions that can be stored, processed, and executed by front-end 1618, execution engine 1632, and stored in memory subsystem 1642.

Execution engine 1632 can receive micro-operations into reorder buffer 1634, which can register allocation, rename, and retire OPs. From reorder buffer, μOPs can be sent to scheduler 1636 that can be connected one or more different execution units 1638, which can be connected to address generation unit (AGU) 1640. Execution units 1638 can perform, e.g., basic arithmetic logic unit (ALU) operations, multiplication, division, and/or more complex operations, such as, but not limited to, various vector operations. Scheduler 1636 may manage queuing μOPs for one or more of execution units 1638 depending, e.g., on operations needed to be performed.

Memory subsystem 1642 can process load and store requests as well as ordering operations. For example, μOPs may relate to memory access (e.g. load and store), and those can be sent on dedicated scheduler ports that can perform those memory operations. Store and load operations, for example, can be sent to load and store buffer(s) 1644. Memory subsystem 1642 can also include shared or separate L1 data and instruction cache 1646, as well as L2 cache 1648 that can be used and shared by L1 data and instruction cache 1646. As described above for FIG. 16A, each core 1612 can be connected to a slice of a third level of cache (e.g., LLC 1614) that can be shared by all core 1612.

In at least one embodiment, processor 1600 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

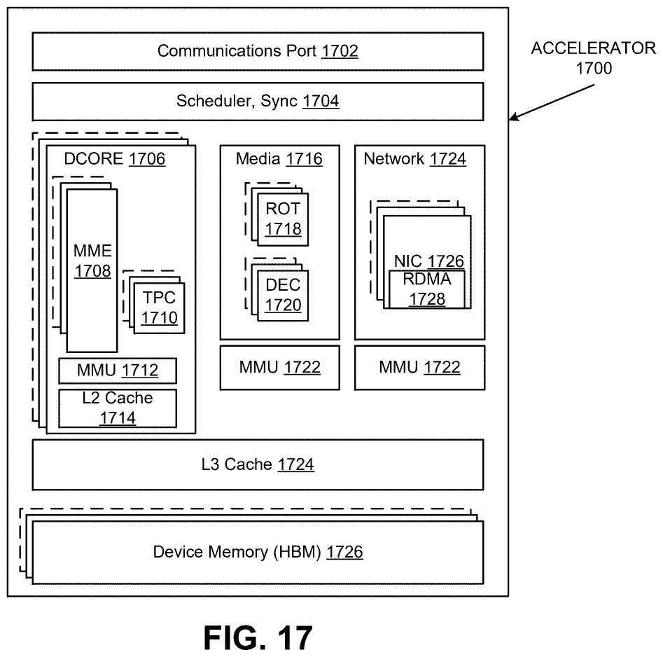

FIG. 17 illustrates an AI accelerator 1700, in accordance with at least one embodiment. A processor can include a processor with AI accelerator 1700 architecture from Intel Corporation in Santa Clara, CA or another processor that shares at least some of the components described herein. AI accelerator 1700 may use instructions that, if executed by AI accelerator 1700, cause AI accelerator 1700 to perform some or all of processes and techniques described elsewhere herein. For example, with respect to AI accelerator 1700 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of AI accelerator 1700 (e.g., in cache and/or memory). A result of API(s) can then be stored in storage within or outside of AI accelerator 1700, including registers, DRAM, flash, SRAM, cache, or other memory. AI accelerator 1700 may include one or more compute dies that can include homogeneous or heterogeneous processors. Compute dies may include one or more central processing units (CPU), one or more graphics processing units (GPU), or combinations of both.

In at least one embodiment, compute dies may include compute engines to perform AI computations. In at least one embodiment, AI accelerator 1700 compute dies may be split into any number of (e.g., four) clusters that may be referred to as a DCORE (Deep Learning Core) 1706 and contain any number of Matrix Multiplication Engines (MMEs) 1708, Tensor Processor Cores (TPCs) 1710, memory management unit 1712, and L2 Cache 1714, in any combination. MME(s) 1708 can perform operations that use Matrix Multiplication, like fully connected layers, convolutions and batched-General Matrix Multiplications (GEMMs). MMEs 1708 may be equipped with Multiply-Accumulate Units (MACs) (not shown) that, for example, may perform General Matrix Multiplication (GEMM) operations, such as, but not limited to, an A×B multiplication that involves generating tensor C[N×M] from two input tensors, A[N×K] and B[K×N]. MME(s) 1708 may be programmed with array dimensions, locations, data types, and various execution operands. MME(s) 1708 can retrieve tensors A and B from memory, pulling them into its streaming buffers for matrix multiplication to be performed in parallel by MACs. MME(s) 1708 may push tensor C back to memory upon completion. TPC(s) 1710 may include any number of scalar units for performing scalar operations, any number of vector units for performing vector operations, any number of register files or local memory units (e.g., a vector local memory), and load and store components for instructions, which can be coupled to memory or cache (e.g., HBM, L3 cache and/or L2 cache) (all not shown). TPCs can support different types of parallel processing, e.g., Very Long Instruction Word (VLIW) Single-Instruction Multiple-Data (SIMD) that supports data types, such as, but not limited to, FP32, BF16, FP16 & FP8 (both E4M3 and E5M2), UINT32, INT32, UINT16, INT16, UINT8 and INT8 datatypes. Any number of compute dies may be connected through an interconnect. An interconnect that can connect compute dies can be over an interposer bridge that, e.g., is transparent to software.

Memory on AI Accelerator 1700 may include one or more levels of cache (e.g., L1, L2, L3, and/or last-level cache) and high-bandwidth memory (e.g., HBM2e or HBM3) in any combination. Memory and/or cache systems can be unified or separate. Compute dies of AI accelerator 1700 may include on-die memory that includes one or more levels (e.g., two-levels) of cache. On-die SRAM or other memory described elsewhere herein can be used as a uniformly accessible last-level cache (L3) or split to slices of L2 cache that may be accessible to groups of MMEs 1708 and TPCs 1710. Using on-die memory as L2 or L3 cache can be fully configurable by software, which dynamically may decide per I/O tensor its optimal cache allocation. AI Accelerator 1700 may include one or more Memory Management Units (MMUs) 1722 for managing memory, such as allowing AI accelerator 1700 memory subsystem to operate in a virtual space when accessing VRAM.

AI accelerator 1700 may include a communications port (e.g., a PCIe Gen5 X16 port) 1702 for communicating with a host and Scheduling and Synchronization Unit 1704. AI accelerator 1700 may include Media Unit 1716 that may include any number or combinations of Media Decoder Engines (DECs) 1720 and Rotator Engines (ROT) 1718. AI accelerator 1700 may include a network unit subsystem 1724 that may include any number or combinations of network ports 1726 and accompanied RDMA Engine(s) 1728, L2 Cache, and memory (e.g., HBM2e or HBM3) stacks. AI accelerator 1700 can incorporate a programmable Control Path entity (not shown) to manage parallel and efficient execution of various engines. Control Path can include Submission Queues (SQs) that may be issued by runtime system, Completion Queues (CQs) that may be used for job completion reporting, a Programmable Scheduling Mechanism that may be utilized for task scheduling, a Programmable Hardware Synchronization Mechanism or ‘Sync Manager (SM)’ that may be used for hardware synchronization, a Programmable Interrupt Service Mechanism or ‘Interrupt Manager (INTR)’ that can enable passing of asynchronous events to drivers.

AI accelerator 1700 may include media decoding units that support Video Formats, such as, but not limited to, HEVC, Progressive H.264, SVC base layer, MVC, VP9, JPEG, Progressive JPEG. AI accelerator 1700 may support post processing of decoded media streams, such as, but not limited to, image down-scaling (resizing an image), vertical and horizontal scaling at different scaling ratios, Image up-scaling, Image cropping, bilinear scaling, and Lancos scaling. AI accelerator 1700 may implement two post processing channels per decoder unit, one with scalar (up and down) and one just to output the original image. AI accelerator 1700 may include a hardware rotator engine that performs the following transformations of an input image: 2D rotation, 3D rotation, Projection, distorting and undistorting images, resampling input data at user-defined coordinates, and rescaling.

RDMA 1728 over Converged Ethernet on AI accelerator 1700 may enable scaling from a single node (i.e., a single AI Accelerator 1700 to hundreds or thousands of nodes or AI Accelerators 1700). NW Subsystem 1724 can include an Intel® Gaudi® Communication Library (IGCL), a master conductor that orchestrates data movement, and a programable scheduling mechanism that can enable smooth activation of engines while maintaining task dependencies. A accelerator networking sub-system can include Gigabit Ethernet NIC ports 1726, a Layer2 MAC (not shown), and RDMA Engines 1728. AI Accelerator 1700 can include Aggregation Engines for performing summing activities. All engines in a processor including an AI accelerator 1700 can operate in parallel, e.g., MME(s) 1708, TPC(s) 1710 and NIC(s) 1726 can all work at the same time. There can be dependency between operations running on different engines, e.g., output of one engine can be used as input of another engine, and/or MME, TPC and NIC can be scheduled to run in parallel. When one engine has completed its executing operation, another engine can be scheduled to start working on the next operation (immediately upon readiness of its inputs).

AI Accelerator 1700 can be operated and controlled using a software layer that may include low-level components, such as, but not limited to, a graph compiler, an automatic kernel fuser and a library of precompiled kernels, as well as integration to AI ecosystems, such as, but not limited to, PyTorch, DeepSpeed, Hugging Face, vLLM, Ray and more, or as described elsewhere herein with respect to software and programming platforms. A software layer may include implementations of algorithms, such as, but not limited to, Paged Attention, Flash Attention and more. A software layer may generate optimized binary code that implements a given model topology, such as, but not limited to, performing operator fusion, data layout management, parallelization, pipelining and memory management, and graph-level optimizations.

In at least one embodiment, AI accelerator 1700 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

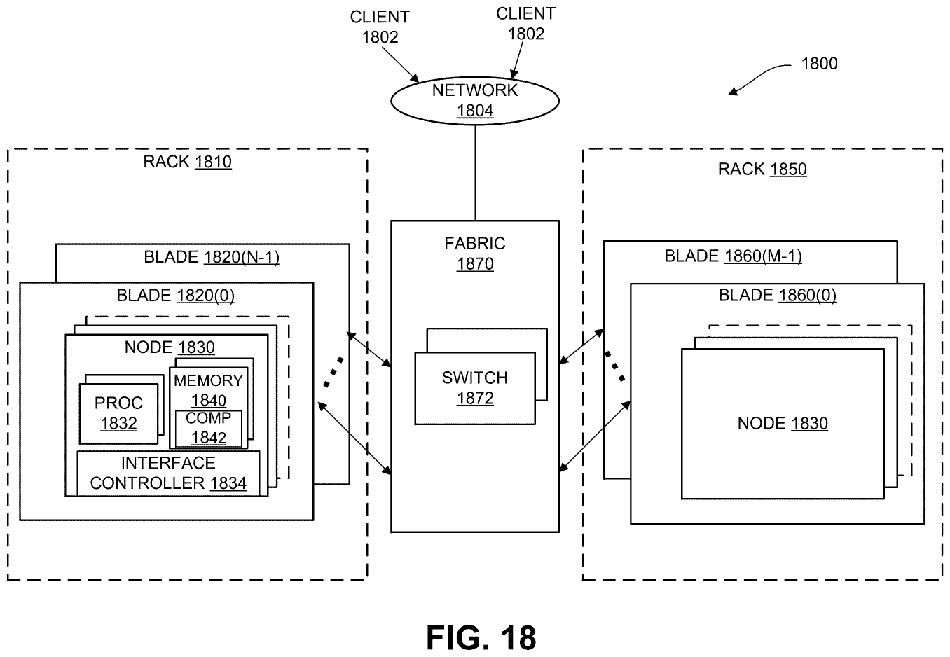

FIG. 18 is a block diagram of an embodiment of a multi-node network in which remote memory computation can be implemented, in accordance with any embodiment. System 1800 may represent a network of nodes described herein that can, e.g., be used to perform some or all of the operations described herein. System 1800 can represent a data center. System 1800 may represent a server farm. System 1800 may represent a data cloud or a processing cloud. System 1800 can represent a supercomputer. System 18 may include tens, hundreds, or thousands of nodes. Nodes of system 1800 may include processors, such as, but not limited to, central processing units (CPUs), graphics processing units (GPUs), or any combination of processors described herein, such as, but not limited to, other processors in FIGS. 13-25. With respect to any of processors in system 1800 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of a processor or node (e.g., in cache and/or memory). A result of API(s) can then be stored in storage within or outside of a processor or node, including registers, DRAM, flash, SRAM, cache, or other memory equivalents. System 1800 may include over nine thousand nodes, with each node including two Intel Xeon Max processors, six Intel Max series GPUs and a unified memory architecture, such as, but not limited to, that used in Intel Aurora Supercomputer from Intel Corporation in Santa Clara, CA or another supercomputer that shares at least some of the components described herein.

One or more clients 1802 make requests over network 1804 to system 1800. Network 1804 represents one or more local networks, or wide area networks, or a combination. Clients 1802 can be human or machine clients, which generate requests for execution of operations by system 1800. System 1800 executes applications or data computation tasks requested by clients 1802.

System 1800 can include one or more racks, which represent structural and interconnect resources to house and interconnect multiple computation nodes. Rack 1810 can include multiple nodes 1830. Rack 1810 may host multiple blade components 1820(0) to 1820(N−1), where N is an integer greater than or equal to 2. Hosting can refer to providing power, structural or mechanical support, and interconnection. Blades 1820(0) to 1820(N−1) can refer to computing resources on printed circuit boards (PCBs), where a PCB houses hardware components for one or more nodes 1830. Blades 1820(0) to 1820(N−1) may or may not include a chassis or housing or other “box” other than that provided by rack 1810. Blades 1820(0) to 1820(N−1) may include housing with exposed connector to connect into rack 1810. System 1800 may or may not include rack 1810, and each blade (e.g., 1820(0)) can include a chassis or housing that can stack or otherwise reside in close proximity to other blades and allow interconnection of nodes 1830. System 1800 may include 10,624 compute blades, which include 63,744 Intel Max Series GPUs and 21,248 Intel Xeon Max CPUs across 166 racks.

System 1800 can include fabric 1870, which represents one or more interconnectors for nodes 1830. Fabric 1870 can include multiple switches 1872 or routers or other hardware to route signals among nodes 1830. Additionally, fabric 1870 can couple system 1800 to network 1804 for access by clients 1802. In addition to routing equipment, fabric 1870 can be considered to include cables or ports or other hardware equipment to couples nodes 1830 together. Fabric 1870 can have one or more associated protocols to manage routing of signals through system 1800. A protocol or protocols is at least partly dependent on hardware equipment used in system 1800.

As illustrated, rack 1810 can include N blades (e.g., 1820(0) to 1820(N−1)). In addition to rack 1810, system 1800 can include rack 1850. As illustrated, rack 1850 may include M blades (e.g., 1860(0) to 1860(M−1)). M is not necessarily the same as N; thus, it will be understood that various different hardware equipment components could be used, and coupled together into system 1800 over fabric 1870. Blades 1860(0) to 1860(M−1) can be the same or similar to blades 1820(0) to 1820(N−1). Nodes 1830 can be any type of node as described herein, and may not be necessarily all the same type of node. System 1800 is not limited to being homogenous, nor is it limited to not being homogenous.

A node in blade 1820(0) is illustrated in detail. However, other nodes in system 1800 can be the same or similar. At least some nodes 1830 may be computation nodes, with processor 1832 and memory 1840. A computation node refers to a node with processing resources (e.g., one or more processors) that executes an operating system and can receive and process one or more tasks. At least some nodes 1830 can include storage server nodes with a server as processing resources of processor 1832 and memory 1840. A storage server refers to a node with more storage resources than a computation node, and rather than having processors for execution of tasks, a storage server includes processing resources to manage access to storage nodes within a storage server.

Node 1830 can include interface controller 1834, which can represent logic to control access by node 1830 to fabric 1870. Logic can include hardware resources to interconnect to physical interconnection hardware. Logic can include software or firmware logic to manage interconnection. Interface controller 1834 can include a host fabric interface, which can include a fabric interface in accordance with any embodiment described herein.

Node 1830 may include memory subsystem 1840. Memory 1840 can include memory computation resources (comp) 1842, which represent one or more capabilities by memory 1840 to perform memory computations. System 1800 enables remote memory operations, such as, but not limited to, the operations described elsewhere herein. Thus, nodes 1830 can request memory computations by remote nodes, where data for computation remains local to an executing node instead of being sent over fabric 1870 or instead of being sent from memory to a fabric interface. In response to execution of memory computation, executing node can provide a result to a requesting node.

Processor 1832 can include one or more separate processors. Each separate processor can include a single processing unit, a multicore processing unit, or a combination. A processing unit can include a primary processor such as, but not limited to, a CPU (central processing unit), a peripheral processor such as, but not limited to, a GPU (graphics processing unit), or a combination. Memory 1840 can be or include memory devices and a memory controller.

Reference to memory devices can apply to different memory types. Memory devices generally refer to volatile memory technologies. Volatile memory is memory whose state (and therefore data stored on it) is indeterminate if power is interrupted. Nonvolatile memory refers to memory whose state is determinate even if power is interrupted. Dynamic volatile memory can refresh data stored in a device to maintain state. One example of dynamic volatile memory includes DRAM (dynamic random access memory), or some variant such as, but not limited to, synchronous DRAM (SDRAM). A memory subsystem as described herein may be compatible with a number of memory technologies, such as, but not limited to, DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideI02), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted. In one embodiment, nonvolatile memory device is a block addressable memory device, such as, but not limited to, NAND or NOR technologies. Thus, a memory device can also include a future generation nonvolatile devices, such as, but not limited to, a three dimensional crosspoint (3DXP) memory device, other byte addressable nonvolatile memory devices, or memory devices that use chalcogenide phase change material (e.g., chalcogenide glass). In one embodiment, a memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In at least one embodiment, system 1800 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

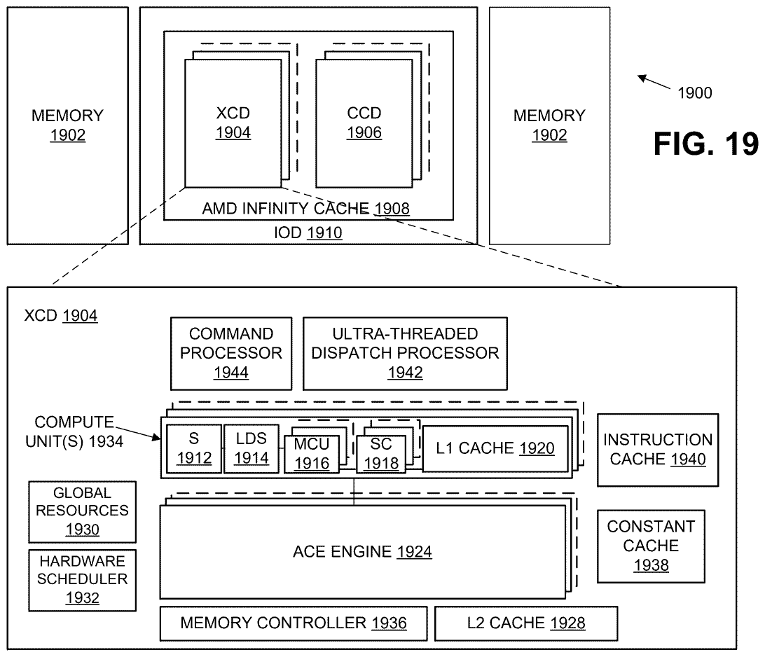

FIG. 19 illustrates accelerated processing unit 1900, in accordance with at least one embodiment. Accelerated processing unit 1900 can include a processor based on CDNA architecture from AMD Corporation in Santa Clara, CA or another processor that shares at least some of the components described herein. Accelerated processing unit 1900 can include one or more accelerator complex dies (XCDs) 1904 for performing operations described elsewhere herein, such as, but not limited to, graphics processing and/or parallel processing as well as computations with instruction-level parallelism, including support for a broad range of precisions (INT8, FP8, BF16, FP16, TF32, FP32, and FP64) and sparse matrix data (i.e. sparsity). XCDs may, in some instances, be referred to as Graphics Compute Dies (GCDs). Accelerated processing unit 1900 can include one or more complex compute dies (CCDs) 1906 for performing operations described elsewhere herein, such as, but not limited to, those operations performed by host processors. CCDs may, in some instances, be referred to as core complexes or CCXs, such as, but not limited to, CCXs used in AMD Ryzen processors. XCDs and CCDs can share any type of cache or memory (e.g., one or more memory units 1902), or have cache or memory allocated to each XCD or CCD or groups of XCDs or CCDs. For example, on-package AMD Infinity Fabric connects XCDs and CCD into shared AMD Infinity Cache 1908 and, in some embodiments, high-bandwidth memory (e.g., HMB3). Accelerated processing unit 1900 can include an AMD MI300a processor that includes three CPU chiplets (or CCDs) and six accelerator chiplets (XCDs) on top of four input-output dies (IODs) that may be layered on a piece of silicon that links them together (e.g., via AMD Infinity Fabric) to eight stacks of high-bandwidth DRAM that ring a superchip. An AMD MI300x processor substitutes CCDs for two more XCDs, for an accelerator-only system.

Accelerated processing unit 1900 can include one or more input/output (I/O) interfaces. For example, XCDs 1904 and CCDs 1906 can be together on one or more input-output dies (IODs) 1910 that can include one or more I/O interfaces. IODs 1910 can include of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 1970. I/O interfaces from IODs 1910 can also be used for connected one or more accelerated processing units 1900, e.g., in a server architecture.

Accelerated processing unit 1900 can include one or more memory units 1902 for storing instructions and other information used to perform operations described elsewhere herein. Memory units 1902 can include any volatile memory, such as, but not limited to, memory types described elsewhere herein and can include, e.g., high-bandwidth memory (e.g., HMB3) or high-bandwidth DRAM. Memory associated with accelerated processing unit 1900 (e.g., memory units 1902) can include system memory that can be used, for example, for commands, instructions and constants, and inputs and outputs. Memory units 1902 can also include device memory that can be used as storage and, for example, for commands, instructions and constants, and inputs and outputs, as return buffer(s) and for private data. Memory units 1902 can be linked to one or more IODs 1910. L1 cache 1920 starts a memory hierarchy that includes shared L2 cache 1928, e.g., within XCDs. AMD Infinity Cache™, which is a last level cache (LLC) located on an active I/O die (IOD). CCDs 1906 and XCDs 1904 may have separate or shared memory. AMD Infinity Architecture and AMD Infinity Fabric™ technology can enable coherent, high-throughput unification of GPU and CPU chiplet technologies (e.g., XCDs, CCDs, and/or CCXs) with memory (e.g., stacked HBM3 memory) in single devices and across multi-device platforms.

As shown in FIG. 19, an XCD 1904 can include a shared set of global resources 1930, which can include hardware scheduler 1932 and Asynchronous Compute Engines (ACE) 1924 that send tasks (e.g., compute shader workgroups) to Compute Units (CUs or cores) 1934. ACEs 1924 (e.g., four) can be each associated with CUs 1934 (e.g., 40 CUs), and some of CUs 1934 can be disabled for yield management. CUs 1934 can have dedicated cache or share cache (e.g., L2 cache) 1928 that may be used to coalesce all memory traffic for a die. CUs 1934 can include threaded and parallel processor cores including instruction fetching and scheduling with Scheduler(S) 1912, matrix core unit (MCU) 1916 and shader core (SC) 1918 (e.g., execution units for scalar, vector and matrix data types), as well as load/store pipelines with an L1 cache 1920 and Local Data Share (LDS) 1914. Local data share can include, for example, a scratch RAM with built-in arithmetic capabilities that allow data to be shared between threads in a workgroup. An instruction cache 1940 (e.g., for storing and providing instructions for performing operations described elsewhere herein) and a constant cache 1938 can be connected to one or more CUs and can be shared between two CUs. Matrix cores 1916 can process a variety of data types, such as, but not limited to, INT8, FP8, FP16, BF16 and TF32 data types. Accelerated processing unit 1900 can include compute units 1934 that may be arranged in an array format, e.g., as a data-parallel-processor (DPP) array. Ultra-threaded dispatch processor 1942 can communicate with compute units 1934, and command processor 1944 can read commands that a host has written to memory-mapped registers in a system-memory address space (not shown). Command processor 1944 can send hardware-generated interrupts to a host processor (e.g., a CCD) when a command is completed. Memory controller 1936 can also have direct access to all device memory and host-specified areas of system memory. To satisfy read and write requests, memory controller 1936 can perform functions of a direct-memory access (DMA) controller, including computing memory-address offsets based on a format of requested data in memory. For example, one or more of APIs described herein can, for example, get compiled into instructions that can be stored in instruction cache 1940 and then fetched by instruction fetch logic in a processor, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor of accelerated processing unit 1900 (e.g., in cache and/or memory). A result of API(s) can then be stored in storage within or outside of processor of accelerated processing unit 1900, including registers, DRAM, flash, SRAM, cache, or other memory equivalents.

An application can include a program running on a host processor (e.g., a CCD) and programs, called kernels, running on one or more XCDs. Programs can be controlled by host commands that set internal base-address and other configuration registers, specify a data domain on which accelerated processing unit 1900 can operate, invalidate and flush caches on accelerated processing unit 1900, and cause accelerated processing unit 1900 to begin execution of a program. Kernels can be referred to as programs executed by accelerated processing unit 1900. A kernel can be executed independently on every work item, or as groups of work-items that can be referred to as a wavefront, which can execute a kernel on all work-items in a group (e.g., 64) in one pass. Compute units 1934 can include a scalar arithmetic logic unit (ALU), which can operates on one value per wavefront (common to all work items), a vector ALU, which can operate on unique values per work-item, a local data share 1914, which can allow work-items within a workgroup to communicate and share data, a scalar memory (not shown), which can transfer data between scalar general-purpose registers (SGPRs) and memory through a cache, and vector memory, which can transfer data between vector general-purpose registers (VGPRs) and memory, including sampling texture maps. Kernel control flow can be handled using scalar ALU instructions, which can includes if/else, branches and looping. Scalar ALU (SALU) and memory instructions can work on an entire wavefront and operate on one or more SGPRs. Vector memory and ALU instructions can operate on all work-items in a wavefront at one time.

In at least one embodiment, accelerated processing unit 1900 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

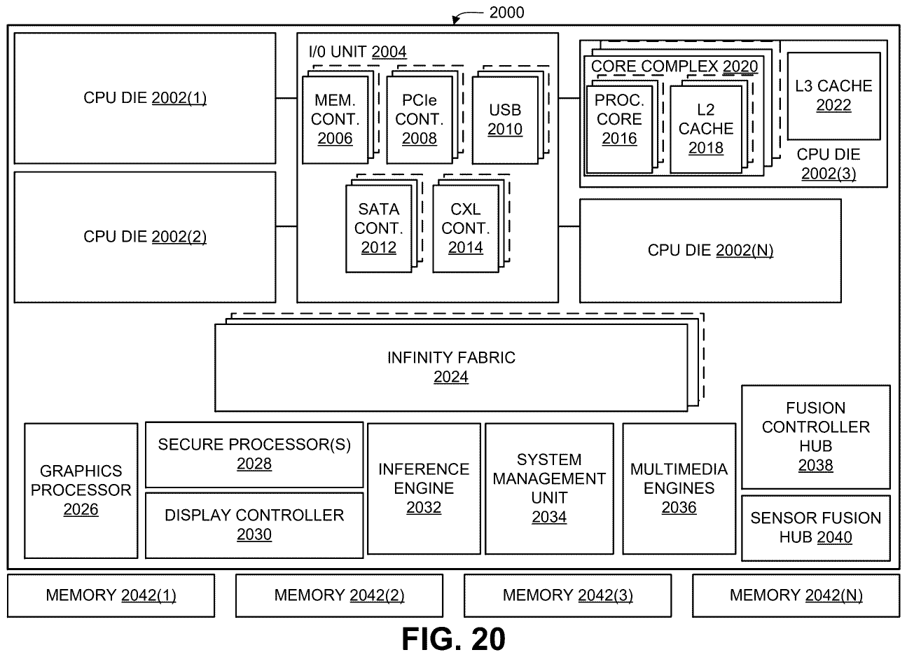

FIG. 20 illustrates a processor 2000, such as, but not limited to, a processor based on a Zen architecture (such as, e.g., Zen 1, 2, 3, 4, 5 or other) from AMD Corporation in Santa Clara, CA or another processor that shares at least some of the components described herein. Processor 2000 includes one or more CPU dies 2002(1)-2002(N), where N is any integer greater than 1. CPU die 2002 can include any number of processor cores 2016 (e.g., to perform any of the operations described elsewhere herein) and any number of cache memories (e.g., to store instructions and other information to perform any of the operations described elsewhere herein), in any combination. For example, L2 Cache units 2018 can be coupled to processor core(s) 2016, which can share and/or couple individually to L2 Cache units 2018. Processor cores 2016 can couple to L3 cache 2022 individually and/or share L3 Cache, which can be a lowest level cache (LLC) 2022 for access to data and other information used by processor cores 2016. One or more processor cores 2016 and one or more L2 Cache units 2018 can be included in a core complex (CCX) 2020 that can include (e.g., a 32 MB) shared cache (e.g., L3 cache 2022). Core complex 2020 can be fabricated onto a die (CCD or CPU die) 2002. For example, up to 12 core complexes 2020 can be configured into a processor along with 8 CPU dies 2002 to provide up to 96 processor cores 2016 for processor 2000. A ‘Zen 4c’ core complex 2020, for example, can include up to eight cores 2016 and a shared 16 MB L3 cache 2022. Two of these core complexes 2020 can be combined onto a single CPU die 2002 for 16 cores per die and a total of 32 MB of L3 cache 2022 per die. Up to eight of CPU dies 2002 may be combined with an I/O unit 2004 to provide CPUs with up to 128 processor cores 2016. Up to four ‘Zen 4c’ dies described above can be combined to provide CPUs with up to 64 processor cores 2016.

Processor 2000 can include a variety of configurations for input/output operations that are described further herein. I/O unit 2004 can include one or more memory controllers 2006 that can manage memory usage (e.g., DDR5 memory) for processor 2000. I/O unit 2004 may include one or more SATA disk controllers for managing storage and one or more Compute Express Link (CXL™) 1.1+ memory controllers 2014 that can provide CPU-to-device and CPU-to-memory connections and can be flexibly assigned to specific functions at server design time. I/O unit 2004 may include PCIe controller 2008 for connecting peripherals and other components connected to processor 2000. I/O unit 2004 may include USB ports 2010 for connecting to other components separate from processor 2000. CPU dies 2002 can support any number of connections, e.g., one or two connections, to I/O unit 2004. As shown, I/O unit 2004 can include components described further herein, and I/O unit 2004 can be a I/O die that houses several different components. Memory controller 2006, PCIe controller 2008, USB ports 2010, SATA controller 2012, and/or CXL controller 2014 can be integrated anywhere within processor 2000 either separately or in any groups or combinations thereof.

Processor 2000 can include Infinity Fabric 2024 interconnects (which can be similar to or based on PCIe architectures) that can provide connections among CPUs (e.g., CPU dies 2002(1)-2002(N)), graphics processor(s) 2026, inference engine(s) 2032, and other components in a multi-chip architecture, such as secure processor(s) 2028 and I/O unit 2004. One or more AMD Infinity Fabric™ interconnects 2010 can connect to CPU dies 2002(1)-2002(N) and serve as a connection that is used between CPUs. One or more Infinity Fabric connections can connect each CPU die 2002 to I/O unit.

In at least one embodiment, processor 2000 can include central processing units (CPUs) and other associated hardware and software described above and further herein. Processor 2000 can also include graphics processor(s) 2026. Graphics processor 2026 can be used for image generation and processing, as well as other computations and operations described further herein. Graphics processor 2026 can be based on RDNA 3 or 3.5 architecture from AMD in Santa Clara, CA. Graphics processor 2026 can include graphics compute dies (GCDs) and memory cache dies (MCDs). GCDs can include any number of compute units (CUs) for graphics or other processing, such as operations performed by arithmetic logic units (ALUs) that are described further herein. Graphics processor 2026 can include L2 cache that can be used by compute units. MCDs (not shown) can include any number of memory units and can include cache, such as L3 cache, as well as memory interfaces for coupling to memory, such as memory 2042(1)-(N), where N is an integer. Components within graphics processor 2026 can be connected using various approaches, such as using Infinity Fabric 2024 interconnects outside or within graphics processor 2026.

Inference engine 2032 can provide neural processing capabilities for processor 2000 for computational processes that are used for neural networks, deep learning, and other artificial intelligence-related operations described further herein. Processor 2000 can include secure processor(s) 2028 for managing security of processor 2000, display controller 2030 for controlling displays, a system management unit 2034 for managing and operating some or all of the components on processor 2000, multimedia engines 2036 for audio and video operations, fusion controller hub 2038 for managing USB, SATA and PCIe connections to processor 2000, and sensor fusion hub 2040 for managing sensors, such as accelerometers. Processor 2000 can also include memory 2042(1)-(N), where N is any integer. Memory can include different memory types, such as LPDDR5 and/or DDR5, or others described elsewhere herein.

For performing operations described further herein, processor 2000 can include an execution pipeline including a front-end that can include a cache (e.g., L1 cache) that stores instructions (not shown). Flow of instructions can be modified by a branch predictor. Instructions can be decoded by a decoder, dispatched to a back-end for execution, and renamed. Instruction fetch and decode pipes, for example, can be dispatched to integer or floating point execution operations that can be scheduled by a scheduler and transferred to vector and/or general-purpose registers. Floating point multiplier and/or add operations can be processed, and arithmetic logic units (ALUs) can also be used to perform computations, such as arithmetic and logic operations. Outputs from computation units can be coupled to a load/store queue, which can be connected to cache, such as L1 cache and/or L2 cache.

With respect to processor 2000 and any of its components described above or elsewhere herein, one or more of APIs or equivalents described herein can, for example, get compiled into instructions or equivalents (e.g., AVX-512 instructions based on an SIMD model), which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 2000 (e.g., in cache and/or memory). A result of API(s) can then be stored in storage within or outside of processor 2000, including registers, DRAM, flash, SRAM, cache, or other memory equivalents.

In at least one embodiment, processor 2000 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

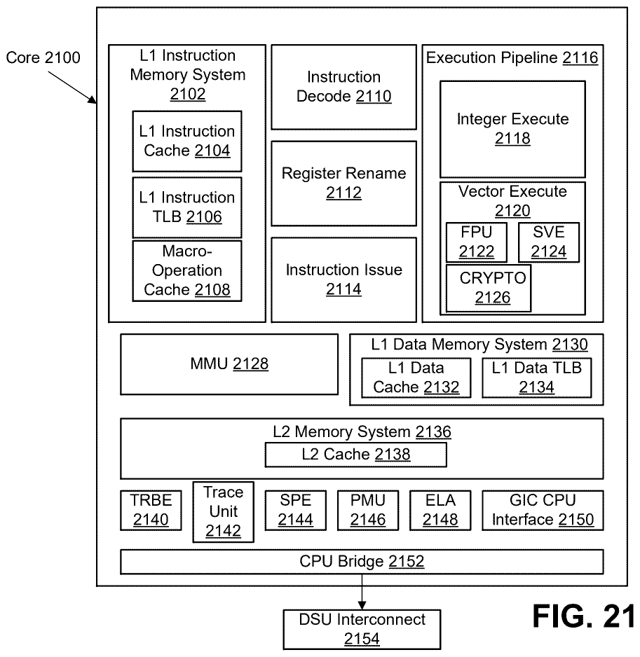

FIG. 21 illustrates an example of a processing core 2100 that may implement Arm architecture (e.g., v9.0-A) or another processor that shares at least some of the components described herein. Neoverse™ V2 core 2100 can be implemented inside a DynamIQ Shared Unit (DSU) cluster via DSU-110 interconnect 2154 for connected one or more cores, e.g., for parallel processing. Neoverse™ V2 core may be implemented as a single core in a DSU cluster that is configured for Direct connect, with or without L3 cache, snoop filter, or Snoop Control Unit (SCU) logic (not shown). Neoverse™ V2 core can include a CPU bridge 2152 that connects core 2100 to DSU-110 interconnect, which can also connect core 2100 to an external memory system and the rest of a system-on-a-chip. L1 instruction memory system 2102 can fetch instructions from an instruction cache 2104 and deliver instructions (e.g., one or more APIs described herein that may be compiled into instructions) to an instruction decode unit 2110, e.g., to perform some or all of operations described above or elsewhere herein. L1 instruction memory system 2102 may include L1 instruction cache 2104, e.g., with 64-byte cache lines, L1 instruction Translation Lookaside Buffer (TLB) 2106, e.g., with native support for 4 KB, 16 KB, 64 KB, and 2 MB page sizes, Macro-Operation Cache (MOP) 2108 (e.g., 1536-entry, 4-way skewed associative L0 MOP cache), which can contain decoded and optimized instructions for higher performance. Instruction decode unit 2110 can decode AArch64 instructions into internal format. Register rename unit 2112 can perform register renaming to facilitate out-of-order execution and dispatches decoded instructions to various issue queues. Instruction issue unit 2114 can control when decoded instructions may be dispatched to execution pipelines, and it can include issue queues for storing instructions pending dispatch to execution pipelines. Integer execution pipeline 2116 can be included in an execution pipeline and include integer execute unit 2118 that can perform arithmetic and logical data processing operations. Vector execute unit 2120 can be included in an execution pipeline and can perform Advanced SIMD and floating-point operations (FPU) 2122, execute Scalable Vector Extension (SVE) and Scalable Vector Extension 2 (SVE2) instructions 2124, and can optionally execute cryptographic instructions (Crypto) 2126. Advanced SIMD can include media and signal processing architecture that adds instructions primarily for audio, video, 3D graphics, image, and speech processing. A floating-point architecture provides support for single-precision and double-precision floating-point operations. L1 data memory system 2130 can execute load and store instructions, as well as service memory coherency requests. L1 data memory system 2130 can include an L1 data cache 2132 and a fully associative L1 data TLB 2134 with native support for 4 KB, 16 KB and 64 KB page sizes and 2 MB and 512 MB block sizes. Memory Management Unit (MMU) 2128 can provide fine-grained memory system control through a set of virtual-to-physical address mappings and memory attributes that can be held in translation tables, which can be saved into TLB 2134 when an address is translated. L2 memory system 2136 can include L2 cache 2138, and it can be connected to DSU-110 2154 through an asynchronous CPU bridge 2152. Neoverse™ V2 core 2100 can support a range of debug, test, and trace options including a trace unit 2142 and a trace buffer 2140, and an Embedded Logic Analyzer (ELA) 2148. Neoverse™ V2 core 2100 can implement Statistical Profiling Extension (SPE) 2144 to provide a statistical view of the performance characteristics of executed instructions that software writers can use to optimize their code for better performance. Performance Monitoring Unit (PMU) 2146 can provide performance monitors that can be configured to gather statistics on operation of each core and memory system. Information can be used for debug and code profiling. Generic Interrupt Controller (GIC) CPU interface 2150, when integrated with an external distributor component, can be a resource for supporting and managing interrupts in a cluster system. In a cluster, there can be one CPU bridge 2152 between each Neoverse™ V2 core 2100 and DSU-110 2154. CPU bridge 2152 can control buffering and synchronization between core 2100 and DSU-110 2154. CPU bridge 2152 can be asynchronous to allow different frequency, power, and area implementation points for each core 2100. CPU bridge 2152 can run synchronously without affecting other interfaces such as, but not limited to, debug and trace which can be asynchronous.

In at least one embodiment, core 2100 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

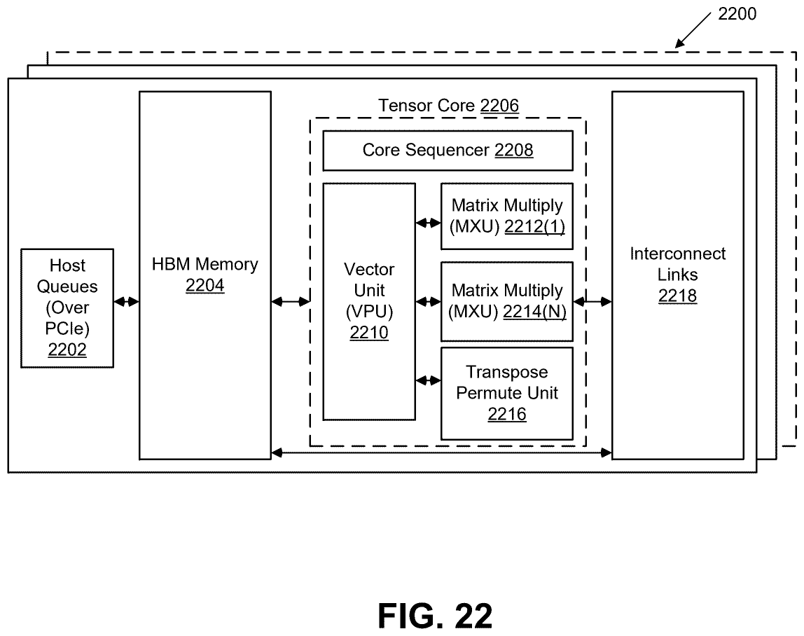

FIG. 22 illustrates one or more chips including one or more tensor processing units (TPUs) 2200, in accordance with at least one embodiment. TPUs 2200 in FIG. 22 can include application specific integrated circuits (ASICs), e.g., to perform some or all of the operations described above or elsewhere herein, such as, but not limited to, accelerate machine learning workloads performing matrix operations. TPUs 2200 may be ASICs from Alphabet Corporation in Mountain View, CA. Cloud TPU includes a cloud service that makes TPUs available as a scalable resource for processing tasks, such as, but not limited to, machine learning workloads that can run on frameworks such as, but not limited to, TensorFlow, Pytorch, and JAX.

A chip can include any number of TPUs 2200 that can include tensor cores 2206. Tensor core 2206 can include one or more core sequencer 2208, vector processing unit (VPU) 2210, matrix multiply unit (MXU) 2212(A)-2214(N), where N is any integer greater than 1, and a transpose permute unit 2216. Core Sequencer 2208 can fetch (e.g., VLIW (Very Long Instruction Word)) instructions from core's 2206 Instruction Memory (Imem), execute scalar operations using a scalar data memory (Smem) and scalar registers (Sregs) (not shown), and forward vector instructions to Vector Processing Unit (VPU) (2210. Instructions can, for example, launch eight operations: two scalar, two vector ALU, vector load and store, and a pair of slots that queue data to and from matrix multiply and transpose units. VPU 2210 can perform vector operations using a large on-chip vector memory (Vmem), and vector registers (Vregs). VPU 2210 can stream data to and from MXU through decoupling FIFOs. VPU 2210 can collect and distribute data to Vmem via data-level parallelism (2D matrix and vector functional units) and instruction-level parallelism (8 operations per instruction). A large two-dimensional matrix multiply unit (MXU) 2212(A)-2212(N) can, e.g., use a systolic array to reduce area and energy plus large, software-controlled on-chip memories instead of caches. Transpose Reduction Permute Unit 2216 can do (e.g., 128×128) matrix transposes, reductions, and permutations of VPU 2210 lanes. High Bandwidth Memory 2204 can be used for applications on chip, and it can be coupled to host queue(s) 2202, e.g., over PCIe. One or more chips including one or more TPUs 2200 can be connected together for computing. For example, one or more chips including one or more TPUs 2200 can be connected as a torus, e.g., a 2D torus. Chip including one or more TPUs 2200 can also include any number (e.g., four) Inter-Core Interconnect (ICI) links 2218 that can enable direct connections between chips to form a supercomputer.

With respect to any processors in chip including one or more TPUs 2200 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of any processors in chip including one or more TPUs 2200 (e.g., in cache and/or memory). A result of API(s) can then be stored in storage within or outside of any processors in chip including one or more TPUs 2200, including registers, DRAM, flash, SRAM, cache, or other memory equivalents.

In at least one embodiment, chip including one or more TPUs 2200 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

### Software Constructions

The following figures set forth, without limitation, examples of software constructs for implementing at least one embodiment.

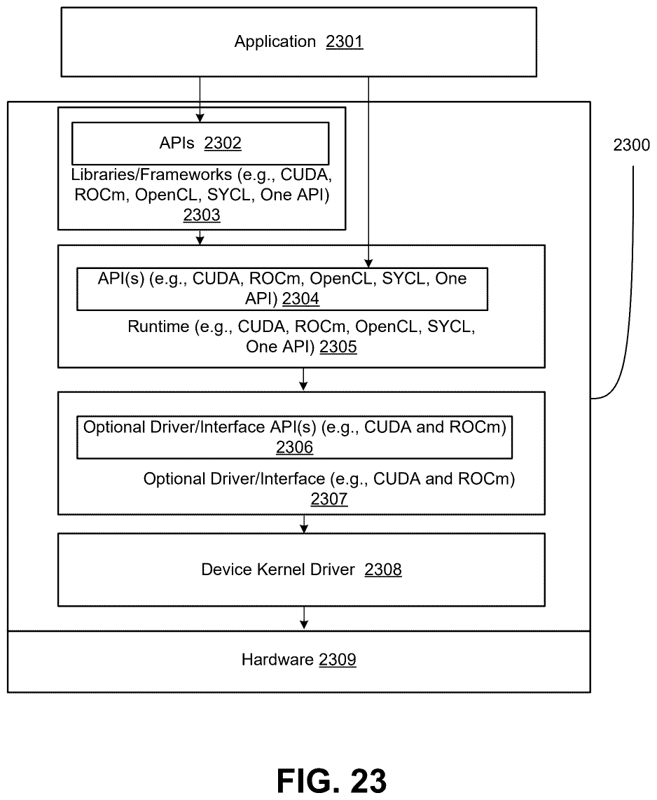

FIG. 23 illustrates a software stack of a programming platform, in accordance with at least one embodiment. A programming platform can include a platform for leveraging hardware on a computing system to accelerate computational tasks. A programming platform may be accessible to software developers through libraries, compiler directives, and/or extensions to programming languages, in at least one embodiment. A programming platform may be CUDA, Radeon Open Compute Platform (“ROCm”), OpenCL (OpenCL™ is developed by Khronos group), SYCL, or Intel oneAPI.

A software stack 2300 of a programming platform can provide an execution environment for an application 2301. Application 2301 may include any computer software capable of being launched on software stack 2300. Application 2301 may include an artificial intelligence (“AI”)/machine learning (“ML”) application, a high performance computing (“HPC”) application, a virtual desktop infrastructure (“VDI”), or a data center workload.

Application 2301 and software stack 2300 run on hardware 2308. Hardware 2308 may include one or more GPUs, CPUs, FPGAs, AI engines, and/or other types of compute devices that support a programming platform. Software stack 2300 may be vendor specific and compatible with only devices from particular vendor(s), such as CUDA, ROCm, OneAPI, OpenCL, or other implementations. Hardware 2308 can include a host connected to one more devices that can be accessed to perform computational tasks via application programming interface (“API”) calls. A device within hardware 2308 may include a GPU, FPGA, AI engine, or other compute device (but may also include a CPU) and its memory, as opposed to a host within hardware 2308 that may include a CPU (but may also include a compute device) and its memory, in at least one embodiment. With respect to any hardware 2308 described above or elsewhere herein, one or more of APIs described herein can, for example, get compiled into instructions, which may be fetched by instruction fetch logic, decoded by a processor decoder, scheduled (e.g., in order or out of order) for execution by a scheduler, executed by execution logic, reordered, and then retired by retirement logic. API(s) (and/or compiled instructions including API(s)) can be stored in any storage outside or inside of hardware 2308 (e.g., in cache and/or memory). A result of API(s) can then be stored in storage within or outside of hardware 2308, including registers, DRAM, flash, SRAM, cache, or other memory. One or more of APIs described herein can receive a call. One or more of APIs described herein can communicate with a library or a portion of a library to perform a function described by the call. One or more of APIs described herein can receive a call and communicate with a library or portion of a library to perform a function described by the call.

Software stack 2300 of a programming platform can include a number of libraries 2303, a runtime 2305, an optional driver/interface 2307, and hardware 2308 including a device kernel driver. Each of libraries 2303 may include data and programming code that can be used by computer programs and leveraged during software development. Libraries 2303 may include pre-written code and subroutines, classes, values, type specifications, configuration data, documentation, help data, and/or message templates. Libraries 2303 can include functions that may be optimized for execution on one or more types of devices. Libraries 2303 may include functions for performing mathematical, deep learning, and/or other types of operations on devices. Libraries 2303 can be associated with corresponding APIs 2302, which may include one or more APIs, that expose functions implemented in libraries 2303. A processor (e.g. CPU, GPU) may perform, call, or otherwise use one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. A processor may perform an API or calls an API from memory to be performed to support dynamic stream priority (e.g., updating priority while a stream is being used to perform operations). For example, when a processor performs said API, it allows a programmer to copy stream priority from one stream to one or more other streams.

Software stack 2300 may include an API to support dynamic stream priority (e.g., updating priority while a stream is being used to perform operations), which can allow a programmer to set priority of a stream at any time after creation. Software stack 2300 can include an API to support dynamic stream priority (e.g., updating priority while the stream is being used to perform operations), which may allow a programmer to obtain current priority of a stream, where the priority is one of a plurality of attributes of a stream. Software stack 2300 can include an API to support dynamic stream priority (e.g., updating priority while the stream is being used to perform operations), which may allow a programmer to obtain current priority of a stream as a single attribute. Software stack 2300 can include an API to support dynamic stream priority (e.g., updating priority while the stream is being used to perform operations), which allows a programmer to launch a kernel to perform operations on a stream at a set priority, which may be different from the stream priority. Software stack 2300 may include an API to indicate whether an object (e.g., a thread synchronization object such as, but not limited to, a barrier) tracks whether all data movement operations for a set of threads operating on a GPU may be complete has a specified state after a specified period of time, where a specified state can be a state indicating that data has been moved and is ready for use, and is specified using an expected parity value as an input to the API.

Software stack 2300 can include one or more APIs to updated kernels. A processor can perform an API or call an API from memory to be performed to update to an existing API is to support context-free kernels, which may allow a programmer to add a kernel node to a graph without a graphics context, so that a graphics context can be dynamically associated with a kernel at runtime. Software stack 2300 may include one or more APIs to allow a programmer to obtain a kernel identifier and a graphics context as separate parameters from a kernel node, so that parameters to be obtained from kernels and from context-free kernels. Software stack 2300 can include one or more APIs to use parallel processor(s), such as, but not limited to, one or more graphics processing units, to launch task graphs (e.g., task graphs) and to execute one or more task graphs (e.g., including one or more programs).

Software stack 2300 may include one or more APIs to associate one or more instructions with one or more memory ordering operations, such as, but not limited to, a fence or membar operation. Instructions can be associated with one or more domains such that a memory ordering operation is executed in association to one or more particular domains without interfering with instructions of other domains. An API can indicate a thread has arrived (e.g., at a thread synchronization barrier), or finished a stage of work in relation to asynchronous data movement operations on a GPU. Software stack 2300 may include one or more to allow programmers to manually indicate an expected transaction count when a thread has finished a stage of work, which can be used to update an object that tracks whether all data movement operations for a set of threads may be complete.

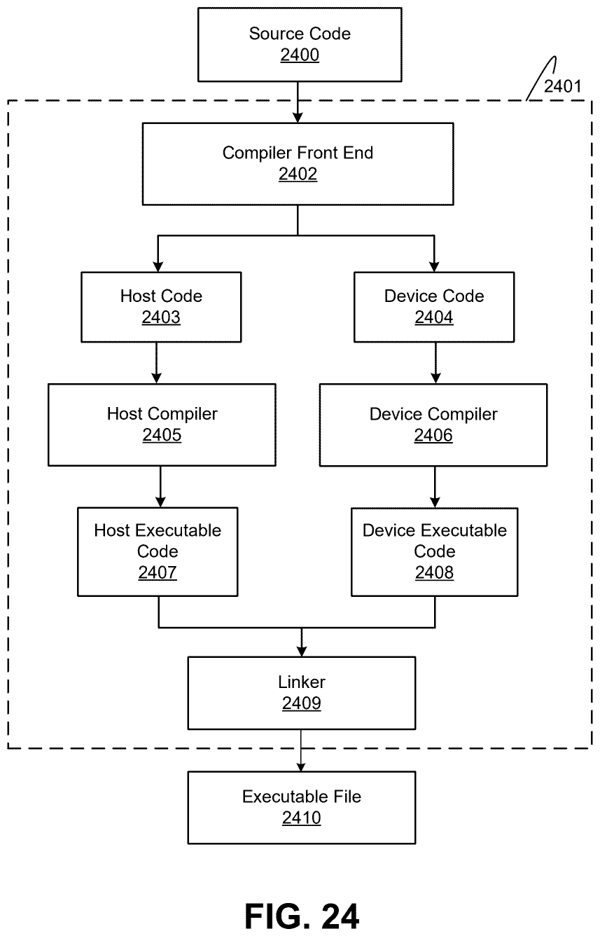

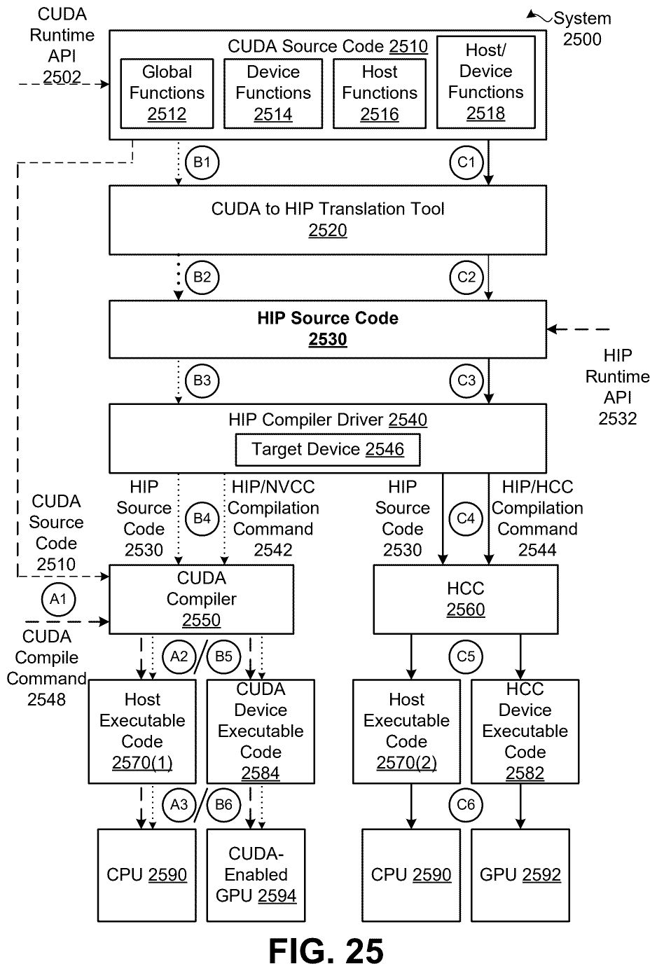

Application 2301 can be written as source code that is compiled into executable code, as discussed in greater detail below in conjunction with FIGS. 24 and 25. Executable code of application 2301 may run, at least in part, on an execution environment provided by software stack 2300. During execution of application 2301, code may be reached that needs to run on a device, as opposed to a host. In such a case, runtime 2305 may be called to load and launch requisite code on a device. Runtime 2305 may include any technically feasible runtime system that is able to support execution of application 2301.

Runtime 2305 can be implemented as one or more runtime libraries associated with corresponding APIs, which are shown as API(s) 2304. One or more of such runtime libraries may include functions for memory management, execution control, device management, error handling, and/or synchronization, among other things. Memory management functions may include functions to allocate, deallocate, and copy device memory, as well as transfer data between host memory and device memory. Execution control functions may include functions to launch a function (sometimes referred to as a “kernel” when a function is a global function callable from a host) on a device and set attribute values in a buffer maintained by a runtime library for a given function to be executed on a device.

Runtime libraries and corresponding API(s) 2304 may be implemented in any technically feasible manner. One (or any number of) API may expose a low-level set of functions for fine-grained control of a device, while another (or any number of) API may expose a higher-level set of such functions. A high-level runtime API may be built on top of a low-level API. One or more of runtime APIs may be language-specific APIs that may be layered on top of a language-independent runtime API.

An optional driver or interface 2307 may be implemented, e.g., for CUDA and ROCm implementations, that are described further below. Optional driver/interface 2307 may be associated with optional driver or interface API(s), such as, but not limited to, CUDA and/or ROCm API(s).

One or more processors disclosed in “processing systems” can perform, access, or otherwise use software stack 2300. For example, system-on-a-chip 1300, parallel processor 1400, graphics multiprocessor 1434, processor 1500, processor 1600, accelerator 1700, neuromorphic processor 1805, supercomputer, acceleration processing unit 1900, processor 2000, processor core 2100, tensor processing unit 2200, a processor, and a system 2500 using a language processing unit can perform, use, call, or otherwise implement (e.g., through accessing a memory) one or more APIs included in software stack 2300.

Hardware 2308 including a device kernel driver can be configured to facilitate communication with an underlying device. Hardware 2308 including a device kernel driver may provide low-level functionalities upon which APIs, such as, but not limited to, API(s) 2304, and/or other software relies. Hardware 2308 including a device kernel driver may be configured to compile intermediate representation (“IR”) code into binary code at runtime. For CUDA or other implementations such as, but not limited to, ROCm, OneAPI, or OpenCL, hardware 2308 including a device kernel driver may compile Parallel Thread Execution (“PTX”) IR code that is not hardware specific into binary code for a specific target device at runtime (with caching of compiled binary code), which is also sometimes referred to as “finalizing” code. Doing so may permit finalized code to run on a target device, which may not have existed when source code was originally compiled into PTX code. Alternatively, device source code may be compiled into binary code offline, without requiring hardware 2308 including a device kernel driver to compile IR code at runtime.

Processors described elsewhere herein, such as, but not limited to, processors in FIGS. 13-25 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software, e.g., software stack 2300 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

In accordance with at least one embodiment, software stack 2300 of FIG. 23 can be performed in a CUDA implementation. A CUDA software stack 2300, on which an application 2301 may be launched, may include CUDA libraries 2303, a CUDA runtime 2305, a CUDA driver 2307, and hardware 2308 including a device kernel driver. CUDA software stack 2300 can execute on hardware (e.g., graphics multiprocessor 1434 that may include a GPU that supports CUDA and is developed by NVIDIA Corporation of Santa Clara, CA.

Application 2301, CUDA runtime 2305, and hardware 2308 including a device kernel driver can perform functionalities that are described above and elsewhere herein. CUDA driver 2307 can include a library (libcuda.so) that may implement a CUDA driver API 2306. Similar to a CUDA runtime API 2304 implemented by a CUDA runtime library (cudart), CUDA driver API 2306 may expose functions for memory management, execution control, device management, error handling, synchronization, and/or graphics interoperability, among other things. CUDA driver API 2306 can differ from CUDA runtime API 2304 in that CUDA runtime API 2304 simplifies device code management by providing implicit initialization, context (analogous to a process) management, and module (analogous to dynamically loaded libraries) management. In contrast to high-level CUDA runtime API 2304, CUDA driver API 2306 can be a low-level API providing more fine-grained control of a device, particularly with respect to contexts and module loading. CUDA driver API 2306 may expose functions for context management that may be not exposed by CUDA runtime API 2304. CUDA driver API 2306 may also be language-independent and support, e.g., OpenCL, in addition to CUDA runtime API 2304. Further, development libraries, including CUDA runtime 2305, may be considered as separate from driver components, including user-mode CUDA driver 2307 and hardware 2308 including a kernel-mode device driver (also sometimes referred to as a “display” driver).

CUDA libraries 2303 may include mathematical libraries, deep learning libraries, parallel algorithm libraries, and/or signal/image/video processing libraries, which parallel computing applications such as, but not limited to, application 2301 may utilize. CUDA libraries 2303 may include mathematical libraries such as, but not limited to, a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. CUDA libraries 2303 may include deep learning libraries such as, but not limited to, a cuDNN library of primitives for deep neural networks and a TensorRT platform for high-performance deep learning inference, among others.

In at least one embodiment, processors described elsewhere herein, such as, but not limited to, processors in FIGS. 13-25 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software, e.g., software stack 2300 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

In accordance with at least one embodiment, software stack 2300 of FIG. 23 can be performed in a ROCm implementation. A ROCm software stack 2300, on which an application 2301 may be launched, includes a language runtime 2305, a system runtime 2305, a thunk, and hardware 2308 including a ROCm kernel driver. ROCm software stack 2300 executes on hardware 2309, which may include a GPU that supports ROCm and is developed by AMD Corporation of Santa Clara, CA.

Application 2301 may perform similar functionalities as discussed above in conjunction with FIG. 23. In addition, language runtime 2305 and system runtime 2305 may perform similar functionalities as runtime 2305 discussed above in conjunction with FIG. 23. Language runtime 2305 and system runtime 2305 may differ in that system runtime 2305 is a language-independent runtime that implements a ROCr system runtime API 2304 and makes use of a Heterogeneous System Architecture (“HSA”) Runtime API. HSA runtime API can include a thin, user-mode API that exposes interfaces to access and interact with an AMD GPU, including functions for memory management, execution control via architected dispatch of kernels, error handling, system and agent information, and runtime initialization and shutdown, among other things. In contrast to system runtime 2305, language runtime 2305 can be an implementation of a language-specific runtime API 2302 layered on top of ROCr system runtime API 2304. Language runtime API may include a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and a HIP language runtime API may include functions that may be similar to those of CUDA runtime API discussed above in conjunction with FIG. 23, such as, but not limited to, functions for memory management, execution control, device management, error handling, and synchronization, among other things.

Thunk (ROCt) can be an interface that can be used to interact with underlying hardware 2308 including a ROCm driver. Hardware 2308 including a ROCm driver can be a ROCK driver, which is a combination of an AMDGPU driver and a HSA kernel driver (amdkfd). AMDGPU driver can be a device kernel driver for GPUs developed by AMD that performs similar functionalities as a device kernel driver of hardware 2309 discussed above in conjunction with FIG. 23. HSA kernel driver can be a driver permitting different types of processors to share system resources more effectively via hardware features.

Various libraries (not shown) may be included in ROCm software stack 2300 above language runtime 2305 and provide functionality similar to CUDA libraries 2303, discussed above in conjunction with FIG. 23. Various libraries may include mathematical, deep learning, and/or other libraries such as, but not limited to, a hipBLAS library that implements functions similar to those of CUDA cuBLAS, a rocFFT library for computing FFTs that is similar to CUDA cuFFT, among others.

Processors described elsewhere herein, such as, but not limited to, processors in FIGS. 13-25 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software, e.g., software stack 2300 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

In accordance with at least one embodiment, software stack 2300 of FIG. 23 can be performed in a OpenCL implementation. An OpenCL software stack 2300, on which an application 2301 may be launched, can include an OpenCL framework 2303, an OpenCL runtime 2305, and hardware 2308 including a driver. OpenCL software stack 2300 may execute on hardware 2309 that is not vendor-specific. As OpenCL is supported by devices developed by different vendors, specific OpenCL drivers may be required to interoperate with hardware from such vendors.

Application 2301, OpenCL runtime 2305, hardware 2308 including a device kernel driver, and hardware 2309 may perform similar functionalities as other implementations of application 2301, runtime 2305, hardware 2308 including a device kernel driver, and hardware 2309, respectively, that are discussed above in conjunction with FIG. 23. Application 2301 can further include an OpenCL kernel (not shown) with code that is to be executed on a device.

OpenCL may define a “platform” that allows a host to control devices connected to a host. An OpenCL framework can provide a platform layer API and a runtime API, shown as platform API 2302 and runtime API 2304. Runtime API 2304 can use contexts to manage execution of kernels on devices. Each identified device may be associated with a respective context, which runtime API 2304 may use to manage command queues, program objects, and kernel objects, share memory objects, among other things, for that device. Platform API 2302 can expose functions that permit device contexts to be used to select and initialize devices, submit work to devices via command queues, and enable data transfer to and from devices, among other things. In addition, OpenCL framework can provide various built-in functions (not shown), including math functions, relational functions, and image processing functions, among others.

A compiler (not shown) can also be included in OpenCL framework 2303. Source code may be compiled offline prior to executing an application or online during execution of an application. In contrast to CUDA and ROCm, OpenCL applications may be compiled online by a compiler that is representative of any number of compilers that may be used to compile source code and/or IR code, such as, but not limited to, Standard Portable Intermediate Representation (“SPIR-V”) code, into binary code. Alternatively, OpenCL applications may be compiled offline, prior to execution of such applications.

In at least one embodiment, processors described elsewhere herein, such as, but not limited to, processors in FIGS. 13-25 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software, e.g., software stack 2300 to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

In accordance with at least one embodiment, software can be supported by a programming platform that is configured to support various programming models, middlewares and/or libraries, and frameworks that an application may rely upon. Application may be an AI/ML application implemented using, for example, a deep learning framework such as, but not limited to, MXNet, PyTorch, or TensorFlow, which may rely on libraries such as, but not limited to, cuDNN, NVIDIA Collective Communications Library (“NCCL”), and/or NVIDA Developer Data Loading Library (“DALI”) CUDA libraries to provide accelerated computing on underlying hardware.

Programming platform may be one of a CUDA, ROCm, or OpenCL platform described above in conjunction with FIG. 23. Programming platform can support multiple programming models, which may be abstractions of an underlying computing system permitting expressions of algorithms and data structures. Programming models may expose features of underlying hardware in order to improve performance. Programming models may include CUDA, HIP, OpenCL, C++ Accelerated Massive Parallelism (“C++ AMP”), Open Multi-Processing (“OpenMP”), Open Accelerators (“OpenACC”), and/or Vulkan Compute.

Libraries and/or middlewares may provide implementations of abstractions of programming models. Such libraries can include data and programming code that may be used by computer programs and leveraged during software development. Such middlewares can include software that provides services to applications beyond those available from programming platform. Libraries and/or middlewares may include cuBLAS, cuFFT, cuRAND, and other CUDA libraries, or rocBLAS, rocFFT, rocRAND, and other ROCm libraries. In addition, libraries and/or middlewares may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

Application frameworks may depend on libraries and/or middlewares. Each of application frameworks can be a software framework used to implement a standard structure of application software. Returning to the AI/ML example discussed above, an AI/ML application may be implemented using a framework such as, but not limited to, Caffe, Caffe2, TensorFlow, Keras, PyTorch, or MxNet deep learning frameworks, for example.

In at least one embodiment, processors described elsewhere herein, such as, but not limited to, processors in FIGS. 13-25 can include one or more circuits to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein. One or more circuits can be configured by software, e.g., programming platforms described herein, to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE or otherwise perform any of the operations described above or elsewhere herein.

FIG. 24 illustrates compiling code to execute on one of programming platforms of FIG. 23 described above, in accordance with at least one embodiment. A compiler 2401 is configured to receive source code 2400, compile source code 2400, and output an executable file 2410. Complier 2401 can be configured to convert source code 2400 into host executable code 2407 for execution on a host and device executable code 2408 for execution on a device. Source code 2400 may either be compiled offline prior to execution of an application, or online during execution of an application. Source code 2400 may include code in any programming language supported by compiler 2401, such as, but not limited to, C++, C, Fortran, etc. Source code 2400 may be included in a single-source file having a mixture of host code and device code, with locations of device code being indicated therein. A single-source file may be a .cu file that includes CUDA code or a .hip.cpp file that includes HIP code or a file in another format that includes both host code and device code. Alternatively, source code 2400 may include multiple source code files, rather than a single-source file, into which host code and device code may be separated. Compiler 2401 includes or has access to one or more libraries to recognize a sequence of API calls to perform a single fused API, where a single fused API is a combined API for two or more APIs. In at least one embodiment, compiler 2401 may be an NVIDIA CUDA compiler (“NVCC”) for compiling CUDA code in .cu files, or a HCC compiler for compiling HIP code in .hip.cpp files, or other compilers.

Compiler 2401 can be configured to compile source code 2400 into host executable code 2407 for execution on a host and device executable code 2408 for execution on a device. Compiler 2401 performs operations including parsing source code 2400 into an abstract system tree (AST), performing optimizations, and generating executable code. When source code 2400 includes a single-source file, compiler 2401 may separate device code from host code in such a single-source file, compile device code and host code into device executable code 2408 and host executable code 2407, respectively, and link device executable code 2408 and host executable code 2407 together in a single file.

Compiler 2401 can include a compiler front end 2402, a host compiler 2405, a device compiler 2406, and a linker 2409. Compiler front end 2402 can be configured to separate device code 2404 from host code 2403 in source code 2400. Device code 2404 may be compiled by device compiler 2406 into device executable code 2408, which as described may include binary code or IR code, in at least one embodiment. Separately, host code 2403 may be compiled by host compiler 2405 into host executable code 2407. For NVCC other compilers, such as, but not limited to, those for oneAPI, ROCm, and OpenCL, host compiler 2405 may be a general purpose C/C++ compiler that outputs native object code, while device compiler 2406 may be a Low Level Virtual Machine (“LLVM”)-based compiler that forks a LLVM compiler infrastructure and outputs PTX code or binary code. For HCC, both host compiler 2405 and device compiler 2406 may be LLVM-based compilers that output target binary code.

Subsequent to compiling source code 2400 into host executable code 2407 and device executable code 2408, linker 2409 can link host and device executable code 2407 and 2408 together in executable file 2410. Native object code for a host and PTX or binary code for a device may be linked together in an Executable and Linkable Format (“ELF”) file, which is a container format used to store object code. Host executable code 2407 and device executable code 2408 may be in any suitable format, such as, but not limited to, binary code and/or IR code. In the case of CUDA, host executable code 2407 may include native object code and device executable code 2408 may include code in PTX intermediate representation, in at least one embodiment. In the case of ROCm, both host executable code 2407 and device executable code 2408 may include target binary code, in at least one embodiment. Other implementations, such as, but not limited to, oneAPI, OpenCL are contemplated and can be performed similarly to the CUDA and ROCm implementations above.

Source code 2400 may be translated prior to compiling source code. Source code is passed through a translation tool (not shown), which translates source code 2400 into translated source code. A compiler 2401 can be used to compile translated source code into host executable code 2407 and device executable code 2408 in a process that is similar to compilation of source code 2400 by compiler 2401 into host executable code 2407 and device executable code 2408, as discussed above in conjunction with FIG. 24.

A translation performed by translation tool can be used to port source code 2400 for execution in a different environment than that in which it was originally intended to run. Translation tool may include a HIP translator that is used to “hipify” CUDA code intended for a CUDA platform into HIP code that can be compiled and executed on a ROCm platform. Translation of source code 2400 may include parsing source code 2400 and converting calls to API(s) provided by one programming model (e.g., CUDA) into corresponding calls to API(s) provided by another programming model (e.g., HIP), as discussed in greater detail below in conjunction with FIG. 25. Returning to the example of hipifying CUDA code, calls to CUDA runtime API, CUDA driver API, and/or CUDA libraries may be converted to corresponding HIP API calls. Automated translations performed by a translation tool, such as compiler 2401, may sometimes be incomplete, requiring additional, manual effort to fully port source code 2400.

One or more techniques described herein may utilize a variety of methods for converting one type of code to another type of code. For example, compiler 2401 or other compilers described herein can convert a high-level language (e.g., source code that is abstract to hardware) to a lower-level language (e.g., machine code or an intermediate representation). Source code can be scanned, parsed, transformed into an abstract syntax tree semantically analyzed, then converted into an intermediate code, and then converted into machine code or assembly language. Compiler 2401 or other compilers described herein can include a transpiler, which can convert, for example, one type of source code to another type of source code or one type of machine code to another type of machine code. Source code can be parsed, and transformed into an abstract syntax tree, which can then be converted to an intermediate model that can be transformed into an abstract syntax tree of target language and code can be generated. Compiler 2401 or other compilers described herein can be used to enable interchangeability between different device architectures. For example, an application for one platform (e.g., a CUDA application) can be compiled into code for implementation on another platform (e.g., an AMD processor, Intel processor, or other processor). Source code 2400 can include source code for one platform (e.g., CUDA). Compiler 2401 can compile the source 2400 into an executable file 2410 that can be used by another platform (e.g., AMD or Intel). Programming toolkits can allow applications for one platform (e.g., CUDA) to be compiled (e.g., natively) for another platform (e.g., AMD or Intel). For example, a GPGPU programming toolkit can allow for CUDA applications to be natively compiled for AMD GPUs. Programs (e.g., CUDA programs) or its build system do not have to be modified or translated to another language before compiling to code for another platform. A compiler may accept the same command-line options and programming dialect (e.g., CUDA dialect) as another compiler (e.g., nvcc for CUDA), serving as a drop-in replacement to impersonate an installation of a toolkit (e.g., NVIDIA CUDA Toolkit), so existing build tools and scripts (e.g., like cmake) work without further modification. In at least one embodiment, an nvcc-compatible compiler can be used to compile nvcc-dialect CUDA for AMD GPUs, including PTX asm. Implementations of CUDA runtime and driver APIs for AMD GPUs can be used. Libraries (e.g., open source wrapper libraries) can provide APIs, such as “CUDA-X” APIs by delegating to the corresponding ROCm libraries. An example implementation includes SCALE from Spectral Compute in London, England. SCALE can allow programs written using CUDA language to be directly compiled to lower-level language (e.g., machine code) for AMD GPUs. SCALE can create one or more directories that can be used to impersonate NVIDIA CUDA Toolkit (from the point of view of a build system) by instructing a build system that a CUDA installation path is one provided by SCALE, rather than the one provided by NVIDIA. Additional implementations can include a Clang compiler that can provide a language front-end and tooling infrastructure for languages in the C language family (C, C++, Objective C/C++, OpenCL, CUDA, and RenderScript). In at least one embodiment, compilers and/or transpilers described herein, such as, but not limited to compiler 2401, compiler 2405, and/or compiler 2406 can include one or more circuits to compile code (e.g., CUDA, HIP, OpenCL, OneAPI, or others) to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or perform any of the operations described above or elsewhere herein. In at least one embodiment, compilers and/or transpilers described herein, such as, but not limited to compiler 2401, compiler 2405, and/or compiler 2406 can include one or more circuits to convert code (e.g., source code for CUDA) to one or more other types of code (e.g., machine code for CUDA and/or another platform, such as AMD or Intel processors) to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE and/or perform any of the operations described above or elsewhere herein.

FIG. 25 illustrates a system 2500 configured to compile and execute CUDA source code 2510 using different types of processing units, in accordance with at least one embodiment. System 2500 includes CUDA source code 2510, a CUDA compiler 2550, host executable code 2570(1), host executable code 2570(2), CUDA device executable code 2584, a CPU 2590, a CUDA-enabled GPU 2594, a GPU 2592, a CUDA to HIP translation tool 2520, HIP source code 2530, a HIP compiler driver 2540, an HCC 2560, and HCC device executable code 2582.

CUDA source code 2510 may be a collection of human-readable code in a CUDA programming language. A CUDA programming language can be an extension of the C++ programming language that includes mechanisms to define device code and distinguish between device code and host code. Device code can include source code that, after compilation, is executable in parallel on a device. A device may be a processor that is optimized for parallel instruction processing, such as, but not limited to, CUDA-enabled GPU, GPU 2592, or another GPGPU, etc. Host code is source code that, after compilation, is executable on a host. A host is a processor that is optimized for sequential instruction processing, such as, but not limited to, CPU 2590.

CUDA source code 2510 can include any number (including zero) of global functions 2512, any number (including zero) of device functions 2514, any number (including zero) of host functions 2516, and any number (including zero) of host/device functions 2518. Global functions 2512, device functions 2514, host functions 2516, and host/device functions 2518 may be mixed in CUDA source code 2510. Each of global functions 2512 may be executable on a device and callable from a host. One or more of global functions 2512 may therefore act as entry points to a device. Each of global functions 2512 can be a kernel. In a technique known as dynamic parallelism, one or more of global functions 2512 can define a kernel that is executable on a device and callable from such a device. A kernel can be executed N (where N is any positive integer) times in parallel by N different threads on a device during execution.

Each of device functions 2514 can be executed on a device and callable from such a device only. Each of host functions 2516 can be executed on a host and callable from such a host only. Each of host/device functions 2516 may define both a host version of a function that is executable on a host and callable from such a host only and a device version of the function that is executable on a device and callable from such a device only.

CUDA source code 2510 may also include any number of calls to any number of functions that may be defined via a CUDA runtime API 2502. CUDA runtime API 2502 may include any number of functions that execute on a host to allocate and deallocate device memory, transfer data between host memory and device memory, manage systems with multiple devices, etc. CUDA source code 2510 may also include any number of calls to any number of functions that may be specified in any number of other CUDA APIs. A CUDA API may be any API that is designed for use by CUDA code. CUDA APIs can include CUDA runtime API 2502, a CUDA driver API, APIs for any number of CUDA libraries, etc, including any API(s) described elsewhere herein. Relative to CUDA runtime API 2502, a CUDA driver API can be a lower-level API but can provide finer-grained control of a device. Examples of CUDA libraries include cuBLAS, cuFFT, cuRAND, cuDNN, etc.

CUDA compiler 2550 may compile input CUDA code (e.g., CUDA source code 2510) to generate host executable code 2570(1) and CUDA device executable code 2584. CUDA compiler 2550 may be, but is not limited to, NVCC. Host executable code 2570(1) can be a compiled version of host code included in input source code that is executable on CPU 2590. CPU 2590 may be any processor that is optimized for sequential instruction processing.

CUDA device executable code 2584 may be a compiled version of device code included in input source code that is executable on CUDA-enabled GPU 2594. CUDA device executable code 2584 may include binary code. CUDA device executable code 2584 can include IR code, such as, but not limited to, PTX code, that is further compiled at runtime into binary code for a specific target device (e.g., CUDA-enabled GPU 2594) by a device driver. CUDA-enabled GPU 2594 may include any processor that is optimized for parallel instruction processing and that supports CUDA. CUDA-enabled GPU 2594 may be developed by NVIDIA Corporation of Santa Clara, CA.

CUDA to HIP translation tool 2520 can be configured to translate CUDA source code 2510 to functionally similar HIP source code 2530. HIP source code 2530 may include a collection of human-readable code in a HIP programming language. HIP code can include human-readable code in a HIP programming language. A HIP programming language can include an extension of the C++ programming language that includes functionally similar versions of CUDA mechanisms to define device code and distinguish between device code and host code. A HIP programming language may include a subset of functionality of a CUDA programming language. For example, a HIP programming language includes mechanism(s) to define global functions 2512, but such a HIP programming language may lack support for dynamic parallelism and therefore global functions 2512 defined in HIP code may be callable from a host only.

HIP source code 2530 may include any number (including zero) of global functions 2512, any number (including zero) of device functions 2514, any number (including zero) of host functions 2516, and any number (including zero) of host/device functions 2518. HIP source code 2530 may also include any number of calls to any number of functions that may be specified in a HIP runtime API 2532. HIP runtime API 2532 may include functionally similar versions of a subset of functions included in CUDA runtime API 2502. HIP source code 2530 may also include any number of calls to any number of functions that may be specified in any number of other HIP APIs. A HIP API may be any API that is designed for use by HIP code and/or ROCm. HIP APIs may include HIP runtime API 2532, a HIP driver API, APIs for any number of HIP libraries, APIs for any number of ROCm libraries, etc.

CUDA to HIP translation tool 2520 can convert each kernel call in CUDA code from a CUDA syntax to a HIP syntax and can convert any number of other CUDA calls in CUDA code to any number of other functionally similar HIP calls. A CUDA call can include a call to a function specified in a CUDA API, and a HIP call can include a call to a function specified in a HIP API. CUDA to HIP translation tool 2520 may convert any number of calls to functions specified in CUDA runtime API 2502 to any number of calls to functions specified in HIP runtime API 2532.

CUDA to HIP translation tool 2520 can include a tool known as hipify-perl that executes a text-based translation process. CUDA to HIP translation tool 2520 can include a tool known as hipify-clang that, relative to hipify-perl, executes a more complex and more robust translation process that involves parsing CUDA code using clang (a compiler front-end) and then translating resulting symbols. Converting CUDA code to HIP code may include modifications (e.g., manual edits) in addition to those performed by CUDA to HIP translation tool 2520.

HIP compiler driver 2540 can include a front end that determines a target device 2546 and then configures a compiler that is compatible with target device 2546 to compile HIP source code 2530. Target device 2546 can include a processor that is optimized for parallel instruction processing. HIP compiler driver 2540 may determine target device 2546 in any technically feasible fashion.

If target device 2546 is compatible with CUDA (e.g., CUDA-enabled GPU 2594), then HIP compiler driver 2540 can generate a HIP/NVCC compilation command 2542. HIP/NVCC compilation command 2542 can configure CUDA compiler 2550 to compile HIP source code 2530 using a HIP to CUDA translation header and a CUDA runtime library. In response to HIP/NVCC compilation command 2542, CUDA compiler 2550 may generate host executable code 2570(1) and CUDA device executable code 2584.

If target device 2546 is not compatible with CUDA, then HIP compiler driver 2540 may generate a HIP/HCC compilation command 2544. HIP/HCC compilation command 2544 can configure HCC 2560 to compile HIP source code 2530 using an HCC header and a HIP/HCC runtime library. In response to HIP/HCC compilation command 2544, HCC 2560 may generate host executable code 2570(2) and HCC device executable code 2582. HCC device executable code 2582 may be a compiled version of device code included in HIP source code 2530 that is executable on GPU 2592. GPU 2592 may be any processor that is optimized for parallel instruction processing, is not compatible with CUDA, and is compatible with HCC. GPU 2592 can be developed by AMD Corporation of Santa Clara, CA. GPU 2592 can include a non-CUDA-enabled GPU 2592.

For explanatory purposes only, three different flows that may be implemented in at least one embodiment to compile CUDA source code 2510 for execution on CPU 2590 and different devices are depicted in FIG. 25. A direct CUDA flow can compile CUDA source code 2510 for execution on CPU 2590 and CUDA-enabled GPU 2594 without translating CUDA source code 2510 to HIP source code 2530. An indirect CUDA flow can translate CUDA source code 2510 to HIP source code 2530 and then compiles HIP source code 2530 for execution on CPU 2590 and CUDA-enabled GPU 2594. A CUDA/HCC flow can translate CUDA source code 2510 to HIP source code 2530 and then can compile HIP source code 2530 for execution on CPU 2590 and GPU 2592.

A direct CUDA flow that may be implemented is depicted via dashed lines and a series of bubbles annotated A1-A3. As depicted with bubble annotated A1, CUDA compiler 2550 can receive CUDA source code 2510 and a CUDA compile command 2548 that can configure CUDA compiler 2550 to compile CUDA source code 2510. CUDA source code 2510 that can be used in a direct CUDA flow can be written in a CUDA programming language that is based on a programming language other than C++ (e.g., C, Fortran, Python, Java, etc.). In response to CUDA compile command 2548, CUDA compiler 2550 can generate host executable code 2570(1) and CUDA device executable code 2584 (depicted with bubble annotated A2). As depicted with bubble annotated A3, host executable code 2570(1) and CUDA device executable code 2584 may be executed on, respectively, CPU 2590 and CUDA-enabled GPU 2594. CUDA device executable code 2584 can include binary code. CUDA device executable code 2584 can include PTX code and can be further compiled into binary code for a specific target device at runtime.

An indirect CUDA flow that may be implemented is depicted via dotted lines and a series of bubbles annotated B1-B6. As depicted with bubble annotated B1, CUDA to HIP translation tool 2520 can receive CUDA source code 2510. As depicted with bubble annotated B2, CUDA to HIP translation tool 2520 can translate CUDA source code 2510 to HIP source code 2530. As depicted with bubble annotated B3, HIP compiler driver 2540 can receive HIP source code 2530 and can determine that target device 2546 is CUDA-enabled.

As depicted with bubble annotated B4, HIP compiler driver 2540 can generate HIP/NVCC compilation command 2542 and can transmit both HIP/NVCC compilation command 2542 and HIP source code 2530 to CUDA compiler 2550. HIP/NVCC compilation command 2542 can configure CUDA compiler 2550 to compile HIP source code 2530 using a HIP to CUDA translation header and a CUDA runtime library. HIP to CUDA translation header can translate any number of mechanisms (e.g., functions) specified in any number of HIP APIs to any number of mechanisms specified in any number of CUDA APIs. CUDA compiler 2550 may use HIP to CUDA translation header in conjunction with a CUDA runtime library corresponding to CUDA runtime API 2502 to generate host executable code 2570(1) and CUDA device executable code 2584. In response to HIP/NVCC compilation command 2542, CUDA compiler 2550 can generate host executable code 2570(1) and CUDA device executable code 2584 (depicted with bubble annotated B5). As depicted with bubble annotated B6, host executable code 2570(1) and CUDA device executable code 2584 may be executed on, respectively, CPU 2590 and CUDA-enabled GPU 2594. CUDA device executable code 2584 can include binary code. CUDA device executable code 2584 can include PTX code and can be further compiled into binary code for a specific target device at runtime.

A CUDA/HCC flow that may be implemented is depicted via solid lines and a series of bubbles annotated C1-C6. As depicted with bubble annotated C1, CUDA to HIP translation tool 2520 can receive CUDA source code 2510. As depicted with bubble annotated C2, CUDA to HIP translation tool 2520 can translate CUDA source code 2510 to HIP source code 2530. As depicted with bubble annotated C3, HIP compiler driver 2540 can receive HIP source code 2530 and can determine that target device 2546 is not CUDA-enabled.

HIP compiler driver 2540 may generate HIP/HCC compilation command 2544 and may transmit both HIP/HCC compilation command 2544 and HIP source code 2530 to HCC 2560 (depicted with bubble annotated C4). HIP/HCC compilation command 2544 can configure HCC 2560 to compile HIP source code 2530 using an HCC header and a HIP/HCC runtime library. HIP/HCC runtime library can correspond to HIP runtime API 2532. HCC header may include any number and type of interoperability mechanisms for HIP and HCC. In response to HIP/HCC compilation command 2544, HCC 2560 can generate host executable code 2570(2) and HCC device executable code 2582 (depicted with bubble annotated C5). As depicted with bubble annotated C6, host executable code 2570(2) and HCC device executable code 2582 may be executed on, respectively, CPU 2590 and GPU 2592.

After CUDA source code 2510 is translated to HIP source code 2530, HIP compiler driver 2540 may subsequently be used to generate executable code for either CUDA-enabled GPU 2594 or GPU 2592 without re-executing CUDA to HIP translation tool 2520. CUDA to HIP translation tool 2520 can translate CUDA source code 2510 to HIP source code 2530 that is then stored in memory. HIP compiler driver 2540 can then configure HCC 2560 to generate host executable code 2570(2) and HCC device executable code 2582 based on HIP source code 2530. In at least one embodiment, HIP compiler driver 2540 subsequently configures CUDA compiler 2550 to generate host executable code 2570(1) and CUDA device executable code 2584 based on stored HIP source code 2530.

An example kernel may be translated by CUDA-to-HIP translation tool 2520 of FIG. 25, in accordance with at least one embodiment. CUDA source code 2510 partitions an overall problem that a given kernel is designed to solve into relatively coarse sub-problems that can independently be solved using thread blocks. Each thread block includes any number of threads. Each sub-problem can be partitioned into relatively fine pieces that can be solved cooperatively in parallel by threads within a thread block. Threads within a thread block can cooperate by sharing data through shared memory and by synchronizing execution to coordinate memory accesses.

CUDA source code 2510 can organize thread blocks associated with a given kernel into a one-dimensional, a two-dimensional, or a three-dimensional grid of thread blocks. Each thread block includes any number of threads, and a grid includes any number of thread blocks.

A kernel can be a function in device code that is defined using a “_global_” declaration specifier. The dimension of a grid that executes a kernel for a given kernel call and associated streams may be specified using a CUDA kernel launch syntax. CUDA kernel launch syntax is specified as “KernelName<<<GridSize, BlockSize, SharedMemorySize, Stream>(KernelArguments);”. An execution configuration syntax can include a “<<< . . . >>>” construct that is inserted between a kernel name (“KernelName”) and a parenthesized list of kernel arguments (“KernelArguments”). CUDA kernel launch syntax can include a CUDA launch function syntax instead of an execution configuration syntax.

“GridSize” can be of a type dim3 and specify the dimension and size of a grid. Type dim3 may be a CUDA-defined structure that includes unsigned integers x, y, and z. If z is not specified, then z may default to one. If y is not specified, then y may default to one. The number of thread blocks in a grid can be equal to the product of GridSize.x, GridSize.y, and GridSize.z. “BlockSize” can be of type dim3 and specify the dimension and size of each thread block. The number of threads per thread block may be equal to the product of BlockSize.x, BlockSize.y, and BlockSize.z. Each thread that executes a kernel may be given a unique thread ID that is accessible within the kernel through a built-in variable (e.g., “threadIdx”).

With respect to CUDA kernel launch syntax, “SharedMemorySize” may be an optional argument that may specify a number of bytes in a shared memory that is dynamically allocated per thread block for a given kernel call in addition to statically allocated memory. With respect to CUDA kernel launch syntax, SharedMemorySize may default to zero. With respect to CUDA kernel launch syntax, “Stream” may be an optional argument that specifies an associated stream and defaults to zero to specify a default stream. A stream may be a sequence of commands (possibly issued by different host threads) that execute in order. Different streams may execute commands out of order with respect to one another or concurrently.

CUDA source code 2510 may include a kernel definition for an example kernel “MatAdd” and a main function. Main function may be host code that executes on a host and includes a kernel call that causes kernel MatAdd to execute on a device. Kernel MatAdd can add two matrices A and B of size N×N, where N is a positive integer, and store the result in a matrix C. Main function can define a threadsPerBlock variable as 16 by 16 and a numBlocks variable as N/16 by N/16. Main function can then specify kernel call “MatAdd<<<numBlocks, threadsPerBlock>>>(A, B, C);”. As per CUDA kernel launch syntax, kernel MatAdd can be executed using a grid of thread blocks having a dimension N/16 by N/16, where each thread block has a dimension of 16 by 16. Each thread block can include 256 threads, a grid can be created with enough blocks to have one thread per matrix element, and each thread in such a grid may execute kernel MatAdd to perform one pair-wise addition.

While translating CUDA source code 2510 to HIP source code 2530, CUDA to HIP translation tool 2520 may translate each kernel call in CUDA source code 2510 from CUDA kernel launch syntax to a HIP kernel launch syntax and may convert any number of other CUDA calls in source code 2510 to any number of other functionally similar HIP calls. HIP kernel launch syntax can be specified as “hipLaunchKernelGGL (KernelName, GridSize, BlockSize, SharedMemorySize, Stream, KernelArguments);”. Each of KernelName, GridSize, BlockSize, ShareMemorySize, Stream, and KernelArguments can have the same meaning in HIP kernel launch syntax as in CUDA kernel launch syntax (described previously herein). Arguments SharedMemorySize and Stream can be required in HIP kernel launch syntax and can be optional in CUDA kernel launch syntax.

A portion of HIP source code 2530 can be identical to a portion of CUDA source code 2510 depicted except for a kernel call that causes kernel MatAdd to execute on a device. Kernel MatAdd may be defined in HIP source code 2530 with the same “_global_” declaration specifier with which kernel MatAdd is defined in CUDA source code 2510. A kernel call in HIP source code 2530 may be “hipLaunchKernelGGL (MatAdd, numBlocks, threadsPerBlock, 0, 0, A, B, C);”, while a corresponding kernel call in CUDA source code 2510 is “MatAdd<<<numBlocks, threadsPerBlock>>>(A, B, C);”.

Other implementations are contemplated and can be performed similarly to the CUDA and HIP implementations above, such as oneAPI, OpenCL, and other programming platforms. Code can be translated in any direction. For example, CUDA can be translated to HIP, and CUDA can be translated to OpenCL. SnuCL-Tr and CUCL can be used to translate OpenCL to CUDA or CUDA to OpenCL, respectively. Compiled code or intermediate representations (e.g., CUDA PTX code) can also be translated to run on other processor platforms (e.g., AMD or Intel). For example, PTX code can be translated to run on Intel or AMD processors using a translation tool, such as ZLUDA.

One or more techniques described herein can utilize a oneAPI programming model. A oneAPI programming model can refer to a programming model for interacting with various compute accelerator architectures. OneAPI may refer to an application programming interface (API) designed to interact with various compute accelerator architectures. A oneAPI programming model may utilize a DPC++ programming language. A DPC++ programming language may refer to a high-level language for data parallel programming productivity. A DPC++ programming language can be based at least in part on C and/or C++ programming languages. A oneAPI programming model can be a programming model such as, but not limited to, those developed by Intel Corporation of Santa Clara, CA.

OneAPI and/or oneAPI programming model can be utilized to interact with various accelerator, GPU, processor, and/or variations thereof, architectures. OneAPI may include a set of libraries that implement various functionalities. OneAPI may include at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

A oneAPI DPC++ library, also referred to as oneDPL, can be a library that implements algorithms and functions to accelerate DPC++ kernel programming. OneDPL may implement one or more standard template library (STL) functions. OneDPL can implement one or more parallel STL functions. OneDPL can provide a set of library classes and functions such as, but not limited to, parallel algorithms, iterators, function object classes, range-based API, and/or variations thereof. OneDPL can implement one or more classes and/or functions of a C++ standard library. OneDPL can implement one or more random number generator functions.

A oneAPI math kernel library, also referred to as oneMKL, can be a library that implements various optimized and parallelized routines for various mathematical functions and/or operations. OneMKL can implement one or more basic linear algebra subprograms (BLAS) and/or linear algebra package (LAPACK) dense linear algebra routines. OneMKL may implement one or more sparse BLAS linear algebra routines. OneMKL can implement one or more random number generators (RNGs). OneMKL may implement one or more vector mathematics (VM) routines for mathematical operations on vectors. OneMKL may implement one or more Fast Fourier Transform (FFT) functions.

A oneAPI data analytics library, also referred to as oneDAL, can include a library that implements various data analysis applications and distributed computations. OneDAL can implement various algorithms for preprocessing, transformation, analysis, modeling, validation, and decision making for data analytics, in batch, online, and distributed processing modes of computation. OneDAL can implement various C++ and/or Java APIs and various connectors to one or more data sources. OneDAL may implement DPC++ API extensions to a traditional C++ interface and enables GPU usage for various algorithms.

A oneAPI deep neural network library, also referred to as oneDNN, can include a library that implements various deep learning functions. OneDNN may implement various neural network, machine learning, and deep learning functions, algorithms, and/or variations thereof.

A oneAPI collective communications library, also referred to as oneCCL, can include a library that implements various applications for deep learning and machine learning workloads. OneCCL can be built upon lower-level communication middleware, such as, but not limited to, message passing interface (MPI) and libfabrics. OneCCL can enable a set of deep learning specific optimizations, such as, but not limited to, prioritization, persistent operations, out of order executions, and/or variations thereof. OneCCL can implement various CPU and GPU functions.

A oneAPI threading building blocks library, also referred to as oneTBB, can include a library that implements various parallelized processes for various applications. OneTBB can be utilized for task-based, shared parallel programming on a host. OneTBB may implement generic parallel algorithms. OneTBB may implement concurrent containers. OneTBB may implement a scalable memory allocator. OneTBB may implement a work-stealing task scheduler. OneTBB may implement low-level synchronization primitives. OneTBB may be compiler-independent and usable on various processors, such as, but not limited to, GPUs, PPUs, CPUs, and/or variations thereof.

A oneAPI video processing library, also referred to as oneVPL, can include a library that is utilized for accelerating video processing in one or more applications. One VPL can implement various video decoding, encoding, and processing functions. OneVPL can implement various functions for media pipelines on CPUs, GPUs, and other accelerators. OneVPL can implement device discovery and selection in media centric and video analytics workloads. OneVPL can implement API primitives for zero-copy buffer sharing.

A oneAPI programming model may utilize a DPC++ programming language. A DPC++ programming language can include a programming language that can include functionally similar versions of CUDA mechanisms to define device code and distinguish between device code and host code. A DPC++ programming language may include a subset of functionality of a CUDA programming language. One or more CUDA programming model operations may be performed using a oneAPI programming model using a DPC++ programming language.

Any application programming interface (API) described herein can be compiled into one or more instructions, operations, or any other signal by a compiler, interpreter, or other software tool. Compilation can include generating one or more machine-executable instructions, operations, or other signals from source code. An API compiled into one or more instructions, operations, or other signals, when performed, can cause one or more processors such as, but not limited to, processors described, e.g., in FIGS. 13-25, or any other logic circuit further described herein to perform one or more computing operations.

In at least one embodiment, translation tools described elsewhere herein, such as, but not limited to, can include one or more circuits to translate CUDA code to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE to HIP, oneAPI, OpenCL, or any other language used to perform any of the operations described above or elsewhere herein. One or more circuits can be configured by software to translate CUDA code to receive performance metric values for each user equipment device (UE) of a plurality of UEs, identify one or more first peaks by determining that one or more performance metric values are a maximum in a sub-band compared to all sub-bands for a UE of the plurality of UEs and a maximum compared to the same performance metric for any other UE in the same sub-band, identify one or more second peaks by performing a parallel prefix minimum operation, and/or allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE to HIP, oneAPI, OpenCL, or any other language used to perform any of the operations described above or elsewhere herein.

### Autonomous Vehicle

At least one embodiment of the disclosure can be described in view of the following clauses:
1. One or more processors comprising:
   circuitry to:
   receive performance metric values for each user equipment device (UE) of a plurality of UEs;
   identify one or more first peaks by determining that one or more performance metric values are a maximum in a sub-band compared to all sub-bands for a UE of the plurality of UEs and a maximum compared to the same performance metric for any other UE in the same sub-band,
      wherein the determination is to be performed in parallel by executing a first reduction operation using first threads and a second reduction operation using second threads;
   identify one or more second peaks by performing a parallel prefix minimum operation, wherein the parallel prefix minimum operation is to be performed using third threads and fourth threads in parallel to compute prefix minimum values across sub-bands; and
   allocate one or more sub-bands to each of UE of the plurality of UEs based, at least in part, on the identified first and second peaks and gaps between assigned sub-bands by executing parallel threads for each gap, each thread processing an unallocated sub-band by determining the nearest assigned sub-band and assigning the unallocated sub-band to a UE device
2. The one or more processors of clause 1, wherein the performance metric values correspond to one of the following: signal strength, signal-to-noise ratio, signal-to-interference ratio, or proportional fairness.
3. The one or more processors of clauses 1 and/or 2, wherein the circuitry is to transmit allocated sub-bands to each of the plurality of UEs.
4. The one or more processors of clauses 1-3, wherein performed in parallel includes one or more threads being performed simultaneously.
5. The one or more processors of clauses 1-4, wherein the first, second, third, fourth, fifth, and sixth threads are to be performed by one or more GPUs.
6. The one or more processors of clauses 1-5, wherein the sub-bands correspond to one or more frequencies in an Open Radio Access Network (O-RAN).
7. The one or more processors of clauses 1-6, wherein the sub-bands correspond to one or more frequencies in a Fifth Generation (5G) radio access network.
8. A system comprising:
one or more processors to:
identify two or more first local maximum values within a first range for a performance metric for one or more wireless signals received by two or more first user equipment devices,
identify two or more second local maximum values within a second range for the performance metric for one or more wireless signals received by two or more second user equipment devices,
wherein each local maximum value corresponds to a wireless signal received by a different user equipment device,
cause one or more sub-bands to be allocated to the two or more first user equipment devices and to the two or more second user equipment devices based, at least in part, a first thread group that is to be performed using the first range and a second thread group that is to be performed using the second range, wherein the first and second thread group are performed in parallel.
9. The system of clause 8, wherein the one or more processors are to perform multiple input multiple output (MIMO) operations when communicating with the first and second user equipment devices.
10. The system of clauses 8 and/or 9, wherein the first and second user equipment devices includes at least one of the following: a mobile phone, an in-machine infotainment device, a smart device, an autonomous vehicle, or a handheld device.
11. The system of clauses 8-10, wherein the first thread group and the second thread group comprise graphics processing unit (GPU) threads.
12. The system of clauses 8-11, wherein the first range and second range are adjacent to each other.
13. The system of clauses 8-12, wherein the system is comprised in at least one of:
a system supporting a cellular wireless network;
a control system for an autonomous or semi-autonomous machine;
a system for performing one or more simulation operations;
a system for performing one or more digital twin operations;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that deploy one or more machine learning models in a service or microservice along with an OS-level virtualization package (e.g., a container);
a system incorporating one or more virtual machines (VMs);
a system implemented at least partially in a data center; or a system implemented at least partially using cloud computing resources.
14. The system of clauses 8-13, wherein the first range and second range are separate by at least one sub-band.
15. A method comprising, the method comprising:
   receiving performance metric values for each user equipment device (UE) of a plurality of UEs;
   identifying one or more first peaks by determining that one or more performance metric values are a maximum in a sub-band compared to all sub-bands for a UE of the plurality of UEs and a maximum compared to the same performance metric for any other UE in the same sub-band, wherein the determination includes using threads in parallel for different sub-band ranges;
   identifying one or more second peaks by performing a parallel prefix minimum operation; and
   allocating one or more sub-bands to the UE of the plurality of UEs based, at least in part, on the identified first and second peaks.
16. The method of clause 15, wherein the determination is to be performed in parallel by executing a first reduction operation using first threads and a second reduction operation using second threads.
17. The method of clauses 15 and/or 16, wherein the parallel prefix minimum operation is to be performed using third threads and fourth threads in parallel to compute prefix minimum values across sub-bands.
18. The method of clauses 15-17, wherein allocating further comprises:
filling gaps between assigned sub-bands by executing parallel threads for each gap, each thread processing an unallocated sub-band by determining the nearest assigned sub-band and assigning the unallocated sub-band to a UE device
19. The method of clauses 16-18, wherein performed in parallel includes one or more threads being performed simultaneously.
20. The method of clauses 15-19, wherein the performance metric values correspond to one of the following: signal strength, signal-to-noise ratio, signal-to-interference ratio, or proportional fairness.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

As described further herein, processors, such as those disclosed in FIGS. 13-25 can use instructions to perform any of the operations described herein. Instructions, for example, can be performed using one or more threads. A thread block can include any number of threads of execution. A workgroup can be a thread block. A processor can execute a group of threads (e.g., 16 threads). A group of threads can also be referred to as a warp, or subgroup, or wavefront (e.g., as used by AMD and Intel). Each thread in a warp, wave, subgroup, or wavefront can belong to a single thread block and can be configured to process a different set of data based on a single set of instructions. A lane can be a thread. A work item can be a thread, such as, but not limited to, e.g., with OpenCL.

A processor, such as, processors described further herein (e.g., FIGS. 13-25) can include one or more threads that can perform instructions synchronously. A thread can perform instructions synchronously. For example, a thread can perform a sequence of two instructions. An output of the first instruction can be input to the second instruction.

In at least one embodiment, a thread performs an instruction asynchronously if the thread performs one or more subsequent instructions before a processor's completion of all operations corresponding to the instruction have been completely been performed. For example, the thread can perform the instruction to cause a processor to queue or otherwise begin performing an operation and the thread can perform subsequent instructions before the processor has completed performing the operation. A processor, such as, processors described further herein (e.g., FIGS. 13-25) can perform instructions asynchronously. For example, a thread may submit or issue an instruction to be performed by processor, and processor can perform the instruction independently of a thread that can be performing other instruction(s). A thread may submit or issue an instruction that can be performed by processor, and, for example, can inform one or more threads (the same thread or other threads) when the processor has performed a previously submitted or issued instruction. A thread may perform a first instruction to wait to be informed that processor has performed previously submitted or issued instructions, and, for example, output from the processor can be available to the thread. Output from processor can be input to a thread performing a second instruction. Instructions can be performed asynchronously in a variety of sequences. For example, one or more threads may submit one or more instructions to a processor, and processor may perform instructions in a sequence that is the same or different than an order submitted by the threads. Processor may specify a sequencing for the instructions that the processor performs.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors—for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

An arithmetic logic unit can include a set of combinational logic circuitry that takes one or more inputs to produce a result. An arithmetic logic unit can be used by a processor to implement mathematical operation such as, but not limited to, addition, subtraction, or multiplication. An arithmetic logic unit is used to implement logical operations such as, but not limited to, logical AND/OR or XOR. An arithmetic logic unit can be stateless, and made from physical switching components such as, but not limited to, semiconductor transistors arranged to form logical gates. An arithmetic logic unit may operate internally as a stateful logic circuit with an associated clock. An arithmetic logic unit may be constructed as an asynchronous logic circuit with an internal state not maintained in an associated register set. An arithmetic logic unit can be used by a processor to combine operands stored in one or more registers of the processor and produce an output that can be stored by the processor in another register or a memory location.

As a result of processing an instruction retrieved by the processor, the processor may present one or more inputs or operands to an arithmetic logic unit, causing the arithmetic logic unit to produce a result based at least in part on an instruction code provided to inputs of the arithmetic logic unit. The instruction codes provided by the processor to the ALU may be based at least in part on the instruction executed by the processor. Combinational logic in the ALU may process the inputs and produces an output which is placed on a bus within the processor. A processor can select a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

One or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. One or more processors comprising:
circuitry to:
receive performance metric values for a plurality of user equipment devices (UEs);
identify one or more first peaks based at least on determining that one or more performance metric values are: (i) greater in a sub-band compared to other sub-bands for a UE of the plurality of UEs; and (ii) greater compared to the same performance metric for another UE in the sub-band, the determination performed in parallel by executing a first reduction operation using first threads and a second reduction operation using second threads of at least one processor of the one or more processors;
identify one or more second peaks based at least on performing a parallel prefix minimum operation, the parallel prefix minimum operation performed using third threads and fourth threads of the at least one processor in parallel to compute prefix minimum values across sub-bands; and
allocate one or more sub-bands to the UE of the plurality of UEs based at least on the identified one or more first and one or more second peaks and gaps between assigned sub-bands based at least on executing parallel threads for individual gaps of the gaps.

2. The one or more processors of claim 1, wherein the performance metric values correspond to at least one of: signal strength, signal-to-noise ratio, signal-to-interference ratio, or proportional fairness.

3. The one or more processors of claim 2, wherein performed in parallel include one or more threads being performed simultaneously.

4. The one or more processors of claim 3, wherein the first, second, third, and fourth threads are to be performed using one or more GPUs.

5. The one or more processors of claim 1, wherein the circuitry is to transmit allocated sub-bands to individual UEs of the plurality of UEs.

6. The one or more processors of claim 1, wherein the sub-bands correspond to one or more frequencies in an Open Radio Access Network (O-RAN).

7. The one or more processors of claim 1, wherein the sub-bands correspond to one or more frequencies in a Fifth Generation (5G) radio access network.

8. A system comprising:
one or more processors to:
identify two or more first local maximum values within a first range for a performance metric for one or more wireless signals received by a plurality of first user equipment devices (UEs);
identify two or more second local maximum values within a second range for the performance metric for one or more wireless signals received by a plurality of second UEs; and
cause one or more sub-bands to be allocated to the plurality of first UEs and to the plurality of second UEs based at least on first threads that are to be executed on the first range in parallel with second threads that are to be executed on the second range.

9. The system of claim 8, wherein the one or more processors are to perform multiple input multiple output (MIMO) operations when communicating with the plurality of first UEs and the plurality of second UE devices.

10. The system of claim 8, wherein the plurality of first UEs and the plurality of second UEs include at least one of: a mobile phone, a computing device, an in-machine infotainment device, a smart device, a talking kiosk, an autonomous or semi-autonomous vehicle, robot, or machine, or a handheld wireless device.

11. The system of claim 8, wherein the first threads and the second threads comprise graphics processing unit (GPU) threads.

12. The system of claim 8, wherein the first range and second range are adjacent to each other.

13. The system of claim 11, wherein the system is comprised in at least one of:
a system supporting a cellular wireless network;
a control system for an autonomous or semi-autonomous machine;
a system for performing one or more simulation operations;
a system for performing one or more digital twin operations;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

14. The system of claim 8, wherein the first range and second range are separated by at least one sub-band.

15. A method, comprising:
assigning a first sub-band and one or more second sub-bands contiguous to the first sub-band of a radio spectrum to a first user equipment device (UE), the assigning being based at least on evaluating, in parallel using a plurality of threads of a parallel processor, performance of the first UE on the first sub-band relative to one or more second UEs on the first sub-band.

16. The method of claim 15, wherein the first sub-band is determined to be a peak in performance for the first UE, and one or more second sub-bands are assigned based at least on the one or more second sub-bands being contiguous to the first sub-band and not having a current assignment to a second UE of the one or more second UEs.

17. The method of claim 15, wherein performance is defined using one or more metric values including at least one of: signal strength, signal-to-noise ratio, signal-to-interference ratio, or proportional fairness.

18. The method of claim 15, wherein each thread of the plurality of threads, at each processing iteration of the thread, processes first data corresponding to a sub-band of the radio spectrum and second data corresponding to a UE of the first UE or the one or more second UEs.

19. The method of claim 16, wherein in parallel includes two or more threads of the plurality of threads being performed simultaneously.

20. The method of claim 15, wherein the method is performed using at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
